(19) United States
(12) Patent Application Publication
(10) Pub. No.: US 2004/0054627 A1
(43) Pub. Date: Mar. 18, 2004

(54) Universal identification system for printed and electronic media

(76) Inventor: David R. Rutledge, Sonora, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/326,218

(22) Filed: Dec. 20, 2002

Related U.S. Application Data
(60) Provisional application No. 60/410,716, filed on Sep. 13, 2002.

(51) Int. Cl. G06F 17/60

(52) U.S. Cl. 705/50

(57) ABSTRACT

A method, system, and software for creating a universal identification system for articles of printed and electronic media. In one embodiment, identification tags are printed, affixed, or otherwise attached to articles of printed media in order to stamp these articles with ID tags that conform to a standard. These media identification tags, or media IDs, are used to definitively identify, catalog, and organize articles of printed media, and are easily scanned or otherwise read by any person or any entity with the aid of a portable and inexpensive electronic device. Once scanned, media IDs can be transferred to software and/or hardware that automatically catalogs and organizes the media ID's, and provides numerous services related to management and retrieval of the media ID tags and associated articles of media. In another embodiment, identification tags are located with, or otherwise associated with articles of electronic media in order to stamp these articles with ID tags that conform to a standard. These electronic media identification tags, or media IDs, are used to definitively identify, catalog, and organize articles of electronic media. Software and/or hardware are used to generate and distribute the electronic media IDs. Similarly, software and hardware are used to collect, store, and organize electronic media IDs. In one embodiment of the invention, media ID software provides sophisticated cataloging and management of a user's printed and electronic media IDs, and provides powerful search and retrieval capabilities.

### CROSS-REFERENCES TO RELATED APPLICATIONS

This application claims priority from U.S. Provisional Patent Application No. 60/410,716, filed Sep. 13, 2002, which is hereby incorporated by reference.

### BACKGROUND OF THE INVENTION

The invention of the printing press, the discovery of electricity, the concentration of the population in urban areas, the expansion of international trade, and the recent growth of the world economy have all led to the development of a sophisticated international media industry. For example, virtually every significant industry in the world is now represented by at least one trade journal, and virtually every medium to large city in the developed world has a newspaper. Television and radio coverage is common in most of the developed world. Most businesses and many households now have access to electronic information published on the Internet.

The recent development of the computer industry is providing important new technology that has been adopted by the business community and is now accelerating the creation of printed and electronic media. Similarly, the development of distributed networks (including the Internet) and the development of satellite systems are providing important new platforms and conduits for media distribution. A truly global and sweeping media distribution system exists today.

Because of these and other factors, a proliferation of media has occurred. The last twenty years has brought an explosion in the quantity and variety of printed and electronic media. The amazing growth rate in new magazines, newspapers, books, Internet web sites, advertisements, songs, and video is partly due to an increasing audience.

Each day millions of media articles are printed, and millions of media articles are published electronically. These printed and electronic media articles are distributed to readers in the form of magazines, newspapers, books, scientific journals, Internet web pages, compact discs, digital video, and a multitude of other formats. Printed media is here defined in the ordinary sense of the words in the field of printing (e.g. printing a newspaper or printing a magazine). Likewise, electronic media is here defined in the ordinary sense of the words in the field of computers and technology (e.g. publishing an electronic news article on a web page or releasing a digital video etc.).

Information from these numerous articles of printed and electronic media are currently a poorly organized system primarily because there is no consistent media identification system. In fact, most articles of media bear no identification tag whatsoever. Because of this, a considerable amount of time is wasted searching for media articles that lack ID tags, and a considerable amount of time is wasted storing physical copies of media, when the storage of a media ID tag would in most cases suffice. For instance, it is often very difficult for a person to locate an electronic or printed media article that he or she read or otherwise interacted with six months ago. The person must correctly recall where the article of media appeared, and must correctly recall the approximate date of the publication. Once recalled, the person seeking the article of media must then interface with publishers, distributors, or others who often lack a sophisticated and convenient system to locate and distribute copies of their own media, or the media they distribute. Even worse, the person seeking the article of media is forced to locate it in a collection of newspapers, magazines, etc. stored at their own house.

The explosion of printed and electronic information combined with the meager development of information management tools has important implications for productivity. This combination directly leads to one of the key problems facing modem society; our inability to properly address the proliferation of printed and electronic media. So much information is being created and distributed that the average person no longer has the necessary tools to meaningfully and artfully interact with it. The development of information management tools has not kept pace with the development and distribution of information. Therefore, there is a need in the art for a comprehensive and definitive identification system that produces consistent and unique IDs for articles of printed and electronic media, couples these ID tags to articles of media, and that has associated software to manage the media identification tags or media IDs, and the associated media. This provides a mechanism for ID tags from articles of media to be easily collected, properly cataloged, and logically organized. It also provides users the toolset to easily retrieve the original article of media at a later time and to perform sophisticated media searches. The establishment of a universal ID system for printed and electronic media is the first step in developing a method, system, and software that people can use to increase productivity, and intelligently and gracefully interact with the staggering amount of printed and electronic media surrounding them.

### BRIEF SUMMARY OF THE INVENTION

The various aspects of the present invention can be more clearly understood and appreciated from a review of the following detailed description of the disclosed embodiments and by reference to the appended drawings and claims.

### BRIEF DESCRIPTION OF THE DRAWINGS

The invention will be described with reference to the drawings, in which:

FIG. 1 shows the universal media ID system of the present invention plus the current fragmented identification systems;

FIG. 2 shows the elements of the universal identification system for printed and electronic media;

FIG. 3 shows the basic elements of the universal printed media ID system;

FIG. 4 shows the relationship between the media ID intermediary or other entity and the clients that are both using the universal media identification system;

FIG. 5 shows the relationship between the media ID intermediary or other entity and the users that are both using the universal media identification system;

FIG. 6 is a flow chart showing the attachment of a media ID to an article of printed media;

FIG. 7 shows a printed newspaper that has been modified with a graphics program to illustrate universal printed media IDs of the present invention;

FIG. 8 shows a printed newspaper that has been modified with a graphics program to illustrate universal printed media IDs;

FIG. 9 shows some aspects of the relationship between a media ID and its associated media;

FIG. 10 shows a high-level schematic of the handheld electronic media ID scanner;

FIG. 11 shows a detailed schematic of the scanning mechanism of the handheld electronic media ID scanner;

FIG. 12 shows a detailed schematic of the memory architecture of the handheld electronic media ID scanner;

FIG. 13 shows a detailed schematic of the data transmission mechanism of the handheld electronic media ID scanner;

FIG. 14 shows technology used for attaching, printing, or otherwise affixing media IDs to printed media;

FIG. 15 displays the handheld electronic media ID scanner and various communication systems and users;

FIG. 16 shows the elements of the universal electronic media ID system of the present invention;

FIG. 17 shows the interaction of media IDs with a user computer system, a distributed network, and remote computer systems;

FIG. 18 shows a media ID user computer diagram;

FIG. 19 shows the basic concepts of the electronic media ID and its interaction with media and the media ID software;

FIG. 20 shows aspects of the electronic media ID data field structure;

FIG. 21 shows the interaction of a media ID with a local computer system and a remote computer system;

FIG. 22 shows the transfer of a media ID from a web browser to the media ID software;

FIG. 23 shows the transfer of a media ID from a web browser to a storage device located on, or connected to a local computer system;

FIG. 24 shows the transfer of a media ID from a web browser to a remote computer system;

FIG. 25 shows the transfer of a media ID from a web browser to a media ID transport file;

FIG. 26 shows the transfer of a media ID from a web browser to a user account by means of a distributed network;

FIG. 27 is a flow chart that shows the transfer of an electronic media ID from an article of electronic media to the media ID software;

FIG. 28 is a diagram that shows the transfer of a media ID from a web server to the media ID software;

FIG. 29 is a flow chart that shows the transfer of an electronic media ID from a remote device to the media ID software;

FIG. 30 is a screen illustration of the drag and drops capabilities of electronic media IDs;

FIG. 31 is a screen illustration of the media ID mitt;

FIG. 32 shows a media ID transfer process from the media ID scanner to a media ID user computer system;

FIG. 33 is a diagram that shows the basic components of the media ID software;

FIG. 34 is a screen illustration of the media ID software that shows the media ID viewer and the media ID database;

FIG. 35 is a screen illustration of the media ID software database viewer;

FIG. 36 is a screen illustration of the media ID software and media ID viewer;

FIG. 37 is a screen illustration of the media ID software quick facts window;

FIG. 38 is a screen illustration of the media ID software media ID sortable database viewer;

FIG. 39 is a screen illustration of the media ID software that shows the media ID radial subject viewer, the graphical search engine, the media ID icon viewer, the online bulletin/discussion forum, and the subject icon viewer;

FIG. 40 is a screen illustration of the media ID software graphical search engine;

FIG. 41 is a screen illustration of the media ID software text search engine;

FIG. 42 show is a screen illustration of the media ID software subject classification radial viewer;

FIG. 43 is a screen illustration of the media ID software icon viewer;

FIG. 44 is a screen illustration of the media ID software subject icon viewer;

FIG. 45 is a screen illustration of the media ID software online bulletin/discussion forum window;

FIG. 46 is a diagram of the media ID subject layer classification system;

FIG. 47 is a screen illustration of the media ID software that shows the media ID layer control, the layer search tool, the layer search parameters, the layer search results, and the layer search timeline tool; and

FIG. 48 shows the creation and application of intelligence media IDs.

### DETAILED DESCRIPTION OF THE INVENTION

The present invention satisfies the above-described need by providing a method, system, and software for identifying, organizing, and cataloging printed and electronic media information. This is accomplished through the introduction of a universal media identification system that entails the placement of an identification tag (or media ID) on each article of printed and electronic information. In one embodiment, each copy of an individual article of media bears the exact same ID, regardless of how it is distributed (i.e. how many newspapers containing it are distributed). For example, if a person in New York purchases the same Wall Street Journal newspaper on the same day as a person in San Francisco, and each person collects a media ID from the same story in the newspaper, then they will each possess the exact same media ID.

The media ID of the present invention is broad and encompassing, and implements a common language for identification of articles of printed and electronic media. This common media ID language eliminates much of the ambiguity, turbulence, and distortion currently associated with user identification and negotiation of articles of media. In general, a media ID of the present invention from the same article of media is the same for each and every user.

In one embodiment, a media ID is a set of information fields that collectively define and isolate an individual article of media. These information fields provide a comprehensive and exact identification of the article of media that the media ID is bonded with. In most instances, a media ID offers a thorough and beyond all dispute identification of an article of media.

For printed media, a media ID consists of a code symbology or graphic encoded with or otherwise referencing a set of information that is associated with an article of printed media. A user can acquire the printed media ID by scanning it with an electronic scanner or other electronic device.

For electronic media, a media ID consists of a graphic or hyperlink encoded with or otherwise referencing a set of information. A user can acquire the electronic media ID that is associated with an article of media by clicking on it, dragging and dropping it, or otherwise selecting it.

In an additional embodiment, media IDs can also contain the associated article of media as an information field, or as an attachment.

In the case of printed media, the media IDs are “printed”, placed, or otherwise affixed with each article of printed media and contain relevant information about the article and in some cases, the entire content of the article.

For example, relevant information encoded within the “printed” ID tag associated with the media could include but is not limited to the author, the media ID version, the name of the publication, the title of the article, the date of the publication, the page number, the primary subject classification, the secondary subject classifications, the subject (theme) of the article (e.g., investing, cooking, health, computers) etc.

In another embodiment of the invention, an easy mechanism is provided to users for collecting, scanning, or otherwise “reading” the identification tag associated with the printed media of interest. The reader of the article of media scans this printed media ID tag with a simple and inexpensive wireless handheld electronic scanner or other electronic device. The electronic device then decodes and stores the unique information about the media article provided by the ID tag. In one embodiment, this is stored in digital format. The reader can then download the information from an electronic media ID scanner into a personal computer or other suitable electronic device.

Media ID software running on the platform of a personal computer or other suitable electronic device receives the media IDs from the scanner. Once received, the software automatically organizes the various scanned media identifications into user-defined groups and provides powerful media and media ID management tools.

In the case of electronic media, media IDs are embedded in or otherwise located with articles of electronic media. Each electronic media ID comprehensively and definitively identifies the associated article of electronic media. This electronic media ID is easily transferred from the article of electronic media by the user to media ID software. For example, a user initiates the transfer of an electronic media ID from an electronic news article located on a client web page by clicking on or otherwise selecting the media ID icon or graphic that is associated with the article of electronic media. In another example, the reader of the electronic media can drag and drop the electronic media ID symbol or graphic associated with each article of electronic media into the media ID software or some other intermediary. This electronic media ID contains all necessary information such that the article is definitively identified and can be then be cataloged and organized. In some cases, the electronic media ID also contains the associated article of media.

Relevant information encoded within the electronic media ID associated with the article of electronic media can include the author, the media ID version, the name of the publication, the title of the article, the date of the publication, the total number of pages, the primary subject classification (e.g., investing, cooking, health, computers etc.), and the secondary subject classifications.

Media ID software running on the platform of a personal computer or other suitable electronic device receives the media IDs once the user has dropped them into the media ID software or otherwise activates a transfer. Once received, the software automatically organizes the various scanned printed and electronic media identifications into user-defined groups and categories.

A sophisticated database in the media ID software organizes media IDs and offers powerful search capabilities that can be conducted on media IDs within the software as well as media IDs located elsewhere (contained on other computers etc.).

The user can browse through the software database(s) to review the media IDs that they have collected. In one embodiment, the associated article of media is stored in the database along with the media ID that identifies it, or alternately is located elsewhere. The user can browse through the software databases(s) to review the media IDs that they have collected. For example, these media IDs can be from articles, scientific papers, songs, photographs, intelligence reports, or other media.

For articles of media that the full text and graphics could not be retrieved along with the media ID, an embodiment of the invention provides a method and a system for the user to retrieve the full text and graphics of the original work through the Internet, from a library, directly through the original publisher, or through a media ID intermediary or other entity. The media ID software is equally capable of handling electronic media IDs and printed media IDs.

As an example of one embodiment of the invention, a user reads an article about the slide of the dollar against the euro in a business newspaper and finds it of significant interest as to want to keep a record of the article without actually saving the physical article. Because the article has a “printed” media ID as described herein, it is no longer necessary for the user to actually save the physical article in order to retain a record of the article. The user simply scans the “printed” media ID associated with, and located with the media article of interest, thereby capturing its unique identification tag (also known as a media ID). To do this, the user deploys a small electronic scanner or other device and scans the media ID tag that is unique to that article of news.

This handheld scanner converts the identification tag or media ID into an electronic digital identification stored inside of the memory component of the scanner. Throughout the same day, the user might find other articles of interest in different newspapers, periodicals, housekeeping magazines, etc. The same small electronic scanner that captured the unique media ID about the slide of the dollar against the euro will be deployed by the user of the present invention to scan the identifications of these other media articles of interest. At the end of the day the user transfers these identifications from the portable electronic scanner to a personal computer or other electronic device through a wireless connection or through a direct connection.

A media ID software resident on the user's computer or other suitable electronic device automatically categorizes and organizes the various media IDs that have been downloaded from the portable media ID scanner. The software also catalogs and organizes media IDs from other sources. The software is equipped with a standard catalog system, and a user-definable catalog system. The user-definable system provides tools that organize the media identifications or IDs per the users input. In each case, media IDs are organized into meaningful groupings that provide a mechanism for quick retrieval now, or at a later date, and help the user build a media topography that facilitates the easy retrieval of articles of media and the recognition of complicated information patterns. For cases where only the media ID is available for scanning (and not the entire content of the article of media), the media software will have the capability to retrieve the full content of the article of media based upon the unique ID for that media article.

The user of the method, system, and software discussed in this patent is provided with an orderly and consistent media identification system that stamps articles of printed and electronic information with ID tags. Additionally, the user of the present invention is able to collect, store, and organize these media ID tags from articles of printed and electronic media and in some cases collect, store, and organize the full content of the original article of media. The present invention transforms media information from newspapers, magazine articles, scientific journals, etc. from a poorly organized system into an organized system. Users of the present invention can collect and store media ID tags from articles of printed and electronic media in an organized software database, and possess software tools that act as a private staff of researchers, analysts, and librarians.

The various aspects of the present invention can be more clearly understood and appreciated from a review of the following detailed description of the disclosed embodiments and by reference to the appended drawings and claims.

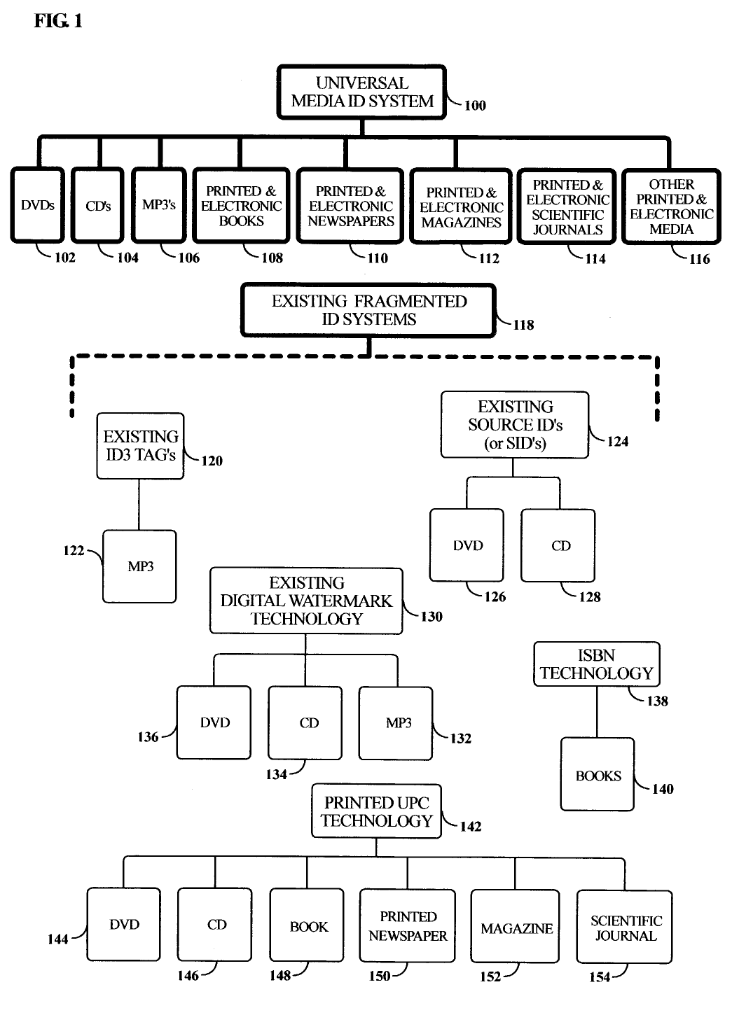

FIG. 1 shows a universal media ID system according to an embodiment of the present invention in contrast to the current fragmented identification systems. The universal media ID system for printed and electronic media is shown at 100. Items 102 through 116 show representative types of printed and electronic media that the universal media ID system encompasses.

Those skilled in the art will realize that items 102 through 116 are intended to generally illustrate the various types of electronic and printed media that are unified and definitively identified by the media ID method and system described herein. Items 102 through 116 are not meant to be all encompassing and do not comprise all printed and electronic media covered by the universal media ID system presented herein.

For example the universal media ID identification or tag can be applied to DVDs 102, CDs 104, MP3s 106, printed and electronic books 108, printed and electronic newspapers 110, printed and electronic magazines 112, printed and electronic scientific journals 114, and miscellaneous printed and electronic media 116.

The application of a common and universal media identification language and identification system to these different types of printed and electronic media gathers disparate media under one system. This common media ID language has a unifying effect by organizing and cataloging all media under one universal media identification system, rather than the current fragmented and specialized identification systems.

The unified media ID system 100 can be contrasted with the existing fragmented ID systems 118 for printed and electronic media. The existing ID systems 118 encompass many different identification technologies and different media identification techniques. In most cases, there is no formal relationship between these different identification technologies. Furthermore, each existing identification technology is very limited in the information encoded in it.

For example, books 140 are cataloged by ISBN numbers from the ISBN system 138. The ISBN number associated with the book 140 does not contain information about the title, publication date, author, and number of pages, etc. The ISBN associated with the book 140 is simply a single unique number that represents the book.

Another example of the fragmented and incomplete nature of the existing ID systems is the UPC system 142. UPCs 142 are linear bar codes symbologies that uniquely represent physical products with a simple alphanumeric ID. This UPC identification is often simply a number or a very short string of text and numbers. Again, unlike the universal media ID as presented here, UPCs 142 are limited in the descriptive information encoded within. UPC codes 142 are typically used for products such as tools or items in a grocery store. Perhaps the biggest use of UPCs 142 is for merchandise control where a simple alphanumeric number is sufficient to catalog a product for inventory control.

Items 120, 124, 130, 138, and 142 represent different identification and classification systems associated with existing identification technology. These technologies are largely heterogeneous and incompatible. FIG. 1 illustrates the limited technology currently available to identify printed and electronic media and the disparate state of the different systems.

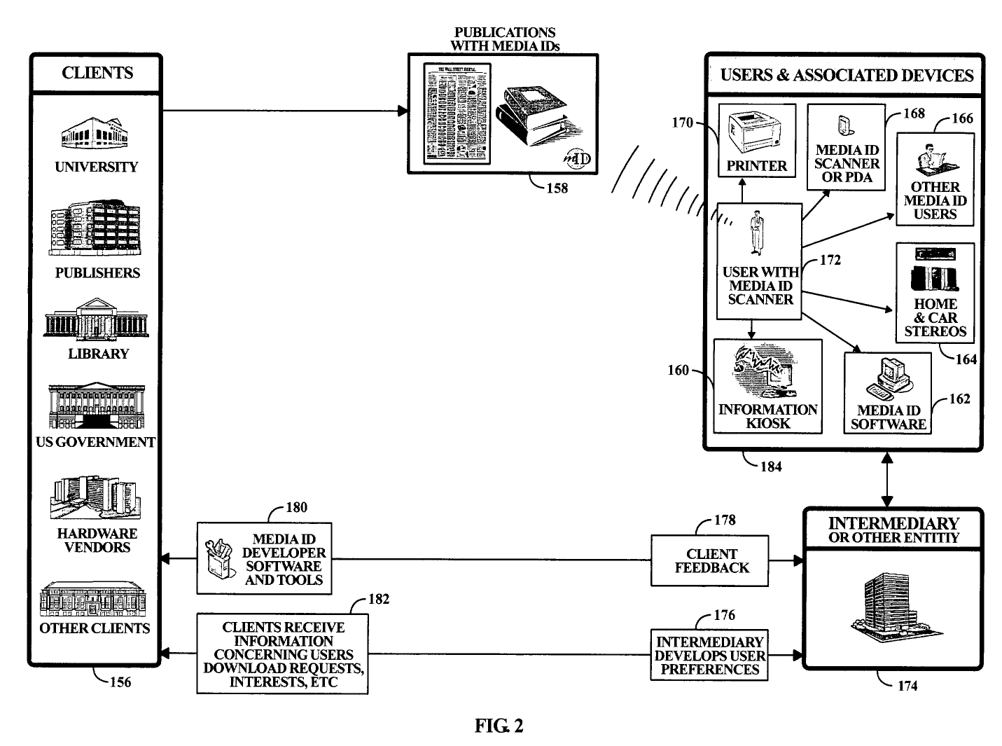

FIG. 2 shows the elements of a universal identification system for printed and electronic media. The clients of the media ID system are located at 156. Clients of the media ID system are defined as entities that publish, create, manage, distribute, archive, store, or otherwise interact with media. In one embodiment, clients create and publish media that are then identified and tagged with a media ID as described in an embodiment of the present invention. In one embodiment, these media with attached media IDs are located at 158. The media located at 158 are definitively identified by their associated media ID tags. Users can download, scan, or otherwise acquire the media IDs associated with the media IDs located at 158 in order to have a record and comprehensive summary of the article of media. The media ID tags or markers can be used to retrieve the original article of media at a later date.

The users of the media ID system and associated devices are located at 184. The users form a broad group and can include diverse participants. A user is generally anybody or anything that downloads, scans, or otherwise acquires media IDs and then uses software and hardware to manage them. Media IDs are generally acquired because users wish to save a record of media that they have encountered without storing or collecting the entire original article of media.

The devices located at 184 are used to print media IDs or original articles of media, to scan media IDs, to play or view media IDs and associated media, and otherwise interact with media. A user is shown at 172 using a portable handheld scanner to scan a media ID associated with an article of printed media that is located at 158.

A media ID intermediary or other entity is located at 174. The media ID intermediary manages the media ID system and engages in ongoing research and development to continually improve the components, processes, and software associated with the media ID system. A feedback loop is located at 178 that exists between 174 and 156. Client feedback is provided to the media ID intermediary or other entity between 174 and 156.

The media ID intermediary develops user preferences at 176. In one embodiment, the media ID intermediary hosts media and media IDs for user to download at 174. Due to its unique location between the users at 184 and the clients at 156, the media ID intermediary is ideally suited to develop user profiles based upon their interaction with media and media IDs. The clients 156 receive the user preferences 182 from the media ID intermediary or other entity 174.

The media ID software and tools that clients use to publish media with media IDs are located at 180 in FIG. 2. The media ID intermediary or other entity 174 continually develops these tools 180 for the benefit of the clients and others that publish or distribute or otherwise interact with media.

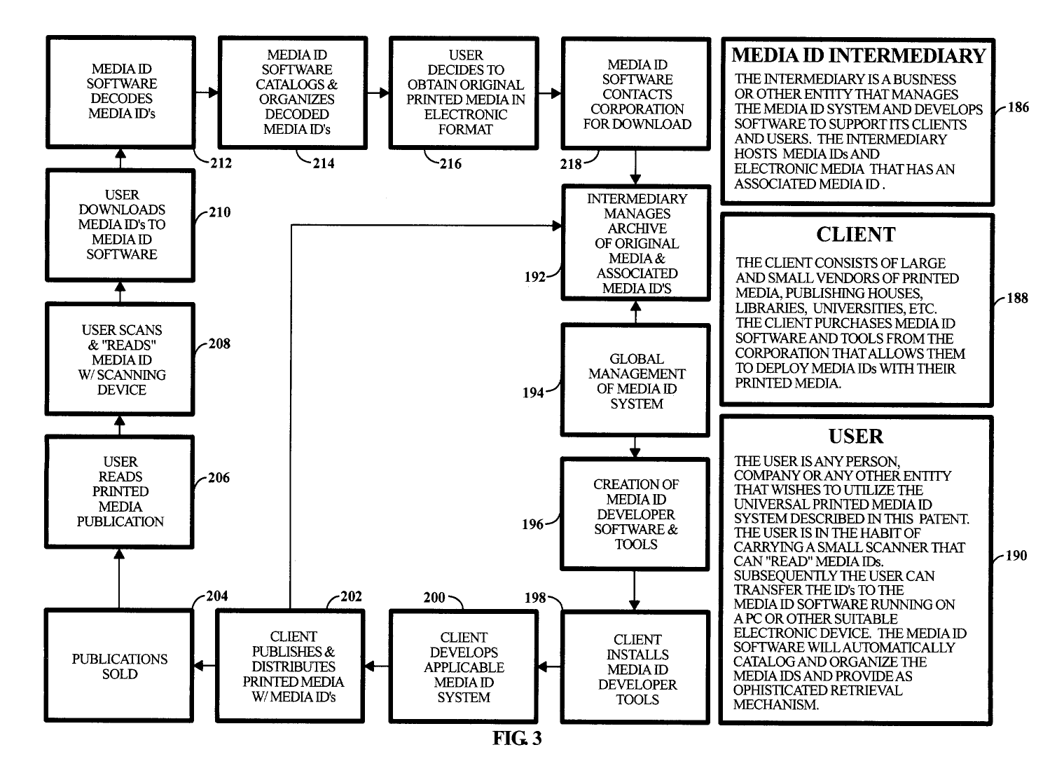

FIG. 3 displays several components to this system: a media ID intermediary or other entity, a set of clients, and a set of users. FIG. 3 displays the basic elements of the universal media ID system and illustrates how they interact. The central element of the universal identification system for printed media is the media identification tag or marker and its data structure. An embodiment of the media ID system provides a common language that forms an umbrella under which unique identifications for all types of printed and electronic media are established.

A media ID intermediary or other entity 186 is a business or other entity that manages the media ID system and data structure and develops software to support its clients and users. Additionally, the media ID intermediary 186 hosts media IDs and printed and electronic “originals” of all printed and electronic media that possess an associated media ID. The media ID intermediary or other entity 186 makes these media IDs and printed and electronic “originals” available for download through varying arrangements negotiated with its clients (generally vendors of printed and electronic media) and with its users.

The client 188 consists of large and small vendors of printed and electronic media, publishing houses, libraries, universities, scientific agencies, the government, etc. The client 188 usually purchases or licenses media ID software and other tools from the media ID intermediary 186. The purchase of media ID software and tools enables the client to deploy media IDs with their articles of printed media. In some cases, the client pays the media ID intermediary or other entity a royalty for the use of the media ID system. In one embodiment, the client 188 receives ongoing professional support from the media ID intermediary 186.

The user 190 of the universal media ID system can be any person, any company, any government, or any other entity that wishes to utilize the universal printed media system. When the user 190 of this media ID system is a person, they are in the habit of carrying a small electronic scanner that can “read” the printed media IDs that are collocated with articles of media. Once “read”, the user 190 has a variety of options. For instance, the media ID is downloaded to the media ID software running on a computer or other device. The media ID software automatically organizes and catalogs all downloaded media IDs and provides sophisticated retrieval and analysis tools. The user 190 is concerned with timesavings and convenience, and enjoys the productivity gains realized from using the art associated with the media ID system described herein.

The media ID intermediary 186, the client 188, and the user 190 together have a sophisticated and mutually beneficial relationship illustrated in the interactions of blocks 192 through 218. At 194, the media ID intermediary 186 provides global management of the universal media ID system. The media ID intermediary 186 has been empowered to manage, modify, and otherwise maintain the media ID language. At 196, the media ID intermediary 186 is engaged in the ongoing development and creation of media ID software developer tools and other tools for the clients 188 to use in association with “printing” or otherwise locating media IDs with their articles of printed media.

Media ID software and supports services are transferred from the media ID intermediary 186 to the clients 188 between items 196 and 198. At 198, a client 188 installs the media ID software developer tools. These tools include software, hardware and protocols that allow the client 188 to print or otherwise place media IDs with the articles of printed media associated with their publications. At 200, the client 188 installs the media ID tools and develops a media ID production system. The result of this integration is the establishment of a method and a system for the client 188 to distribute unique media IDs with articles of printed media.

At 202, the client 188 publishes and distributes printed media articles. Note that a copy of the material is sent to the media ID intermediary or other entity between 202 and 192. Each article or other media type has an associated media ID that can be scanned and “read” or otherwise acquired with the aid of a handheld electronic device. The printed media ID contains a unique identification that consists of fields or blocks of information. For instance, these fields might include (but are not limited to) the media ID version, the publisher, the year of publication, the media author, the title, the icon type, the number of graphics, the song title, etc. At 204, the printed media with the collocated media ID is distributed to users 190.

At 206 of FIG. 3, a user 190 reads the printed media. Here reading can be generally interpreted to mean with the use of human eyesight. It is reasonable to assume that a user 190 finds certain articles of media of sufficient interest as to want to save the unique media identification associated with it. At 208, a user 190 deploys his or her handheld electronic media ID scanner and “reads” the media ID associated with the printed article. The scanner has a memory component and saves a copy of the media ID in electronic digital form. At 210, a user 190 downloads the media ID to the media ID software. The media ID software receives the media ID through a wireless connection or direct connection with the handheld scanner. At 212, the media ID software decodes the media ID that it just received from the handheld media ID scanner. The media ID software now has the full content of the media ID as published by the client 188 and in conformity with the media ID system (and in this embodiment managed by the media ID intermediary 186).

This media ID is unique and contains enough relevant information about the original printed media article for sophisticated cataloging and storage to occur. At 214, the media ID software takes the decoded media ID and catalogs and organizes it in its internal database. The organization system that the media ID software utilizes is described in detail below. The media ID software comes standard with a default directory structure, or a user-definable structure. Once cataloged and stored, a user 190 can easily find the media ID at some future time by using the media ID software.

At 216, a user 190 can obtain the full content of the original printed media. At 218 a user 190 contacts the media ID intermediary 186 through the media ID software to obtain the original article of media. The original article of media can be obtained in electronic or printed form. The original article of media is transmitted to the user between 218 and 192. The media ID intermediary or other entity 186 manages media IDs and the associated media at block 192. This management also includes the archival and hosting of media IDs and associated media.

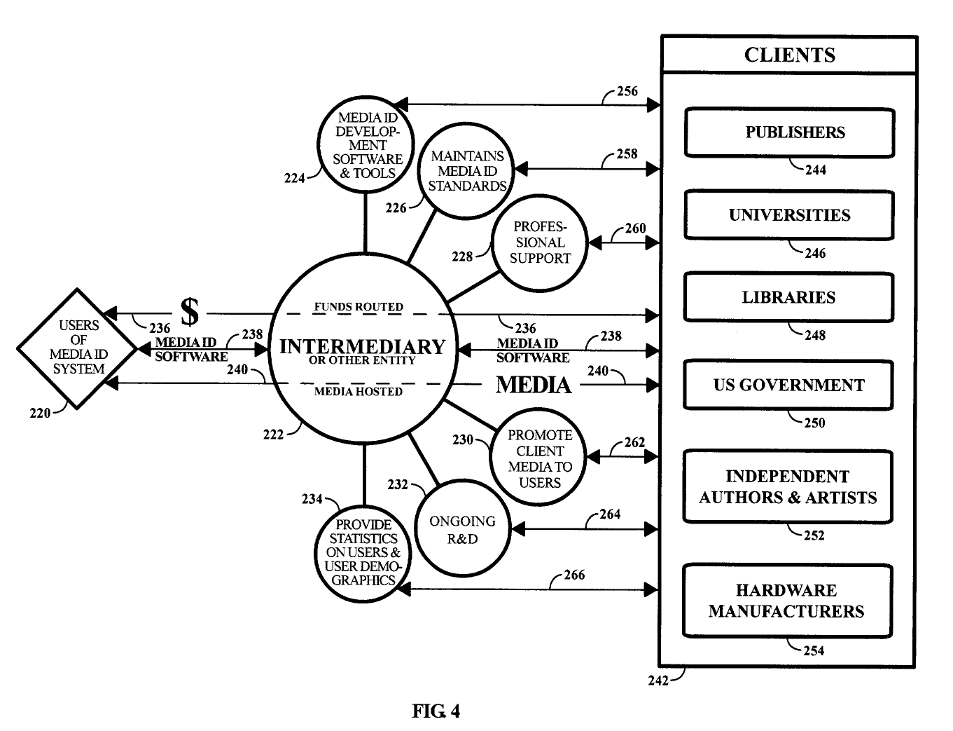

FIG. 4 displays the relationship between the media ID intermediary 222 and the clients 242. A mutually beneficial relationship exists between the media ID intermediary 222 that manages the media ID system and the clients 242 that deploy media IDs with their printed media. The clients 242 include publishers, universities, libraries, the US government, foreign governments, independent authors and artists, hardware manufacturers, and others.

Items 224 through 234 display the services that the media ID intermediary 222 provides on behalf of the clients 242. The clients 242 are in the business of providing superior media products to users 220. The media ID intermediary 222 advances this primary business interest of the clients 242 by providing a universal identification system for printed media articles, among other things. At 224, the media ID intermediary 222 provides media ID development software and tools to the clients 242. Item 224 is connected to 242 with a two-way arrow 256 to indicate the ongoing interaction between the media ID intermediary 222 and the clients 242 with regard, to media ID software development and other support. It is inevitable that the media ID system will grow and evolve as its clients 242 develop new media formats and delivery systems, and as new technology becomes available.

The interaction of the media ID intermediary 222 and the clients 242 between 224 and 242 provides an ongoing mechanism for the media ID intermediary to continually support the clients 242 as they deploy unique media IDs for each article of media that they produce.

At 226, the media ID intermediary 222 maintains media ID standards for its clients 242. The media ID intermediary 222 manages and develops the standards that govern the use and placement of the media IDs that are collocated with the articles of media distributed and sold by the clients 242. The media ID intermediary 222 mediates any disputes that might arise over the structure, use, or placement of media IDs.

At 228, the media ID intermediary 222 provides professional support to the clients 242 pertaining to the use and deployment of media IDs. This support includes professional services related to hardware, firmware, and software related to the deployment and management of the universal media identification system described herein.

At 230, the media ID intermediary 222 actively promotes the interests of its clients 242. In one embodiment, the media ID intermediary 222 is in a unique and powerful situation as the manager of the universal media ID system. Its role as a host from which users download media establishes it as a “hub” in the information world. The media ID intermediary 222 has unique information about the types of information its user-base is interested in. The media ID intermediary 222 also has access to the users 220 through the download mechanism. The strategic position the media ID intermediary 222 occupies vis-à-vis its hosting of articles of media that that users 220 access enhances its ability to promote media that its clients 242 create or otherwise distribute. At 232, the intermediary engages in ongoing research and development.

At 234, the media ID intermediary 222 compiles statistics on the media preferences of its users 220 and in some instances how these preferences intersect with demographics. In some cases these statistics are being provided to the media ID intermediaries clients 242 for their ongoing sales and marketing strategies. In other cases, the media ID intermediary 222 uses this information to advance its own sales and marketing strategies.

At line 240, the articles of media that have associated media IDs leave the various clients 242 and are received by the media ID intermediary 222. The media ID intermediary 222 hosts these “original” copies of the media in anticipation that its user base 220 will contact the media ID intermediary 222 for access to the “original” article of media. A user 220 who has read a particular article of media and finds it of interest deploys his or her handheld scanner and “reads” the unique media ID associated with the article. The user then transfers it to the media ID software. The media ID software automatically catalogs and organizes the media ID in its database.

A user 220 can then purchase the full text and graphics of the original article of media from the media ID intermediary 222. At line 238 the user 220 contacts the media ID intermediary 222 through the media ID software and purchases the original article, plus a closely related article that the media ID intermediary 222 suggests based upon its statistical and heuristic analysis of what other articles the user 220 would be interested in. The article is transferred from the media ID intermediary 222 to the user 220 along line 240. At line 236, the user 220 transfers money to the media ID intermediary 222, which in turn transfers money to the appropriate clients 242 that published the article of media.

The following examples are presented as an illustration of the embodiment of FIG. 4. A publisher 244 of a printed magazine obtains and installs the media ID development software and tools located at 224 from the media ID intermediary 222. The publisher 244 installs the necessary software and hardware to begin “printing” or otherwise locating media IDs with its printed media. In addition to providing the publisher 244 of the magazine with the necessary software and hardware tools at 224, the media ID intermediary 222 also supports the publisher 244 at 228 with professional services. The publisher 244 publishes a magazine with unique media IDs for each media article. Coincident with the physical distribution of the printed magazine, the publisher 244 of the magazine sends a copy of the entire magazine and each article of media within it and the associated media IDs to the media ID intermediary 222.

The media ID intermediary 222 receives the magazine from the magazine publisher 244 and prepares the information so that the media ID user 220 can download portions of it, or all of it. The media ID intermediary 222 catalogs and organizes the magazine and all sub-components (including articles of media, advertisements, etc.) in preparation for user 220 requests. The universal media ID system provides a common identification language that these three entities each “speak”. The media ID intermediary 222 readies all aspects of the magazine printed by the publisher 244 for user 220 access. At line 238 a user 220 contacts the media ID intermediary 222 through their media ID software to purchase an article of media from the media ID intermediary 222. The user 220 request for this article of information is based upon the media ID that he or she scanned from the original article of printed media. The user 220 also requests information from an advertisement located in the magazine that had an associated unique media ID. The media ID intermediary 222 receives the user request along line 238, verifies that the user 220 has an account with the media ID intermediary 222, and then processes the request. The original media is sent to the user 220 along line 238. Alternately, the original media can be sent to the user by physical mail in printed form.

In another example, an independent author 252 of a printed book obtains and installs a subset of the media ID development software and tools 224 from the media ID intermediary 222. The independent book author 252 installs the necessary software and hardware to begin “printing” media IDs with his newly released book. In addition to providing the independent publisher 252 of the book with the necessary software and hardware tools at 224, the media ID intermediary 222 also supports the independent publisher 252 with limited professional services 228 to assist the author 252 in “printing” media IDs with the soon-to-be-released book. The author 252 publishes the book with a unique media ID for the book as a whole, and a unique media ID for each chapter of the book.

Coincident with the physical distribution of the printed book, the independent author/publisher 252 of the book utilizes the media ID development software and tools 224 purchased from the media ID intermediary to publish media IDs with his book. He then sends a copy of the entire book and each chapter within it and the associated media IDs to the media ID intermediary 222. The media ID intermediary 222 receives the book from the independent author/publisher 252 and prepares the information so that users 220 can download individual chapters of the book, or the entire book. The media ID intermediary 222 catalogs and organizes the book and its chapters in preparation for user 220 requests.

The media ID system allows the media ID intermediary 222, the author 252 and the user 220 to interact in concert. The universal media ID system provides a common language that the author 252 can utilize to identify his work with media IDs so that the media ID intermediary or other entity 222 will recognize it. The media ID intermediary 222 readies all aspects of the book printed by the publisher 252 for user 220 access. A user 220 contacts the media ID intermediary 222 through their media ID software to purchase a chapter from the media ID intermediary 222. The user 220 request for this chapter is based upon the media ID that he or she scanned from the original printed media ID, or is based upon other media IDs, related media, information conveyed by friends, information from the Internet, etc. The media ID intermediary 222 receives the user 220 request along line 238, verifies that the user 220 has an account with the media ID intermediary 222, and then processes the request. The original media (in this case a chapter of a book) is sent to the user 220 along line 238. This original media can also be sent in printed form.

In another example, the US Government 250 obtains and installs a subset of the media ID development software and tools from the media ID intermediary 222. The Government 250 installs the necessary software and hardware to begin “printing” media IDs with a new report on radon in the United States. In addition to providing the Government 250 with the necessary software and hardware tools located at 224, the media ID intermediary 222 also supports the Government 250 with professional services 228 to assist the government in “printing” media IDs with the soon-to-be-released report on radon. The Government 250 publishes the report on radon with a unique media ID for the report as a whole, and a unique media ID for each chapter of the report.

Coincident with the physical distribution of the printed report, the Government 250 sends a copy the entire report and each chapter within it and the associated media IDs to the media ID intermediary 222 along line 240. The media ID intermediary 222 receives the report from the Government 250 and prepares the information so that users 220 can download individual chapters of the report, or the entire report. The media ID intermediary 222 catalogs and organizes the report and its chapters in preparation for user 220 requests.

The universal media ID system provides a common language that the US Government 250 can use to identify its work so that the media ID intermediary 222 and other entities will recognize its identification tags. The media ID intermediary 222 readies all aspects of the report printed by the US Government 250 for user 220 access.

A user 220 contacts the media ID intermediary 222 through their media ID software to purchase the report on radon. The user 220 request for this report is based upon the media ID that he or she scanned from the original article of printed media. The media ID intermediary 222 receives the user 220 request, verifies that the user 220 has an account with the media ID intermediary 222, and then processes the request. Additionally, the media ID intermediary 222 allows the users 220 to subscribe to US Government 250 reports that are delivered to them when they become available and are related to the users 220 specified interests.

The original media (in this case the entire report on radon) is sent to the user 220 along line 240, or along line 238. This original media can be sent in electronic form or printed form. In this example, the demographics of the users 220 who are interested in radon are also recorded and analyzed. The media ID intermediary 222 is continually gathering statistical and other information 234 about the demographics and makeup of users 220 who are downloading the report on radon. The US Government 250 can access this demographic and statistical information and, if desired, include it in its next report on radon.

In another example, a university 246 obtains and installs a subset of the media ID development software and tools 224 from the media ID intermediary 222. The university 246 installs the necessary software and hardware to begin “printing” media IDs for all of the Ph.D. dissertations at the end of the academic year. In addition to providing the university 246 with the necessary software and hardware tools 224, the media ID intermediary 222 also supports the university with professional services 228 to assist the university in “printing” media IDs for the Ph.D. dissertations. Coincident with the physical distribution of the printed Ph.D. dissertations, the university 246 sends a copy of all of the dissertations and the associated media IDs to the media ID intermediary 222. The media ID intermediary 222 receives the dissertations from the university 246 and prepares the information so that users 220 can download the individual dissertations.

In this example, the university 246 can place copies of the dissertations in libraries at the university 246 and at other libraries around the country. It is reasonable to conclude that student users 220 engaged in research at the library might prefer to scan the media ID and transfer it to a library printer rather than checking the book out, or waiting in a line to physically copy the dissertation.

The media ID intermediary 222 catalogs and organizes the dissertations in preparation for user 220 requests. The universal media ID system provides a common language that the university 246 can use to identify its academic work so that the media ID intermediary 222 and other entities will recognize its identification tags. The media ID intermediary 222 readies all aspects of the Ph.D. dissertations printed by the university 246 for user 220 access. A user 220 contacts the media ID intermediary 222 through their media ID software to purchase a university 246 dissertation from the media ID intermediary 222. The user 220 request for this report is based upon the media ID that he or she scanned from the original article of printed media, or search results based upon advanced media ID searches. The media ID intermediary 222 receives the user request from line 238, verifies that the user 220 has an account with the media ID intermediary 222, and then processes the request. The original media (in this case the complete dissertation) is sent to the user 220 along line 238. This original media can also be sent in printed form.

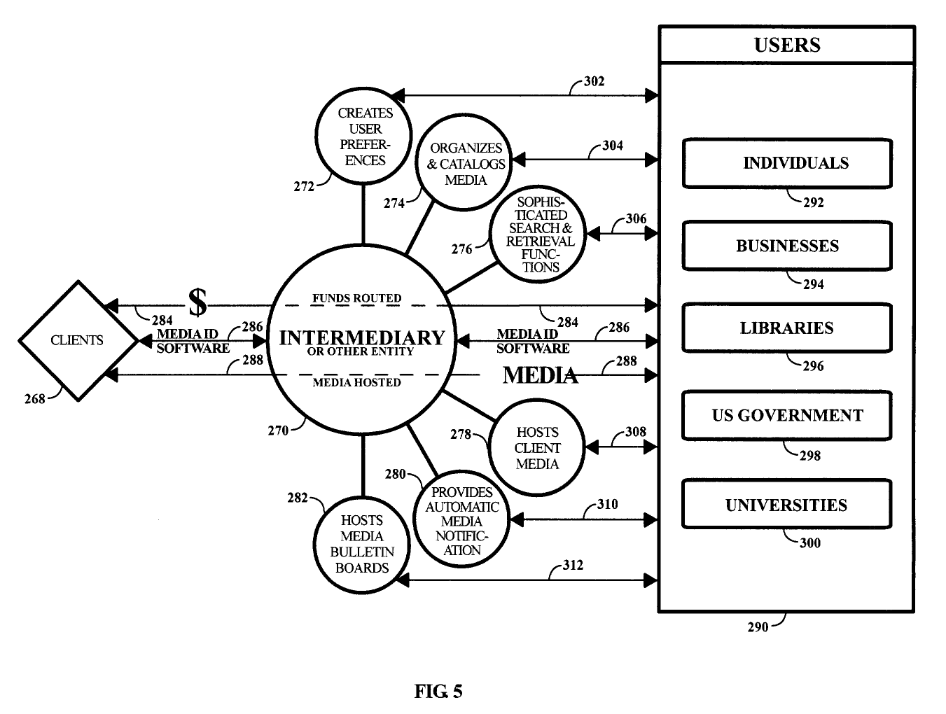

FIG. 5 displays the relationship between the media ID intermediary 270 and the users 290 of the media identification system. A mutually beneficial relationship exists between the media ID intermediary 270 that manages the media ID system and the users 290 that utilize the universal media ID system presented in this invention. The users 290 include individuals, businesses, libraries, governments, universities, and a multitude of others. Items 272 through 282 display the services that the media ID intermediary 270 provides on behalf of the users 290.

According to an embodiment of the invention, the media ID intermediary 270 provides a variety of services to the users 290 and clients 268 by managing the universal identification system for printed media articles. The media ID intermediary 270 creates user preferences 272 for each user 290 of the media ID system. These user preferences 272 allow the media ID intermediary 270 to provide customized service for each and every media ID user 290. Item 272 is connected to item 290 with a two-way arrow to indicate the ongoing interaction between the media ID intermediary 270 and the users 290 with regard to providing the user preferential treatment. The interaction of the media ID intermediary 270 and the users 290 provides an ongoing mechanism for the media ID intermediary 270 and it clients 268 to consistently make appropriate media suggestions to its user base 290.

The media ID intermediary 270 organizes and catalogs media 274. The media ID intermediary 270 provides sophisticated media search and retrieval functions 276 related to articles of media with associated media IDs. These services 276 include rapidly finding the media associated with the media IDs that the user 290 submits, as well as performing complex searches to find related media or related media IDs.

The media ID intermediary 270 hosts the client media 278 created or distributed by its clients 268. These media include magazines, books, newspapers, songs, digital video, etc. The media ID intermediary 270 provides automatic notification 280 to its users 290 when media of interest to the users 290 becomes available. Again, the media could include magazines, books, newspapers, songs, video, or a multitude of other printed and electronic formats.

In a further embodiment, the media ID intermediary 270 hosts sophisticated bulletin boards 282 and other online information services for the benefit of its users 290 and its clients 268. The bulletin boards and other services constitute a meeting place for users 290 to discuss media.

The articles of media that have associated media IDs originate at the various clients 268 and are received by the media ID intermediary 270. The media ID intermediary 270 hosts these “original” copies of the media in anticipation that its user 290 base will contact the media ID intermediary 270 for access to the “original” article of media. A user 290 who has read a particular article of media and finds it of interest deploys his or her handheld electronic scanner and “reads” the unique media ID associated with the article. The user 290 then transfers it to their media ID software. The media ID software automatically catalogs and organizes the media ID in its database.

The user 290 can then purchase the full text and graphics of the original article of media from the media ID intermediary 270. The user contacts the media ID intermediary 270 through the media ID software and purchases the original article, plus a closely related article of media that the media ID intermediary 270 suggests based upon its statistical and heuristic analysis 272 of what other articles the user 290 would be interested in. The article of media is transferred from the media ID intermediary 270 to the user along line 288 or along line 286. The user transfers money to the media ID intermediary 270 along line 284, which in turn transfers money to the appropriate clients 268 who originally published the article of media.

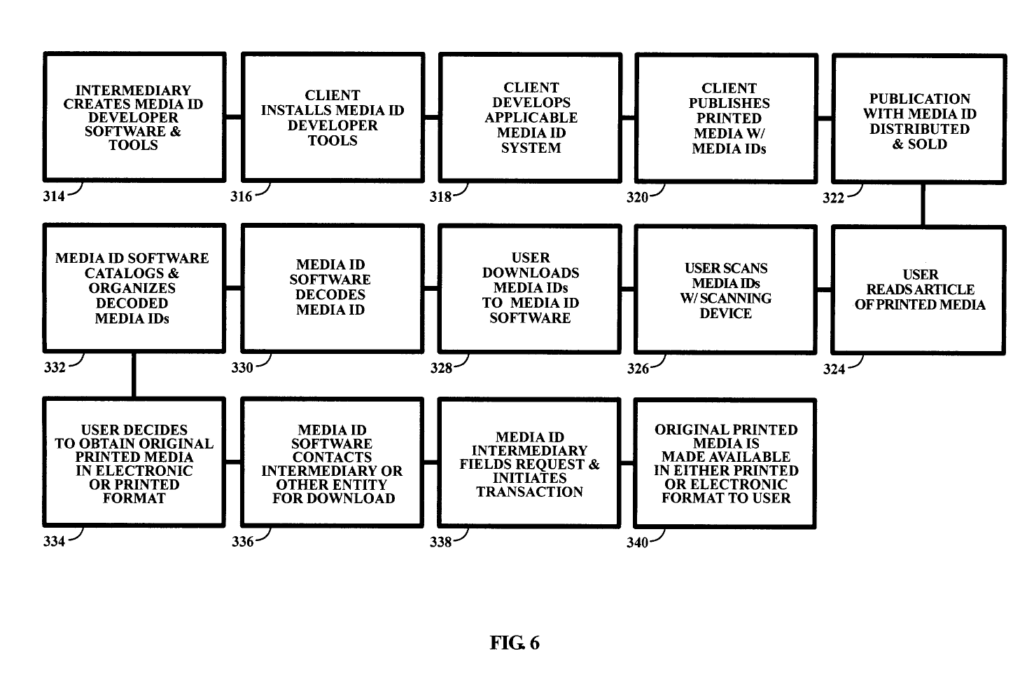

FIG. 6 helps illustrate some of the aspects of the application of a universal media identification system. At 314 a media ID intermediary or other entity creates the media ID development tools that clients will use to “print” or otherwise affix a unique media identification to printed articles of media. At 316 a client purchases and installs the media ID development tools. At 318 the client implements a media ID system whereby articles of printed media distributed by the client will have unique media identification tags.

At 320, the client publishes printed articles of media with associated media IDs that are in compliance with the universal media ID system. At 322 the publications with the media IDs are distributed and sold. At 324 a user reads an article of printed media and finds the article of media of interest. Because of this interest, the user deploys a handheld portable electronic scanner at 326 and “reads” or scans the media ID that is associated with the article. The media ID is stored in the memory component of the scanning device.

At 328 in FIG. 6, the user interfaces the handheld electronic scanner with the media ID software and downloads the media ID to the media ID software. At 330 the media ID software receives the media ID and performs a complete decode on it. At 332, the media ID software organizes and catalogs the media ID into its sophisticated database. Sometime in the future, the user can obtain the “original” article of media in electronic or printed format. The user makes this decision at 334. At 336, the user instructs the media ID software to contact the media ID intermediary that manages media IDs and hosts the original documents for sale or at no charge. At 338 the media ID intermediary receives the request from the user and initiates the transaction. At 340 the article of media is made available to the user in printed or electronic format.

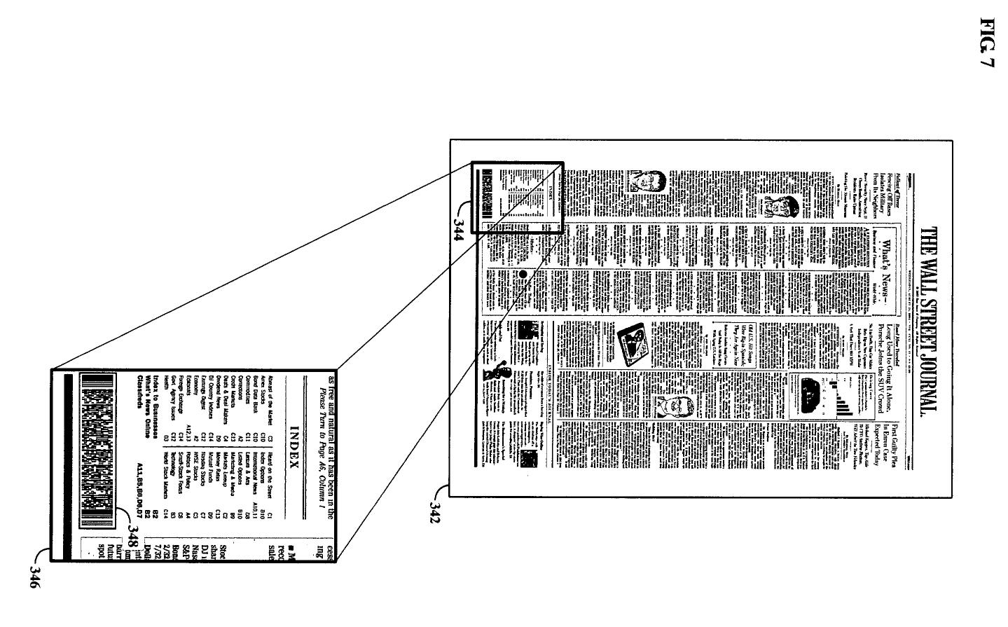

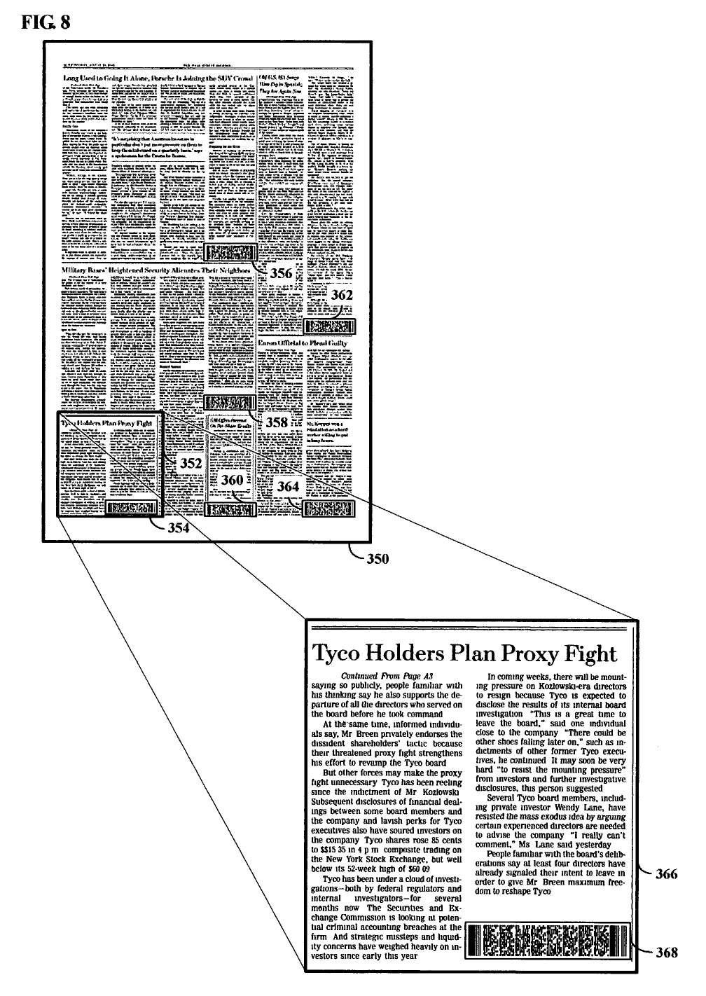

FIG. 7 and FIG. 8 show scanned images of two pages from a newspaper illustrating several of the many embodiments of the present invention. In FIG. 7, a printed media ID 348 has been placed in the lower left section 344 of the front page of the newspaper 342. In this embodiment, the printed media ID 348 utilizes a matrix bar code symbol, such as a PDF-417 format matrix symbol, that can be “read” or scanned by a handheld electronic scanner. Any other machine-readable format for encoding information can also be used. Further, printed media IDs may be encoded so that the media ID is normally invisible to the human eye, for example by using magnetic or fluorescent inks. This particular matrix symbol 348 is only one example of a header media ID as described, and has the following information encoded in it:

TABLE 1
Example Data Structure for “Header” Media ID 348

| | Field Name | Contents | Decodes To |
|---|---|---|---|
| Field 1 | MediaIDVersion | ENG1.00000 | MediaID Version |
| | | | English 1.00000 |
| Field 2 | MediaIDType | 00002 | Header MediaID |
| Field 3 | PublicationName | WSJ | Wall Street Journal |
| Field 4 | PublicationType | 00001 | Newspaper |
| Field 5 | Publisher | 00001 | Dow Jones & Co. |
| | | | Inc. |
| Field 6 | Author | N/A | N/A |
| Field 7 | DatePublished | 082102 | Aug. 21, 2002 |
| Field 8 | Edition | ME | Morning Edition |
| Field 9 | TotalPages | 00045 | 45 pages |
| Field 10 | TotalArticles | 00128 | 128 articles |
| Field 11 | TotalAdvertisements | 00067 | 67 advertisements |
| Field 12 | IconType | 00001 | Wall Street Journal |
| | | | Newspaper Icon |

The media ID 348 is just one example of a header or primary media ID. In this example, a media ID 348 is placed at the beginning of a document such as a newspaper, a magazine, or a book, and contains a global ID for the entire newspaper or magazine.

The portable handheld electronic scanner previously discussed in this invention can scan this media ID 348 and store it in its memory. Once it is stored in the scanner, it can be transferred to software running on computers, other electronic devices, hardware, etc. As an example, the media ID 348 is read by an electronic scanner, is stored in the scanner memory, and is transferred to the media ID software described herein via a wireless connection or through a direct connection. The media software will decode the example media ID 348 as follows:

MediaID Version English 1.00000/Header MediaID/Wall Street Journal/Newspaper/Dow Jones & Co. Inc.//Aug. 21, 2002/Morning Edition/45 pages/128 articles/67 advertisements/Wall Street Journal Newspaper Icon

In this example, the media ID identification information provides the media ID software with a unique set of data that it can use to classify and organize the newspaper 342 from Aug. 21, 2002 within its media ID database.

Similarly, FIG. 8 displays an image 350 from the inside page of a newspaper. Six matrix symbol type, two-dimensional media IDs have been placed at the end of six separate articles. The interested reader in any of these six articles who wishes to retain, catalog, and organize the media identifications for the printed articles can deploy his or her electronic handheld scanner and “read” the universal media IDs for each of the six articles. For each article scanned, the reader has captured the unique media ID of the article in the handheld scanner and has captured its universal media ID identification.

For instance, the media ID 354 at the bottom of column two could be encoded with the following information:

TABLE 2
Example Data Structure for Media ID 354

| | Field Name | Contents | Decodes To |
|---|---|---|---|
| Field 1 | MediaIDVersion | ENG1.00000 | MediaIDVersion |
| | | | English 1.00000 |
| Field 2 | MediaIDType | 00002 | Standard MediaID |
| Field 3 | PublicationName | WSJ | Wall Street Journal |
| Field 4 | PublicationType | 00001 | Newspaper |
| Field 5 | Publisher | 00001 | Dow Jones & Co. |
| | | | Inc. |
| Field 6 | Author | Joann Luvlin | Joann Luvlin |
| Field 7 | Co-Author | N/A | N/A |
| Field 8 | Title | Tyco Holders Plan | Tyco Holders Plan |
| | | Proxy Fight to Oust | Proxy Fight to Oust |
| | | Directors | Directors |
| Field 9 | PublicationDate | 082102 | Aug. 21, 2002 |
| Field 10 | Edition | ME | Morning Edition |
| Field 11 | StartPage | A3 | Page A3 |
| Field 12 | ArticleNumber | 12 | Article 12 |
| Field 13 | TotalArticles | 55 | Total of 55 articles |
| Field 14 | MediaTheme | 00001 | American Business |
| | | | News |
| Field 15 | MediaGenre | N/A | N/A |
| Field 16 | IconType | 00002 | Wall Street Journal |
| | | | American Business |
| | | | News Icon |

In this example, the user scans and “reads” the information contained in the media ID 354 (and shown enlarged 368 at blowup 366) from the “Tyco Holders Plan Proxy Fight” story and then downloads it to the media ID software. The media ID software will decode the unique ID 354 and will have all necessary information to organize and catalog the article in its database.

This provides an electronic archive of the media ID 354 from the newspaper story until such time that the user needs the media ID 354 information, or the entire text and graphics from the original article, or needs to perform a search for similar articles of media and therefore similar media IDs. The media ID software will decode the media ID 354 for the “Tyco” story as follows:

MediaID Version English 1.00000/Standard MediaID/Wall Street Journal/Newspaper/Dow Jones & Co. Inc./Joann Luvlin//Aug. 21, 2002/Morning Edition/Page A3/Article 12/Total of 55 articles/American Business News//Wall Street Journal American Business News Icon

The universal media ID method and system assigns a unique ID to each printed media article such as the one above for the “Tyco” story. Once the media ID has been decoded and stored in the media ID software database, the media ID software will provide the vehicle to retrieve the entire article at a later date and even retrieve articles with related subject content.

Table 3 displays the data structure of another example media ID 364 that is also located on FIG. 8 and has been “printed” on the very bottom of column six of the newspaper. This media ID 364 has a slightly different data structure in order to reflect the field “building block” structure for the universal media ID system, which allows for numerous variations of the media ID tag. An example data structure for the media ID 364 for the newspaper article “First Guilty Plea In Enron Case Expected Today” is presented below in Table 3.

TABLE 3
Example Data Structure for Standard Media ID 364

| | Field Name | Contents | Decodes To |
|---|---|---|---|
| Field 1 | MediaIDVersion | ENG1.00001 | MediaID Version |
| | | | English 1.00001 |
| Field 2 | MediaIDType | 00001 | Standard MediaID |
| Field 3 | PublicationName | WSJ | Wall Street Journal |
| Field 4 | PublicationType | Newspaper | Newspaper |
| Field 5 | Publisher | Dow Jones & Co. | Dow Jones & Co. |
| | | Inc. | Inc. |
| Field 6 | Author | Jonathan Weil | Jonathan Weil |
| Field 7 | Co-Authors | Kathryn Kranhold | Kathryn Kranhold |
| Field 8 | Title | First Guilty Plea | First Guilty Plea In |
| | | In Enron Case | Enron Case |
| | | Expected Today | Expected Today |
| Field 9 | PublicationDate | 082102 | Aug. 21, 2002 |
| Field 10 | Edition | ME | Morning Edition |
| Field 11 | StartPage | A1 | Page A1 |
| Field 12 | ArticleNumber | 4 | Article 4 |
| Field 13 | TotalNumberofArticles | 55 | Total of 55 articles |
| Field 14 | MediaTheme | US Business | US Business News |
| | | News | |
| Field 15 | MediaGenre | N/A | N/A |
| Field 16 | IconType | 00002 | Wall Street Journal |
| | | | American Business |
| | | | News Icon |

FIG. 7 and FIG. 8, combined with Tables 1 through 3, illustrate how an embodiment of the present invention provides a method and a system for a reader of printed media (in this case a printed newspaper) to catalog and organize printed media without having to store and manually organize a physical copy of the printed media.

FIG. 7 and FIG. 8 provide graphical representations of an embodiment of the invention. This example assumes that Dow Jones & Co. Inc. has adopted the media ID system described in this patent for their Wall Street Journal publication. As a competitive and publicly traded company, they would have an advantage over their competitors who have not adopted the universal media ID system. Readers of other papers that lack the media ID system presented in this patent will have to continue to manually organize physical copies of newspapers and archive them in physical file cabinets instead of with electronic software. Such an imbalance will naturally confer to the Dow Jones & Co. Inc. a competitive advantage. By providing readers with media encoded with media IDs, publishers provide additional value to their users and inure substantial competitive benefit.

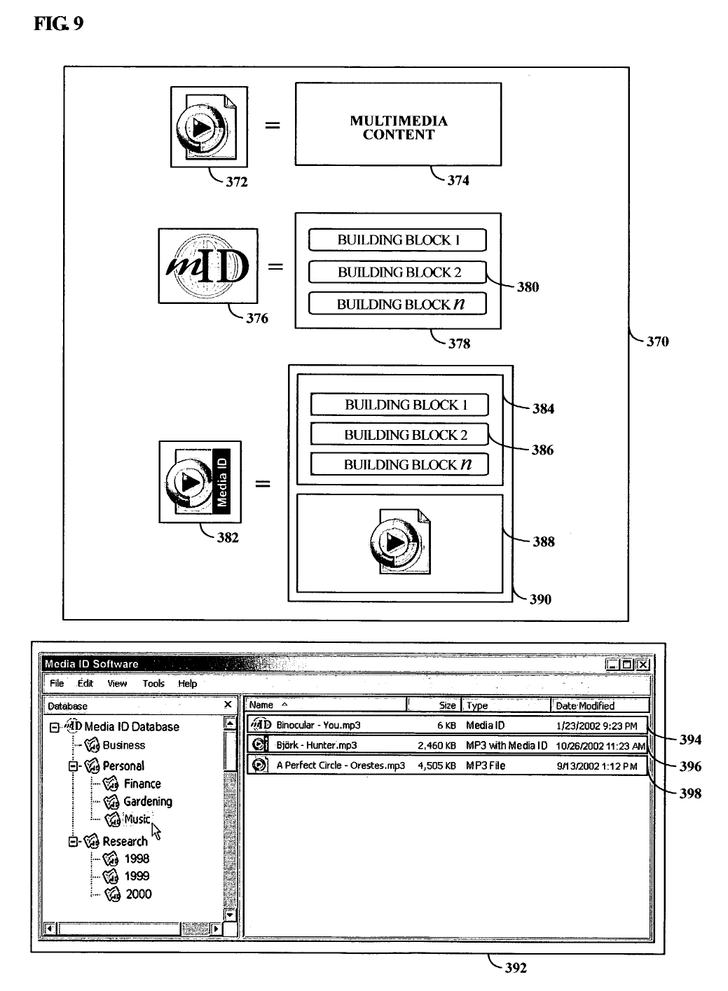

FIG. 9 shows various aspects of the media ID structure and its relationship to the associated article of media. A media ID software database window 392 contains a media ID 394 with or without attached media, an article of media with an attached media ID 396, and an article of media 398. The media ID software can contain, organize, manage, import, export, and design and execute searches with all of these media forms.

An article of media 372 contains multimedia content 374. An article of media 398 usually is associated with a media ID but can exist without one in the media ID software database window 392.

A media ID 376 that uniquely represents an article of media consists of information fields 378 that contain information about the article of media it is associated with. These media ID information fields 378 uniquely define and identify the article of media that the media ID 376 is associated with. In many cases, a user of the universal identification system for printed and electronic media is concerned with the media ID only, and not the original article of media that it identifies. This is logical because the media ID and the media ID software provides a mechanism for the user to easily retrieve the original article of media at anytime. This is due to the comprehensive identifying nature that is inherent with the universal media identification system. Media can also be included within the media ID, residing at a specified building block or information field (e.g. 380) within the media ID 376.

An article of media is shown at 382 with attached media ID information. The media ID 384 consists of information fields (e.g. 386) that uniquely define and identify the article of media 388 that the media ID is associated with. In this example, the media ID 384 is an integral part of the media 388 that it identifies. In many cases the user wishes to download the media ID that uniquely identifies an article of media and the article of media itself at the same time. This is especially true of electronic media where users are often downloading media IDs from web pages that display the article of media on a web page that is loaded in system memory on the user's computer.

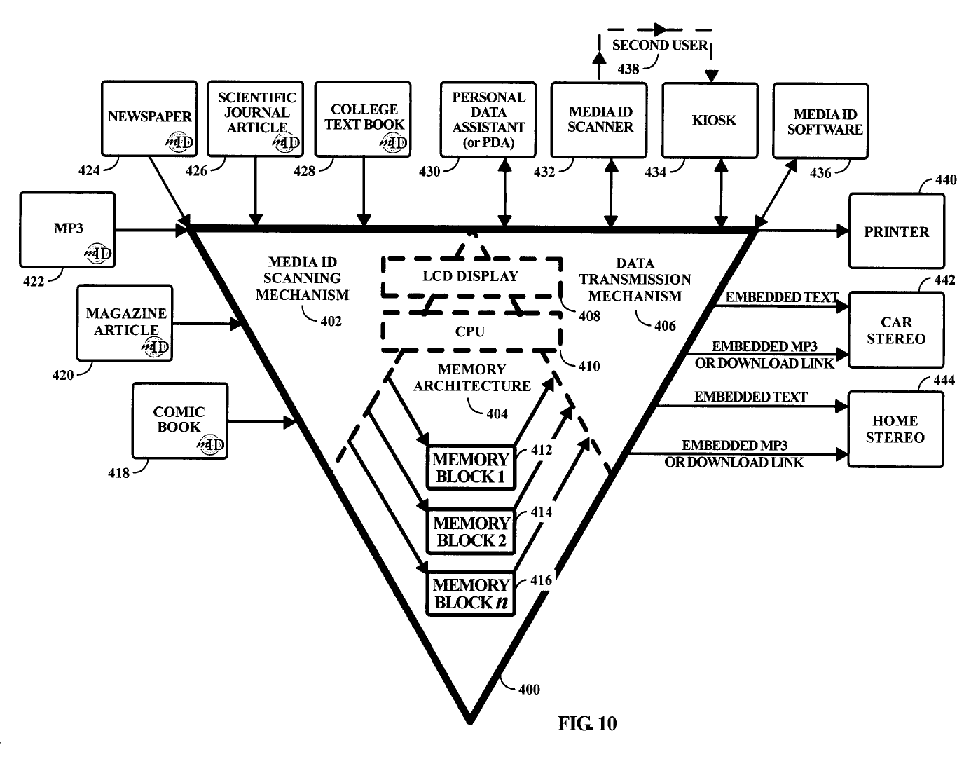

FIG. 10 shows an embodiment of a handheld electronic media ID scanner 400. The media ID scanner 400 consists of three fundamental components and many secondary components. These fundamental components are a media ID scanning mechanism 402 (e.g. a charged-coupled-device (or CCD) or laser scanner technology) for scanning media identification tags or media IDs, a central memory architecture 404, and a data transmission mechanism 406.

Items 402 through 416 represent the three central components of the media ID scanner plus the memory blocks within the memory architecture, the LCD or other display, and the CPU. The remaining items in FIG. 10 represent articles of printed or electronic media that the media ID scanner scans or “reads” and other electronic devices that the media ID scanner interfaces with. The electronic media ID scanner 400 contains computer firmware that can be upgraded as needed through a direct connection or a wireless connection. The LCD display 408 and the CPU 410 can interact with items 402, 404, and 406 independently of each other or in any combination thereof.

A scanning mechanism 402 is that part of the media ID scanner that “reads” or scans the media ID that is located on the printed media. The scanning mechanism 402 uses technology like optical character recognition (or OCR) and charge-coupled-technology (or CCD) to scan and identify the media ID located on the printed media. This scanning technology is capable of “reading” media IDs such as the ones located in association with the scientific journal 426. Once a media ID is “read”, the scanning mechanism 402 hands the media ID off to the memory architecture component 404. The media ID is then stored in one of the memory architecture 404 memory blocks (items 412, 414, and 416).

The memory architecture 404 can contain many media IDs in digital format. When the user transfers his or her collected media IDs to a computer or other electronic device, the memory architecture 404 hands the media IDs to the data transmission mechanism 406. The data transmission mechanism 406 is the interface mechanism to send and receive media IDs between other hardware and software.

For example, a media ID is sent from the data transmission mechanism 406 of the electronic media ID scanner to a printer 440. The printer 440 then prints out the full text and graphics of the original article of media or some subset of the original information. In this example it is assumed that the printer 440 is connected to a network and has communication and an account with the media ID intermediary or other entity, or the media information is embedded or otherwise locally referenced in the media ID contained in the handheld electronic scanner.

Alternately, a personal data assistant (or PDA) 430 is instructed to send a media ID to the data transmission mechanism 406 of the media ID scanner 400. The media ID is received at the data transmission mechanism 406 and stored at memory block 414 in the memory architecture 404. This media ID (now stored at memory block 414 of the media ID scanner 400) is sent to the printer 440. The media ID that originated at with the PDA 430 is received from the media ID scanner 400 by the printer 440 and then printed. The original article of media associated with the media ID can also be printed. The following examples illustrate the interaction of the media ID scanner 400 with printed media IDs and other electronic devices.

A media ID for an MP3 song 422 is transferred to the media ID scanner 400. The scanning mechanism 402 of the handheld scanner is deployed to capture the MP3 422 media ID. Once the media ID for the MP3 422 is scanned or “read”, the scanning mechanism 402 hands the media ID off to be stored at memory block 412 in the memory architecture 404.

The media ID for the MP3 422 is stored in memory at block 412. The user of the handheld electronic scanner 400 can transfer the media ID for the MP3 song 422 to his or her car stereo, 442. This is accomplished by the memory architecture 404 handing the MP3 422 media ID over to the data transmission mechanism 406. The MP3 422 media ID is readied for transmission and is then sent to the car stereo 442 through a wireless, cable, or other transfer method. In some embodiments of the present invention, the media ID for the MP3 422 will have the complete sound file necessary for the car stereo 442 to play the song. In other cases the media ID will only have the necessary ID information for the car stereo 442 to download the MP3 422 from another source (like the media ID intermediary).

The media ID for an article of news in a magazine 420 is transferred from the printed media to the media ID scanning mechanism 402 of the media ID scanner 400. The scanning technology 402 is deployed to capture the magazine article 420 media ID. Once scanned or “read”, the media ID is sent to the memory architecture 404. The media ID is stored at memory block 416 in the memory architecture 404.

The user of the handheld electronic scanner 400 can transfer the media ID for the magazine article 420 to his or her media ID software 436 on a personal computer. This is accomplished by the memory architecture 404 handing the magazine article 420 media ID over to the data transmission mechanism 406. The magazine article 420 media ID is readied for transmission and is then sent to the media ID software 436 through a wireless, wired, optical, or other transfer method. The media ID software 436 receives the media ID for the magazine article 420 and automatically catalogs and organizes it.

The media ID from an article in a scientific journal 426 is transferred from the printed media of the scientific journal 426 by the media ID scanning mechanism 402 of the media ID scanner 400. The scanning mechanism 402 is deployed to capture the media ID from the article in the scientific journal 426. Once scanned or “read”, the media ID scanning mechanism 402 hands the media ID off to the memory architecture 404 to be stored at memory block 412.

In an example, the user of the handheld electronic scanner 400 can transfer the media ID for the article in the scientific magazine 426 to an electronic kiosk 434. This is accomplished by the memory architecture 404 handing the scientific journal 426 media ID over to the data transmission mechanism 406. The scientific journal article 426 media ID is readied for transmission and is then sent to the electronic kiosk 434 through a wireless, cable, or other transfer method. The media ID software loaded at the kiosk 434 receives the media ID from the media ID scanner 400 and displays the full text and graphics of the original article on an electronic kiosk screen for the user to see. The kiosk 434 also automatically provides the user with a list of similar articles from other scientific journals on the same subject. The user has already established an account with the kiosk provider and can print the full text and graphics of the original article plus two related articles that the kiosk 434 presented.

The media ID from a chapter in a college textbook 428 is transferred from the printed media of the college textbook 428 to the media ID scanning mechanism 400 of the media ID scanner. The scanning mechanism 402 is deployed to capture the media ID from the chapter in the college textbook 428. Once scanned or “read”, the media ID scanning mechanism hands the media ID off to the memory architecture 404 to be stored in a memory block.

The user of the handheld electronic scanner 400 can transfer the media ID for the chapter in the college textbook 428 to another media ID scanner 432 owned by a fellow student at the same college. This is accomplished by the memory architecture 404 handing the media ID from the chapter from the college textbook 428 over to the data transmission mechanism 406. The media ID from the chapter from the college textbook 428 is readied for transmission and is then sent through a wireless media ID scanner 400 to media ID scanner 432 transfer. The other media ID scanner 432 receives the media ID from the chapter from the college textbook 428 and stores it in its own memory. The colleague who has received the media ID can print it out and study it, or otherwise interact with it. The media ID for the chapter in the college textbook 428 is sent from the media ID scanner 432 to an electronic kiosk 434 that is located on the college campus. The colleague has an account on the kiosk 434 and the kiosk displays the full text and graphics of the chapter from the college textbook 428. The colleague prints the chapter out for study at the kiosk 434.

A media ID from a newspaper article is transferred from another user's electronic handheld media ID scanner 432 into the data transmission mechanism 406 of the media ID scanner 400. Once the media ID transmission is accepted, the data transmission mechanism 406 then hands the media ID off to the memory architecture 404 of the media ID scanner 400. The media ID is stored in memory 412.

If the user of the handheld electronic media ID scanner 400 decides at some later time to review the article of media that was transferred from the media ID scanner 432 to his or her own media ID scanner 400, the user can download this media ID to the media ID software 436. This is accomplished by the user instructing the handheld electronic media ID scanner memory architecture 404 to hand over the media ID over to the data transmission mechanism 406.

The media ID is readied for transmission and is then sent to the media ID software 436 through a wireless or other transfer method. Once the media ID is at the media ID software 436, it is decoded and organized and cataloged by the media ID software 436. The media ID software 436 offers many research and retrieval methods that the user takes advantage of. These services provide the user with ten related newspaper and magazine articles. The user requests that the media ID software 436 send all ten media IDs for the related media articles to the handheld electronic scanner 400. The media IDs are sent from the media ID software 436 to the handheld media ID scanner 400. The data transmission mechanism 406 hands the ten media IDs to the memory architecture 404 where they are stored in memory block 414. At some later date, the user is at school and can retrieve and study the original full text and graphics of the ten related articles. The media IDs are sent from the memory architecture 404 to the data transmission mechanism 406, and finally to the electronic kiosk 434. At the kiosk 434 the full text and graphics of the original media is printed out for the user to study.

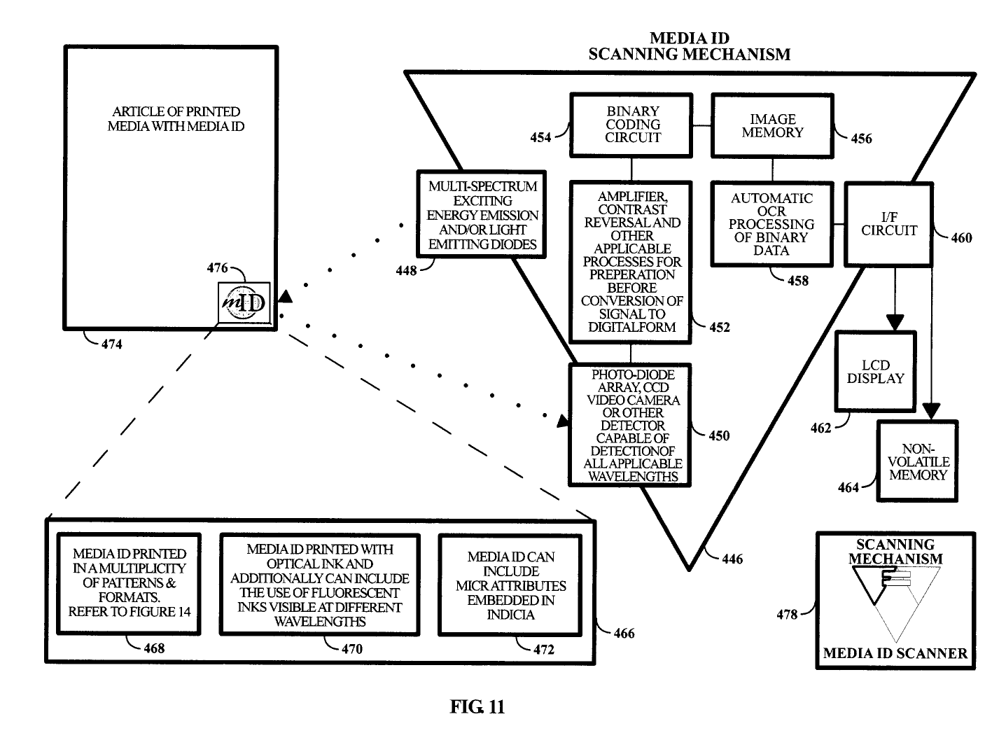

FIG. 11 displays a generalized media ID scanning mechanism 446 as discussed in an embodiment of the present invention. The inset diagram 478 is intended to display that the media ID scanning mechanism 446 is one of the three primary components of the electronic media ID scanner from FIG. 10.

The scanning mechanism 446 is composed of several items that illustrate how a typical electronic scanner operates. An article of printed media 474 has an associated media ID 476. This media ID 476 can be placed on the printed media 474 in a multitude of ways. Several of these methods for media ID placement are illustrated at 466.

The media ID scanning mechanism 446 has a multi-spectrum energy-emitting component 448 that directs light or another energy form towards the media ID 476 associated with the printed media 474. This light or energy is reflected to a detector 450 at the media ID scanning mechanism 446. A photo-diode array, charge-coupled video device, camera, or other detector 450 receives the reflected energy. This light/energy detector 450 is capable of detecting numerous wavelengths in order to support many different scanning technologies.

An amplifier 452 receives the signal from the detector 450. The amplifier 452 can perform contrast reversal and other applicable processes for preparation of the conversion of the signal to digital form. The signal is sent to a binary coding circuit 454 for conversion to digital format. The signal is processed by a binary coding circuit 454 and converted to digital format. Following this, the digital media ID signal is sent to image memory 456. The signal undergoes automatic optical character recognition (or OCR) processing 458 of the binary data or another applicable character recognition technique. Following this, the digital media ID signal is sent to an interface circuit 460 within the electronic media ID scanning mechanism 446.

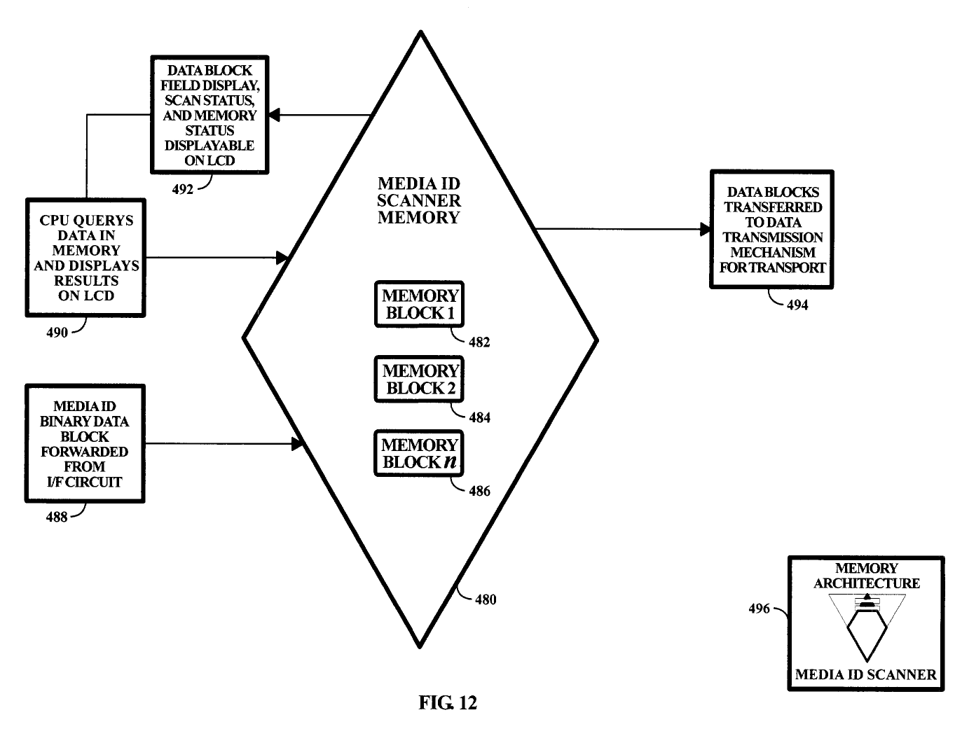

This interface circuit 460 provides a bridge to the memory component 464 of the electronic handheld media ID scanner (see FIG. 12). The interface circuit 460 also provides a bridge to the LCD or other display unit 462 built into the handheld electronic scanner. Immediately before, coincident with, or after the signal is sent to the scanner memory 464, a notification message is sent to the scanner display unit 462. This message alerts the user that the scan of the media ID was successful, and also provides pertinent information about the media ID and other relevant transfer information.

Three sub-blocks are located at 466 and are representative of several of the technologies that can be utilized to “print” or otherwise affix media IDs to printed media. At 468, a multitude of different shapes and patterns can be used to “print” media IDs. For example, a 2-D matrix bar code symbology like PDF-417, or a linear bar code symbology such as Code 128.

A variety of media ID printing technologies are represented at 470 that utilize optical ink. These technologies can be utilized to “print” the media IDs contained in this art. This can include the use of fluorescent inks that are visible at different wavelengths. Magnetic ink character recognition (MICR) technology is located at 472 and can be used to “print” media IDs on printed media. This also encompasses MICR attributes that are embedded in indicia. The handheld electronic scanner can scan these MICR indicia 472.

FIG. 12 shows an embodiment of the memory architecture 480 of the universal media ID scanner as illustrated herein. The inset diagram 496 is intended to display that the media ID memory architecture 480 is one of the three primary components of the electronic media ID scanner from FIG. 10.

FIG. 12 shows the relationship of the memory section 480 to the handheld electronic media ID scanner as a whole. Items 482, 484, and 486 show examples of the media ID scanner memory components. A media ID is forwarded from an interface circuit 488 or similar component (see FIG. 11) to the media ID scanner memory 480.

This media ID is received by the media ID scanner memory 480 and is stored in memory at 484, for instance. An information query 490 is sent to the electronic media ID memory section 480. This query originates from the user of the handheld media ID scanner (see FIG. 10). The media ID scanner memory 480 responds and sends information on its stored media IDs to a display mechanism 492. A user can view information on the display 492 regarding the number of media IDs stored, available memory left, etc.

FIG. 12 also shows a data transmission component 494. This data transmission component 494 provides a mechanism for the media IDs to be transmitted to other electronic devices. For example, a user downloads a media ID that is stored in memory 482 inside of his electronic media ID scanner memory 480. The user can download this media ID into his media ID software that is located on an external computer platform. The user initiates the download either through user input at the scanner or by request through the media ID software. The media ID is sent or routed from the memory 480 of the handheld media ID scanner to the media ID software located on the external computer via 494.

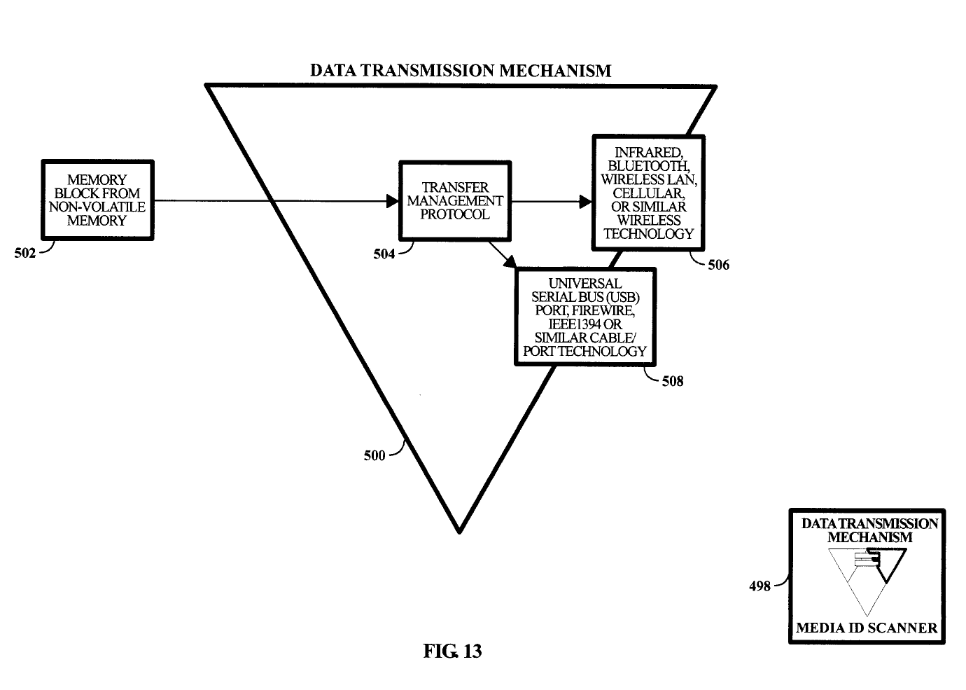

FIG. 13 shows an embodiment of the data transmission mechanism 500 of the electronic media ID scanner as illustrated herein. The inset diagram 498 is intended to display that the media ID data transmission mechanism 500 is one of the three primary components of the electronic media ID scanner from FIG. 10.

FIG. 13 shows the relationship of the data transmission mechanism 500 to the electronic media ID scanner as a whole. A media ID or memory block 502 containing media IDs is forwarded from the memory section (see FIG. 12). This media ID memory block 502 is received and is handled by the transfer management protocol or mechanism 504.

The transfer management protocol 504 is capable of transferring the media ID or block of media IDs in a variety of ways, including wireless transfer technologies 506 such as infrared, Bluetooth, and wireless LAN, and wired or direct connect transfer technologies 508 such as universal serial bus (or USB), serial port, Firewire, IEEE1394, or similar cable port technology. For example, a user can transfer a media ID received from the memory component 502 to an external computer running the media ID software by using Bluetooth technology 506.

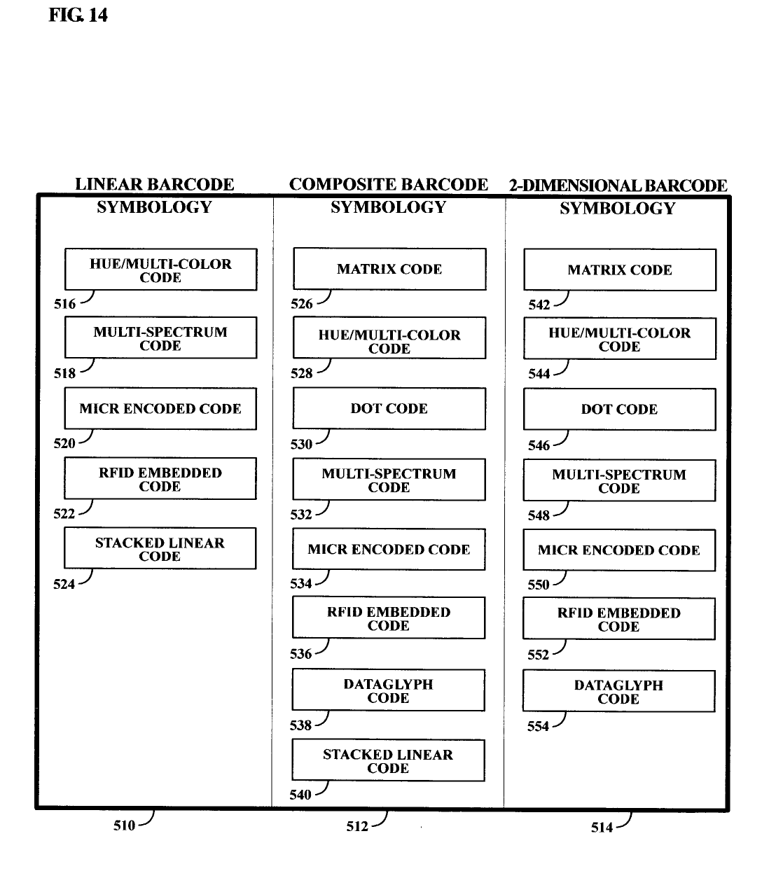

FIG. 14 is a diagram illustrating exemplary methods used to “print” or locate media IDs with articles of printed media. FIG. 14 displays linear bar code symbologies 510, composite bar code symbologies 512, and 2-dimensional bar code symbologies 514. It should be understood that methods described herein are for illustrative purposes and should not be construed as limiting in any sense.

A stacked linear bar code 524 is one embodiment of the present invention and can be used to “print” media IDs on printed media. A radio frequency identification (or RFID) 522 technology can be used to “print” media IDs on printed media. A magnetic ink character recognition (or MICR) technology 520 can be used to “print” media IDs. A multi-spectrum code 518 can be used to “print” media IDs. A hue or multicolor code 516 can be used to “print” media IDs. All of these linear bar code methods 510 can be used in the deployment of media IDs for printed media.

A composite matrix code 526 can be used to “print” media IDs on printed media. A composite hue/multi-color code 528 can be used to “print” media IDs. A composite dot code 530 method can be used to “print” media IDs. A composite multi-spectrum code 532 can be used to “print” media IDs. A composite MICR code 534 can be used to “print” media IDs. A composite radio frequency identification (or RFID) code 536 can be used to “print” media IDs. A composite dataglyph code 538 can be used to “print” media IDs. A composite stacked linear code 540 can be used to “print” media IDs.

A 2-dimensional matrix code 542 is one embodiment of the present invention and can be used to “print” media IDs on printed media. A 2-dimensional hue/multi-color code 544 method can be used to “print” media IDs. A 2-dimensional dot code 546 can be used to “print” media IDs. A 2-dimensional multi-spectrum code 548 can be used to “print” media IDs. A 2-dimensional MICR code 550 can be used to “print” media IDs. A 2-dimensional RFID code 552 can be used to “print” media IDs. A 2-dimensional dataglyph code 554 can be used to “print” media IDs.

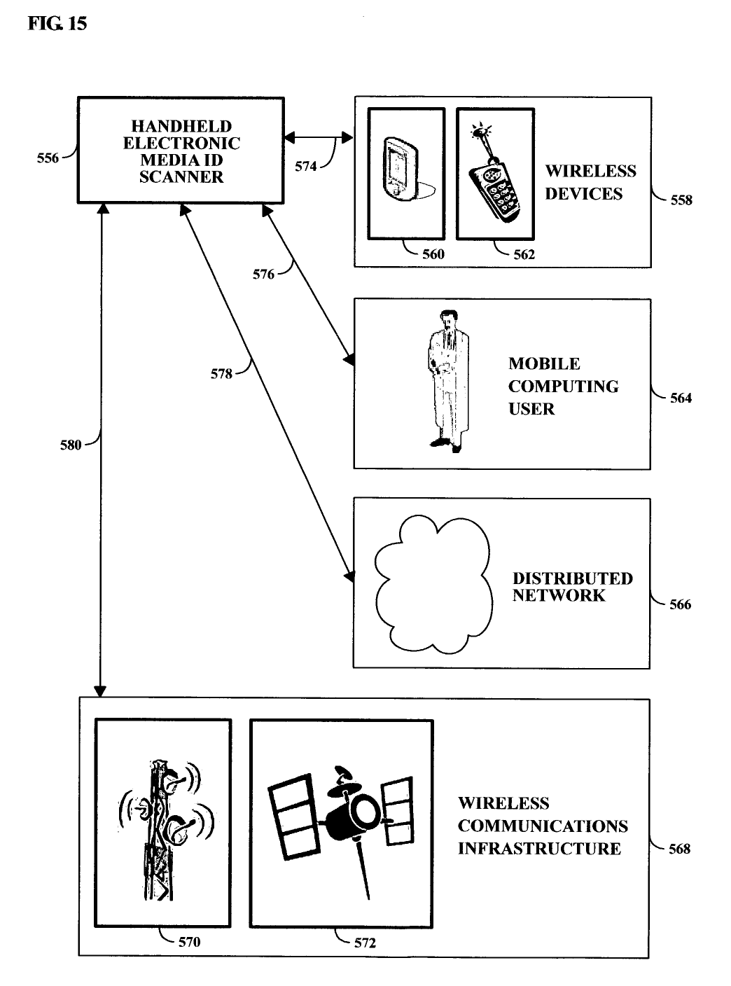

FIG. 15 is diagram that shows the relationship and compatibility between the handheld electronic media ID scanner and various communication systems and devices. The media ID scanner can interact with wireless devices 558 such as PDA's, cellular phones, cellular modems etc. Similarly, the media ID scanner can interact with mobile computing users 564. The media ID scanner can interact with distributed networks 566 and wireless communications infrastructure 568.

An important component of the present invention is the data structure of the media ID for the printed and electronic media ID system. This media ID data structure has been intentionally designed to be modular and consists of media ID field building blocks that can be added or subtracted as needed and arranged in countless ways. Table 8 displays an example list of the media ID field building blocks (or fields). This building block system imparts a flexibility and power to the media ID system and ensures that media IDs can be quickly adapted to any changes in the way printed or electronic media is handled. It is reasonable to assume that the future will bring change, and because of this the media ID data structure is designed to accommodate change. The media ID structure established in an embodiment of the present invention will work for matrix bar code symbology, composite bar code symbology, linear bar code symbology, magnetic ink character recognition, or any other method used to “print” or place the media ID on the printed media. The media ID data structure established in an embodiment of the present invention will also work with the electronic media IDs that are discussed later.

There can be numerous released media ID versions. This imparts a special significance for the MediaIDVersion media ID field and its location within the media ID data structure. The field MediaIDVersion contains information about what version of the media ID system is being used for a given media ID. In other words, MediaIDVersion alerts the decoding hardware or software what data structure to expect.

In some applications of the present invention, the MediaIDVersion field will be the first field of any media ID. Placement of the MediaIDVersion in the media ID allows the media ID decoding hardware and software to instantly recognize the media ID version and ensure that it will be decoded correctly. This is an effective mechanism to support the flexibility of the media ID building blocks that can be arranged and re-arranged in many ways. The MediaIDVersion field consists of an alphanumeric value that will immediately indicate to any decoding software/hardware what field structure can be expected in the media ID code.

The MediaIDVersion field will sometimes be at the header of each media ID and, in one embodiment will follow the format “LAN#.#####”—where LAN equals an assigned alphanumeric abbreviation for the language of the media and #.##### is a numerical value representing the version. The following example would be a valid MediaIDVersion header field for an English language media ID in its 12^{th} minor revision state: ENG1.00012. Please note that the media ID version can be represented in other ways within the present invention.

This media ID field building block architecture provides a mechanism for the media ID system established herein to evolve as future demands are made. Additionally, each released media ID version will have an immediately recognizable field data structure that appropriate hardware and or software scanners will recognize and decode. The data structure of the released media ID versions will be managed by the media ID intermediary or other entity and will be made available to the various clients and users of the media ID system.

Several examples are listed below to explain how the data fields presented in Table 8 interact and combine to form media IDs. These examples can be considered to be released media ID versions. For any given data field, the field structure and length can vary from media ID data structure to media ID data structure. Also, the field can be populated with the actual alphanumeric text, thereby requiring little translation in the media ID software and/or hardware. Further, the field can be populated by a numeric value that requires translation by the media ID software or other hardware/software. For instance, in Table 5 the Publisher field is populated by DJCI. This will be translated to Dow Jones & Co. Inc. This is contrasted to Table 4, where the Publisher field is populated with Dow Jones & Co. Inc. Because the complete text is actually encoded in the Publisher field in Table 4 example 1, very little translation is required by the media ID software or other hardware/software.

A media ID from an article in a newspaper is presented in Table 4. The newspaper is published by Dow Jones & Co. Inc. and is called the Wall Street Journal. The article is titled “First Guilty Plea in Enron Case Expected Today” and was written by Jonathan Weil and Kathryn Kranhold. The media ID associated with the newspaper article consists of 17 data fields of varying length and type. A description of the field is provided as well as an example of how the field is populated for this released media ID version.

TABLE 4
Example Newspaper Article Media ID Structure

| Field | Description | Example |
|---|---|---|
| MediaIDVersion | Media ID Version | ENG1.12000 |
| MediaIDType | Media ID type | Standard |
| PublicationName | Title of publication | Wall Street Journal |
| Edition | Description of edition | Morning Edition |
| Publisher | Name of Publisher | Dow Jones & Co. Inc. |
| Title | Title of media article | First Guilty Plea in |
| | | Enron Case Expected |
| | | Today |
| ArticleNumber | Publishers article | 00004 |
| | number | |
| PrimaryAuthor | Primary author's name | Jonathan Weil |
| Co-Author | Co-author's name | Kathryn Kranhold |
| PageStart | A1 | A1 |
| TotalPages | Total number of pages | 65 |
| DatePublished | Date article of media | 08212002 |
| | published | |
| Theme | Theme of media | US Business News |
| | article | |
| MediaGenre | Genre of article of | Business |
| | media | |
| IconType | Icon type for media | 00012 |
| | article | |
| TotalArticles | Total number of | 155 |
| | articles in media | |
| TotalAdvertisements | Total number of | 65 |
| | advertisements in | |
| | media | |

The complete field structure for the media ID displayed in Table 4 is as follows:

MediaIDVersion/MediaIDType/PublicationName/Edition/Publisher/Title/ArticleNumber/Pri maryAuthor/CoAuthor/PageStart/TotalPages/DatePublished/Theme/MediaGenre/IconType/T otalArticles/TotalAdvertisements

The media ID software or other hardware/software will decode this media ID in a manner similar to this:

ENG1.12000/Standard/Wall Street Journal/Morning Edition/Dow Jones & Co. Inc./First Guilty Plea in Enron Case Expected Today/00004/Jonathan Weil/Kathryn Kranhold/A1/65/08212002/US Business News/Business/00012/00155/00065

The same article is presented in Table 5, but with a different media ID field structure. Again, the newspaper is published by Dow Jones & Co. Inc. and is called the Wall Street Journal. The article is titled “First Guilty Plea in Enron Case Expected Today” and was written by Jonathan Weil and Kathryn Kranhold. The media ID consists of 18 fields of varying length and type. A description of the field is provided as well as an example of how the field is populated for this released media ID version. In this example, the same article is being identified with a completely different media ID field structure or media ID version.

TABLE 5
Example Newspaper Article Media ID Structure

| Field | Description | Example |
|---|---|---|
| MediaIDVersion | Media ID Version | ENG1.15000 |
| MediaIDType | Media ID type | 00001 |
| PublicationName | Title of publication | WSJ |
| Edition | Description of edition | 00002 |
| Publisher | Name of Publisher | DWCI |
| Title | Title of media article | First Guilty Plea in |
| | | Enron Case Expected |
| | | Today |
| ArticleNumber | Publishers article | 00004 |
| | number | |
| PrimaryAuthor | Primary author's name | Jonathan Weil |
| Co-Author | Co-author's name | Kathryn Kranhold |
| PageStart | A1 | A1 |
| TotalPages | Total number of pages | 65 |
| DatePublished | Date article of media | 08212002 |
| | published | |
| Theme | Theme of media | 00251 |
| | article | |
| MediaGenre | Genre of article of | 00630 |
| | media | |
| IconType | Icon type for media | 00012 |
| | article | |
| TotalArticles | Total number of | 155 |
| | articles in media | |
| TotalAdvertisements | Total number of | 65 |
| | advertisements in | |
| | media | |
| BulletinAddress | Address of bulletin | www.wsj.com/bulletin/ |
| | where article can be | 082102/A1/4 |
| | discussed | |

The complete field structure for the media ID displayed in Table 5 is as follows:

MediaIDVersion/MediaIDType/PublicationName/Edition/Publisher/Title/ArticleNumber/Pri maryAuthor/CoAuthor/PageStart/TotalPages/DatePublished/Theme/MediaGenre/IconType/T otalArticles/TotalAdvertisements/BulletinAddres

The media ID software or other hardware/software will decode this media ID in a manner similar to this:

ENG1.12000/00001/WSJ/00002/DJCI/First Guilty Plea in Enron Case Expected Today/00004/ Jonathan Weil/Kathryn Kranhold/A1/00065/08212002/00251/00630//00012/00155/00065/www.wsj.com/bulletin/082102/A1/4

A media ID from a chapter in a book is presented in Table 6. The book is published by Touchstone and is called “Secrets of the Temple.” The chapter that the media ID has been applied to is titled “A Car With Two Drivers” and was written by William Greider. The media ID consists of 25 fields of varying length and type. A description of the field is provided as well as an example of how the field is populated for this released media ID version. In this example, the media ID can be applied to an individual chapter in the book as well as being applied to the entire book.

TABLE 6
Example Book Media ID Structure

| Field | Description | Example |
|---|---|---|
| MediaIDVersion | Media ID Version | ENG1.00012 |
| MediaIDType | Media ID type | Header |
| PublicationTitle | Publication title | Secrets of the Temple |
| Author | Author | William Greider |
| PublicationSubtitle | Publication subtitle | How the Federal |
| | | Reserve runs the |
| | | Country |
| PublicationType | Publication type | Book |
| PrintedMediaEdition | Printed media edition | 00001 |
| PartNumber | Part number | 00003 |
| PartTitle | Part title | The Liquidation |
| ChapterNumber | Chapter number | 00011 |
| ChapterTitle | Chapter title | A Car With Two |
| | | Drivers |
| PageNumber | Page number | Page 351 |
| Publisher | Publisher | Touchstone |
| PublisherAddress | Publisher address | 1230 Avenue of the |
| | | Americas |
| PublisherAddressCity | City publisher is | New York |
| | located in | |
| PublisherAddressCountry | Country publisher is | United States |
| | located in | |
| PublisherAddressState | State publisher is | New York |
| | located in | |
| DatePublished | Date published | Wednesday, Feb. 24, |
| | | 1988 |
| Theme | Theme | Investing |
| MediaGenre | Genre of media | Monetary Policy |
| MediaCopyright | Media Copyright | 1987 by William |
| | | Greider |
| MediaDesignedBy | Media designed by | Helen Granger |
| MediaCategory | Media category | Economics |
| TotalPages | Total number of pages | 00798 |
| Notes | Notes | Portions of this book |
| | | appeared originally in |
| | | the New Yorker |

The complete field structure for the media ID displayed in Table 6 is as follows:

MediaIDVersion/MediaIDType/PublicationTitle/Author/PublicationSubtitle/PublicationT ype/PrintedMediaEdition/PartNumber/PartTitle/ChapterNumber/ChapterTitle/PageNumber/P ublisher/PublisherAddress/PublisherAddressCity/PublisherAddressCountry/PublisherAddress State/DatePublished/Theme/MediaGenre/MediaCopyright/MediaDesignedBy/MediaCategory/TotalPages/Notes

The media ID software or other hardware/software will decode this media ID in a manner similar to this:

ENG1.00012/Header/Secrets of the Temple/William Greider/How the Federal Reserve Runs the Country/Book/00001/00003/The Liquidation/00011/A Car With Two Drivers/Page 351/Touchstone/1230 Avenue of the Americas/New York/United States/New York/Wednesday, Feb. 24, 1988/Investing/Monetary Policy/1987 by William Greider/Helen Granger/Economics/00798/Portions of this book appeared originally in the New Yorker

A media ID from a MP3 format song is presented in Table 7. In this example, a song was published by MCA Records and is called “I Miss You”. The artist is Incubus. The media ID consists of 25 fields of varying length and type. A description of the fields is provided as well as an example of how the field is populated for this released media ID version. In this example, note that the media ID can be applied to a song on the album as well as being applied to the entire album.

TABLE 7
Example MP3 Song Media ID Structure

| Field | Description | Example |
|---|---|---|
| MediaIDVersion | Media ID version | ENG1.00012 |
| MediaIDType | Media ID type | Song |
| PublicationType | Publication type | Compact Disc |
| SongTitle | Song title | I Miss You |
| SongTrackNumber | SongTrack | 00005 |
| | number | |
| SongTrackLength | Song track length | 2:58 |
| SongLyrics | Song lyrics or | www.lyrics.com |
| | Link to song lyrics | |
| SongMood | Song mood | Mellow |
| SongNotes | Song notes | N/A |
| SongTempo | Song tempo | Slow |
| Artist | Artist | Incubus |
| ArtistWebpage | Artist Web page | www.enjoyincubus.com |
| AlbumTitle | Album title | Make Yourself |
| TotalTracks | Total tracks | 00012 |
| MediaType | Media type | MP3 |
| MediaQuality | Media quality | 128 Kb/s |
| MediaGenre | Media genre | Alternative |
| Publisher | Publisher | MCA Records |
| PublisherAddress | Publisher address | 70 Universal City Plaza |
| PublisherAddressCity | City publisher is | Universal City |
| | located in | |
| PublisherAddressCountry | Country publisher | United States |
| | is located in | |
| PublisherAddressState | State publisher is | California |
| | located in | |
| PublishedMediaEdition | Type of media | 00001 |
| MediaCopyright | Media copyright | 1999 By MCA Records |
| IconType | Type of icon | 01452 |

The complete field structure for the media ID displayed in Table 7 is as follows:

MediaIDVersion/MediaIDType/PublicationType/SongTitle/SongTrackNumber/SongTrackLe ngth/SongLyrics/SongMood/SongNotes/SongTempo/Artist/ArtistWebpage/AlbumTitle/Total Tracks/MediaType/MediaQuality/MediaGenre/Publisher/PublisherAddress City/PublisherAdressCountry/PublisherAddressState/PublishedMediaEdition/MediaCopyrigh t/IconType

The media ID software or other hardware/software will decode this media ID in a manner similar to this:

ENG1.00012/Song/Compact Disc/I Miss You/00005/2:58/www.lyrics.com/Mellow//Slow/Incubus/www.enjoyincubus.com/MakeYorself/00012/MP3/ 128Kbs/Alternative/MCA Records/70 Universal City Plaza/United States/California/00001/1999 By MCA Records/01452

Table 8 lists example field building blocks for the universal identification system for printed and electronic media as put forth in an embodiment of the present invention.

TABLE 8
Example Field “Building Blocks” for Media ID Tags

| Field Name | Description |
|---|---|
| Abstract | Abstract of media content |
| AlbumAssociateProducer | Album associate producer |
| AlbumComposer | Album Composer |
| AlbumCopyright | Album Copyright |
| AlbumProducer | Album Producer |
| AlbumReview | Album Review |
| AlbumTitle | Album Title |
| Accreditation | Accreditation of Media ID |
| Agreement | Indicates agreement media content |
| AgreementTitle | Title of agreement |
| Annotation | Annotation |
| Application | Embedded or referenced application |
| Archive | Archive associated with media |
| ArticleNumber | Article number |
| ArticleCategory | Article category |
| ArticleClass | Class of article |
| ArticleGenre | Genre of article |
| ArticleContent | Content of article |
| ArticleMedia | Article media type |
| ArticleFragmentNumber | Fragment number of article |
| ArticleTheme | Theme of article |
| ArticleTitle | Title of article |
| ArticleNotes | Notes associated with article |
| ArticleSeries | Article series |
| ArticleSeriesNumber | Article series number |
| ArticleVolume | Article volume |
| Artist | Artist |
| ArtistBio | Artist biography information |
| ArtistBirthday | Artist's birthday |
| ArtistComments | Artists comments |
| ArtistE-mail | Artist's e-mail |
| ArtistE-mail2 | Artist second e-mail |
| ArtistFaxNumber | Artist's fax number |
| ArtistFirstName | Artist's first name |
| ArtistFTPSite | Artist's FTP site |
| ArtistHomeAddress | Artist's home address |
| ArtistIMAddress | Artist's IM address |
| ArtistJobTitle | Artist's job title |
| ArtistLastName | Artist's last name |
| ArtistMiddleName | Artist's middle name |
| ArtistMobilePhone | Artist's mobile phone |
| ArtistNotes | Artist notes |
| ArtistPOBox | Artist post office box |
| ArtistPostalCode | Artist postal code |
| ArtistPrefix | Artist prefix |
| ArtistSuffix | Artist suffix |
| ArtistWebpageURL | Artist web page URL |
| ArtistWorkPhone | Artist work phone |
| AspectRatio | Video aspect ratio parameter |
| Attributes | Attributes of media |
| Audio | Indicates audio type |
| Author | Author |
| AuthorBio | Author's background information |
| AuthorBirthday | Author's birthday |
| AuthorComments | Author's comments |
| AuthorE-mail | Author's e-mail |
| AuthorE-mail2 | Author's second email |
| AuthorFaxNumber | Author's fax number |
| AuthorFirstName | Author's first name |
| AuthorFTPSite | Author's FTP site |
| AuthorIMAddress | Author's IM address |
| AuthorJobTitle | Author's job title |
| AuthorLastName | Author's last name |
| AuthorMiddleName | Author's middle name |
| AuthorNotes | Author's notes |
| AuthorPOBox | Author's PO box |
| AuthorPostalCode | Author's postal code |
| AuthorPrefix | Author's prefix |
| AuthorSuffix | Author's suffix |
| AuthorWebpageURL | Author web page URL |
| AuthorWorkPhone | Author work phone |
| Bibliography | Bibliographic references |
| BulletinAddress | Address of online bulletin |
| Catalog | Indicates catalog media content |
| CatalogTitle | Title of catalog |
| Category | Category |
| Chapters | Defines number of chapters in media |
| Citation | Indicates citation media content |
| CitationInfo | Information related to citation |
| Class | Class |
| Classified | Classified status |
| ClassificationLevel | Classification level |
| Closed | Signifies media closed to revision |
| CODEC | Defines compression/decompression parameters |
| Co-Author | Co-author |
| Co-Author2 | Co-author2 |
| Co-Author3 | Co-author3 |
| Co-Authors | Co-authors |
| Co-AuthorBio | Co-author biography |
| Co-AuthorBirthday | Co-author birthday |
| Co-AuthorComments | Co-author comments |
| Co-AuthorContributions | Co-author contributions |
| Co-AuthorE-mail | Co-author e-mail |
| Co-AuthorE-mail2 | Co-author email 2 |
| Co-AuthorFaxNumber | Co-author fax number |
| Co-AuthorFirstName | Co-author first name |
| Co-AuthorFTPSite | Co-author FTP site |
| Co-AuthorHomePhone | Co-author home phone |
| Co-AuthorIMAddress | Co-author IM address |
| Co-AuthorJobTitle | Co-author job title |
| Co-AuthorLastName | Co-author last name |
| Co-AuthorMiddleName | Co-author middle name |
| Co-AuthorMobilePhone | Co-author mobile phone |
| Co-AuthorNotes | Co-author notes |
| Co-AuthorPOBox | Co-author PO Box |
| Co-AuthorPostalCode | Co-author Postal Code |
| Co-AuthorPrefix | Co-author prefix |
| Co-AuthorSuffix | Co-author suffix |
| Co-AuthorWebpageURL | Co-author Web page URL |
| Co-AuthorWorkPhone | Co-author work phone |
| Comments | Comments field |
| CompactDisc | Indicates compact disc media source |
| CompactDiscInfo | Information related to published medium |
| Company | Company |
| CompiledBy | Defines who the media ID was compiled by |
| Compression | Defines media compression parameters |
| Confidential | Defines confidentiality settings |
| Content | Media content |
| Context | Context of media ID |
| ContractNumber | Contract number |
| ContractTitle | Contract title |
| ContractAuthor | Contract author |
| Contract | Indicates contract media content |
| ContractTitle | Title of contract |
| Country | Country |
| CreatedDate | Date of media ID creation |
| Culture | Culture with closest relation to media |
| DateCompleted | Date completed |
| DateExpiration | Date of expiration |
| DatePublished | Data published |
| DateRevision | Date of revision |
| Department | Department associated with source of Media ID |
| Description | Description information |
| Development | Signifies development stage of media |
| Diagram | Diagram information |
| Dissertation | Indicates dissertation media content |
| DissertationTitle | Title of dissertation |
| DocumentManager | Document manager |
| DownloadDate | Date of download |
| DownloadTime | Time of download |
| Draft | Draft indicator |
| Edition | Edition |
| Editor | Editor |
| EditorComments | Editor comments |
| EditorE-mail | Editor e-mail |
| EditorE-mail2 | Editor e-mail 2 |
| EditorFaxNumber | Editor fax number |
| EditorFirstName | Editor first name |
| EditorFTPSite | Editor FTP site |
| EditorIMAddress | Editor IM address |
| EditorJobTitle | Editor job title |
| EditorLastName | Editor last name |
| EditorMiddleName | Editor middle name |
| EditorMobilePhone | Editor mobile phone |
| EditorNotes | Editor notes |
| EditorPOBox | Editor PO Box |
| EditorPostalCode | Editor postal code |
| EditorPrefix | Editor prefix |
| EditorSuffix | Editor suffix |
| EditorWebpageURL | Editor Web page URL |
| EditorWorkPhone | Editor work phone |
| EducationalCode | Educational code |
| ElectronicMediaTheme | Electronic media theme |
| ElectronicSeriesNumber | Electronic series number |
| ElectronicSeries | Electronic series |
| ElectronicMediaEdition | Electronic media edition |
| ElectronicMediaSize | Electronic media size |
| ElectronicMediaVolume | Electronic media volume |
| ElectronicMediaNumber | Electronic media number |
| ElectronicMediaFragmentNumber | Electronic media fragment number |
| ElectronicMediaType | Electronic media type |
| ElectronicMediaContent | Electronic media content |
| ElectronicMediaFormat | Electronic media format |
| ElectronicMediaGenre | Electronic media genre |
| ElectronicMedia | Electronic media |
| Encoding | Defines media encoding parameters |
| Encryption | Encryption information |
| EncrptionType | Encryption type |
| Entity | Entity |
| Era | Era closely associated with media |
| Exhibit | Indicates exhibit media content |
| ExhibitTitle | Title of exhibit |
| Expired | Indicates expiration of media |
| Family | Family of information related to media |
| FieldReportName | Name of field report |
| FieldReportNumber | Field report number |
| FieldReportTopic | Field report topic |
| FieldReportTitle | Field report title |
| FieldReportSubject | Field report subject |
| FieldReportTheme | Field report theme |
| FieldReportKeyword1 | Field report keyword 1 |
| FieldReportKeyword2 | Field report keyword 2 |
| Form | Indicates media content form |
| Format | Formatting information |
| FPS | Defines frames per second in video media |
| Frames | Defines total frames in media content |
| FTP | FTP information |
| Gallery | Gallery associated with media |
| General | General information |
| Graph | Indicates graph media type |
| Graph Title | Title of graph |
| Group | Group of information related to media |
| IconSource | Icon source information |
| IconName | Icon name |
| Icon | Icon |
| IconType | Icon type |
| IconLink | Icon link information |
| Identifier | Unique media identifier |
| Illustration | Illustration field |
| Image | Image associated with published media |
| ImportDate | Date of import to reading software/hardware |
| ImportTime | Import time of reading software/hardware |
| ISBN | Record of corresponding ISBN |
| Itinerary | Indicates itinerary media content |
| ItineraryTitle | Title of itinerary |
| Journal | Indicates journal media content |
| JournalTitle | Title of journal |
| Kbps | Indicates kilobyte/sec data quality setting of |
| | media |
| Keyword | Keyword |
| Keyword2 | Keyword 2 |
| Keyword3 | Keyword 3 |
| Language | Language |
| LastAuthor | Last author |
| Layout | Media layout format |
| Lease | Indicates lease document content |
| LegalDocument | Legal document reference |
| Link | Contains information necessary to link media ID |
| | to other media |
| Location | Field location information |
| Manual | Indicates manual document content |
| ManualTitle | Title of manual |
| Magazine | Indicates magazine document content |
| MagazineTitle | Title of magazine |
| Mail | Attached mail |
| MediaTheme | Media theme |
| MediaSeries | Media series |
| MediaSeriesNumber | Media series number |
| MediaVolume | Media volume |
| MediaType | Media type |
| MediaFragmentNumber | Media fragment number |
| MediaContent | Media content |
| MediaEdition | Media edition |
| MediaFormat | Media format |
| MediaClass | Media class |
| MediaCategory | Media category |
| MediaNumber | Media number |
| Media | Media |
| MediaGenre | Media genre |
| MessageClass | Message class |
| MediaIDType | Media ID type |
| MediaIDVersion | Media ID version |
| Memorandum | Indicates memorandum media content |
| Message | Message |
| Model | Model field |
| MP3 | Indicates MP3 media format |
| MP3 Title | Title of MP3 |
| Modified | Modified status |
| ModifiedDate | Modified date |
| NestedMediaID | Nested Media ID |
| NestedMediaIDNumber | Nested Media ID number |
| Newsletter | Indicates newsletter media content |
| NewsletterTitle | Title of newsletter |
| News | Indicates news media content |
| NewsSeriesTitle | Title of unique news series |
| NewsSeriesNumber | Number of media within news series |
| NewsSeriesSubtitle | Subtitle of media within news series |
| NewsWireArticle | News wire article |
| Notes | Notes |
| OriginofArticle | Origin of article |
| PageStart | Start page |
| PageEnd | Page end |
| Pamphlet | Indicates pamphlet media content |
| PamphletTitle | Title of pamphlet |
| Password | Password protection field |
| Patent | Indicates patent media content |
| PatentNumber | Patent number |
| Poetry | Indicates poetry media content |
| PrimarySubjectClassification | Primary subject classification |
| PrimarySubjectClassificationUserAttached | Primary subject classification user attached icon |
| Icon | information |
| PrintedEdition | Printed edition |
| PrintedMedia | Printed media |
| PrintedMediaContent | Printed media content |
| PrintedMediaSeries | Printed media series |
| PrintedMediaSeriesNumber | Printed media series number |
| PrintedMediaGenre | Printed media genre |
| PrintedMediaFragmentNumber | Printed media fragment number |
| PrintedMediaVolume | Printed media volume |
| PrintedMediaTheme | Printed media theme |
| PrintedMediaType | Printed media type |
| Privacy | Privacy settings |
| Project | Project associated with media |
| ProjectTitle | Title of project |
| PublicationName | Publication name |
| PublicationType | Publication type |
| Publisher | Publisher |
| PublisherAddress | Publisher address |
| PublisherAddressCountry | Publisher address country |
| PublisherE-mail | Publisher e-mail |
| PublisherFaxNumber | Publisher fax number |
| PublisherNotes | Publisher notes |
| PublisherPOBox | Publisher PO box |
| PublisherPostalCode | Publisher postal code |
| PublisherWebpageURL | Publisher Web page URL |
| PublisherWorkPhone | Publisher work phone |
| PublisherFTPSite | Publisher FTP site |
| Quality | Value depicting quality of data |
| Read | Indicates that contents have been read |
| ReadDate | Read date |
| Reference | Reference |
| Reference2 | Reference 2 |
| Region | Region |
| Registered | Indicates registration of media |
| Report | Indicates report media content |
| ReportTitle | Title of report |
| Resolution | Resolution of media |
| Resume | Indicates resume media content |
| ResumeTitle | Title of resume |
| Retired | Indicates retired status of media content |
| ReviewDate | Review date |
| ReviewComments | Review comments |
| RevisedBy | Revised by |
| Revision | Media ID revision information |
| RevisionDate | Date of revision |
| RevisionNumber | Revision number |
| ScanTime | Scan time |
| ScanDate | Scan date |
| SecondarySubjectClassification | Secondary subject classification |
| SecondarySubjectClassification1 | Secondary subject classification 1 |
| SecondarySubjectClassification2 | Secondary subject classification 2 |
| SecondarySubjectClassification3 | Secondary subject classification 3 |
| SecondarySubjectClassification4 | Secondary subject classification 4 |
| SecondarySubjectClassification5 | Secondary subject classification 5 |
| SecondarySubjectClassification6 | Secondary subject classification 6 |
| SecondarySubjectClassification7 | Secondary subject classification 7 |
| SecondarySubjectClassification8 | Secondary subject classification 8 |
| SecondarySubjectClassification9 | Secondary subject classification 9 |
| SecondarySubjectClassificationUserAttached | Secondary subject classification user attached |
| Icon | icon information |
| Section | Section |
| Sensitivity | Sensitivity value |
| SeriesNumber | Series number |
| SeriesTitle | Series title |
| Signature | Digital signature |
| SignedBy | Signed by |
| Size | Size of media ID in bytes |
| Software | Software used to generate media |
| SoundQuality | Sound quality |
| Source | Source of media ID |
| Stream | Specifies location of streaming data source |
| SubClass | Sub class |
| Subject | Subject |
| Subject2 | Subject 2 |
| SubTitle | Sub title |
| SubTitle2 | Sub title 2 |
| Summary | Defines the media summarized in present media |
| Synopsis | Synopsis of media content |
| Text | Text associated with media |
| TextContent | Text content |
| Theme | Theme |
| Thesis | Indicates thesis media content |
| ThesisTitle | Title of thesis |
| TrackAssociateProducer | Track associate producer |
| TrackComposer | Track composer |
| TrackProducer | Track producer |
| TrackTitle | Track title |
| Title | Title |
| Topic | Topic of media |
| TotalAdvertisements | Total advertisements |
| TotalArticles | Total articles |
| TotalPages | Total pages |
| Trace | Information tracing media ID |
| Transcription | Indicates transcription media content |
| TranscriptionSource | Specifies source of transcription |
| Trust | Indicates trust media content |
| UPC | Record of corresponding UPC |
| URL | URL |
| UserDefined | User defined block |
| UserDefined2 | User defined block 2 |
| Video | Indicates video type |
| Volume | Volume |
| WebpageURL | Web page URL |
| Will | Indicates will document media content |
| Words | Number of words in media content |

The example fields presented in Table 8 are in no way meant to be restrictive, and are presented for illustrative purposes only.

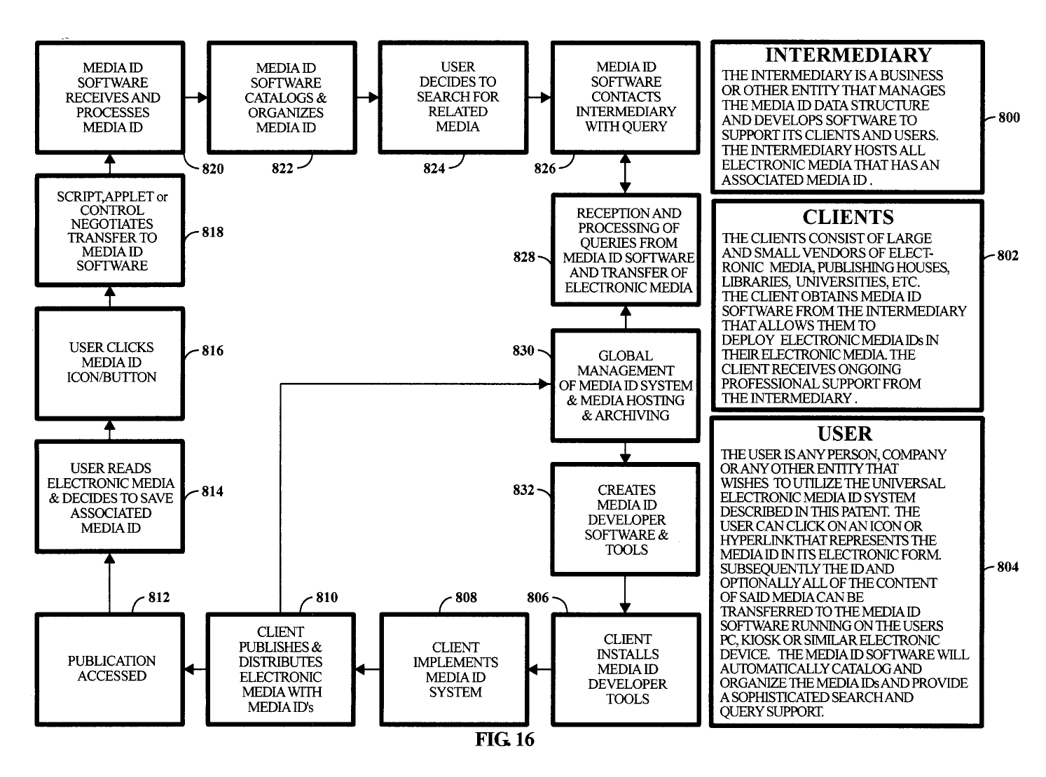

FIG. 16 shows the elements of an embodiment of the universal electronic media ID system. In FIG. 16, items 800 through 804 display the entities involved in the media ID system as described herein. Items 806 through 832 illustrate some of many ways that the media ID system can be implemented, maintained, and managed.

At 806 a media ID client obtains and installs media ID “developer tools” and at 808 the client implements a media ID system. Implementation of a media ID system can here be inferred to mean the establishment of a system for the client to generate and “affix” electronic media IDs for each article of electronic media that they create and/or distribute. At 810 the client publishes and distributes electronic media with associated electronic media IDs.

At 812 the client's electronic media with its associated unique electronic media ID is accessed by a user. For example, accessed here can mean using a web browser to access a remote web page server. At 814 a user reads the electronic media and can save the unique media ID associated with the article of electronic media. The user does this because he or she wants to save a record of the article of media. At 816 the user clicks on the media ID which is represented as a graphic, and/or character hyperlink, or by other methods. At 818 a script or control is activated by the user's action. This script or control negotiates the transfer of the electronic media ID to the user's local media ID software or other media ID software. The entire text and graphics of the original article of media can also be transferred to the media ID software along with the electronic media ID.

At 820, the media ID software receives and processes the media ID. This processing can involve parsing, decoding, and even repairing a damaged media ID. At 822 the media ID software catalogs and organizes the media IDs. The media ID software has a sophisticated database that allows the user to organize his or her media IDs. The media ID software has a graphical-user-interface that enables the user to quickly find media IDs located in the database.

At 824 the user can search for related media IDs and associated media. The user utilizes the media ID software as a vehicle to find related media IDs and associated media. The media ID software has a graphical-user-interface and software functionality that provides a mechanism for the user to develop a query, to develop filters, and to execute a search to find related media. Searches launched from the media ID software search the user's local media ID database as well as remote databases, such as the database located at the media ID intermediary.

At 826 the media ID software contacts a media ID intermediary or other entity with the search query that has been developed to locate related media through the conduit of the media ID system. In this example, the media ID intermediary or other entity will host electronic and other media that have associated media IDs, as well as hosting the media IDs themselves. At 828, the media ID intermediary or other entity receives the request from the user through the media ID software. The query or other request is processed and the media ID intermediary responds with the transfer of the requested media or media IDs. If an agreement is negotiated between the user at 826 and the media ID intermediary or other entity at 828, it is reasonable to presume that related electronic media will be transferred between 828 and 826.

At 830 the media ID intermediary or other entity provides global management of the media ID system. Additionally, at 830 the media ID intermediary or other entity provides sophisticated archiving and storage of articles of electronic media that have associated media IDs, and archiving and storage of the electronic media IDs. The media ID intermediary or other entity hosts these electronic media and media IDs and possesses state-of-the-art cataloging and retrieval tools.

At 832 the media ID intermediary or other entity creates and develops the media ID developer tools and associated software. These developer tools taken together provide the clients with the means to “publish” their electronic articles of media with electronic media IDs as described in the present art.

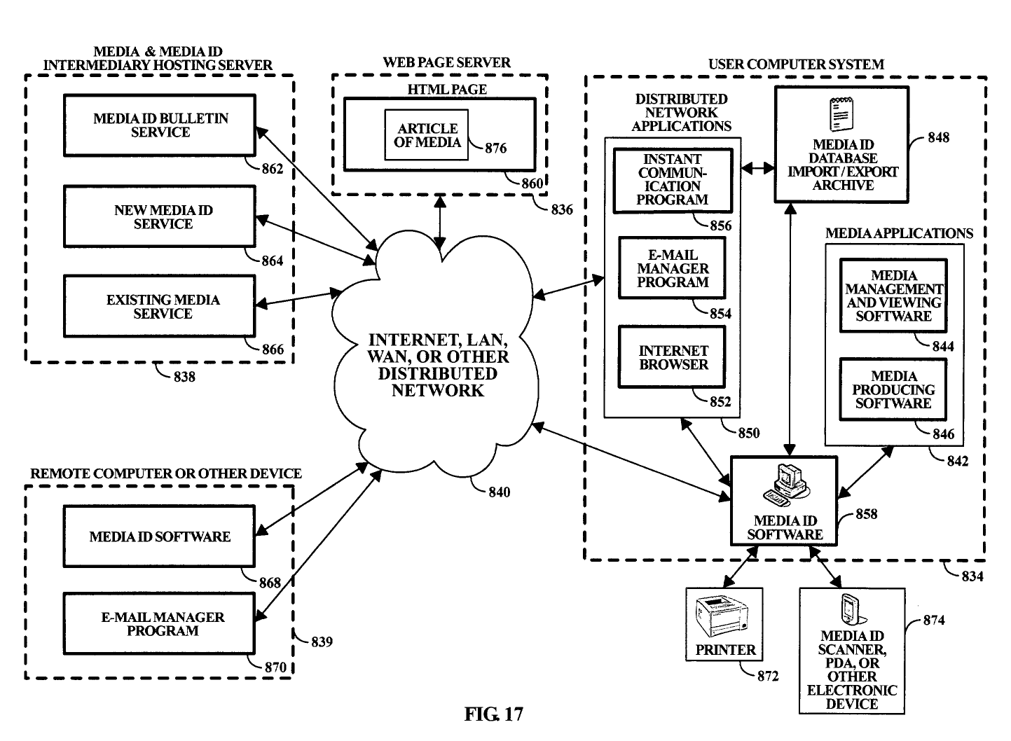

FIG. 17 shows the interaction of media IDs with a user computer 834, a distributed network 840, a media hosting server 838 and computers and other devices 839 that host or contain media IDs. The media ID software 858 is located on the user computer system 834 along with different media applications 842. Various distributed network applications 850, and a media ID database archive 848 are located on the user computer 834. A printer 872 is shown attached to the user computer system 834, and a media ID scanner or PDA 874 is also shown interfacing with the user computer system 834. A multitude of other device can also interface with the user computer system 834 and the media ID software 858.

The media ID software 858 is resident on a user's local computer system 834 and provides media ID cataloging and management services as well as other services. The media ID database archive file 848 is exported from the media ID software 858. It can consist of an export of all media IDs contained in the media ID software, or a subset of the media IDs contained in the media ID software located at 858.

The distributed network applications 850 provide conduits for the media ID software 858 to communicate with other media ID software packages, other computers and servers, and other electronic devices. The media applications at 842 consist of other applications that produce and/or view media. Periodically these applications need to publish an article of media with an associated media ID. Applications at 842 can also be used to view media.

A variety of distributed network types are located at 840. These networks provide a communication path from the media ID software 858 and other distributed network applications 850 on the user platform 834 to other computers and other electronic devices located at 836, 838, and 839. For example, a web page server 836 that is hosting a web page 860 can be accessed from the media ID software 858 via a distributed network 840. An article of electronic media with an associated media ID is also located at 876. A remote computer or other device is located at 839. The remote computer 839 is also a platform for the media ID software, which is located at 868. An e-mail manager program is shown located at 870.

A media hosting and management server is located at 838. In one embodiment of the present invention, this server 838 would be located at a media ID intermediary or other entity that maintains the standards for media IDs and also hosts electronic and printed media for users to download or otherwise acquire. A media ID bulletin message service is located at 862. A new media ID processing service is located at 864, and an existing media archive service is located at 866. The media ID bulletin service 862, the new media ID service 864, and the existing media service 866 can be maintained by a media ID intermediary or other entity and provides many services and resources to users of the media ID method, system, and software, as described herein.

FIG. 17 illustrates several aspects of an embodiment of the present invention. For example, a user can access the Internet through his computer 834 and view news information on a web page server 836. A web page server 836 hosts a web page 860 that contains electronic news media 876 with associated media IDs. The user accesses the electronic news media 876 via a connection between the media ID software 858 and a distributed network connection (e.g. Internet) 840, and then through an Internet connection between 840 and 836.

After reviewing the media content located at 860 through a web browser on his local computer 834, the user can save a record of the electronic news media 876 he has just viewed. This is accomplished by clicking on the electronic media ID icon associated with the electronic media 876 that is being hosted by the web server 836. This initiates a transfer of the media ID from the web page 860 through the Internet network connection 840 and ultimately to the media ID software 858. The media ID software 858 will decode the media ID, catalog and organize it, and thereafter provide the user access to the media ID, provide related media management tools associated with the media ID, and provides the user with a mechanism to download the original article of media 876 (if it was not downloaded with the media ID).

In another example, a user can forward to a colleague a media ID associated with an article of media that he produced using a media producing software 846 on his local user computer system. Using the media ID software 858 on his user computer system 834, the user checks to see if his colleagues computer system 839 is logged onto the Internet 840 and his media ID software 868 is actively accepting connections. After determining that his colleague's media ID software 868 is not actively connected to the Internet 840 and consequently is not available for direct transfer of the media ID from the media ID software 858 on his local user computer system 834, the user instructs his media ID software to export the media ID of interest to a media ID database import/export transport file 848. The user then launches an e-mail manager program 854 and composes an e-mail addressed to his colleague. Upon completing the e-mail, the user attaches the media ID database transport file 848 and sends the e-mail.

At a later time the colleague, using the e-mail manager program 870 on his computer system 839, reads the e-mail and can save the media ID database transport file to his computer system 839. The colleague instructs the software 868 to import the media ID database transport file, now resident on his system 839. The media ID software 868 decodes the media ID transport file, catalogs and organizes it, and thereafter provides access to it and related media ID management tools. Finding the media ID and associated media of great interest, the colleague at computer 839 can conduct a search for related media. Utilizing the search functionality in his media ID software 868, the colleague conducts a detailed search of existing media 866 located at the media hosting and management center 838.

In another embodiment, a user of the local computer 834 can transfer a media ID that he has already collected and is stored on his media ID software 858 to a remote user who is in possession of the media ID software. At 834 the local media ID software user identifies a media ID in his local media ID software 858 (through the media ID GUI) that he wants to transfer to a remote user and user computer located at 839. The user instructs the media ID software at 858 to utilize a distributed network 840 to transfer the media ID to the remote computer 839 and then to the remote user's media ID software at 868.

The media ID software located at 858 processes the user request and opens an Internet connection at 840 to access the user's remote computer 839. It is assumed that the remote computer 839 is already connected to the Internet at 840. Once the Internet connection at 840 is established, the media ID software 858 sends the media ID over the Internet at 840 to the user's remote computer 839. The remote computer 839 receives the media ID and hands it to the media ID software at 868. The media ID software 868 decodes the media ID, catalogs and organizes it, and thereafter provides the remote user access to it and related media ID management tools. The local media ID user at 834 can transfer media IDs directly to remote computers like the one at 839, and vice versa.

In another embodiment, a user with a local computer 834 can download the original article of media associated with a media ID. In FIG. 17, the original article of media is located at the media hosting and management center 838. In some cases media ID users will collect only the media ID, and in other cases users will download both the media ID and the full text, graphics, sound, video, etc. of the original article of media. In this example, it is assumed that the user has only downloaded the electronic media ID and now wishes to obtain the original printed or electronic article of media. Because the media ID is a unique representation of each article of media, it can be used at any point in the future to retrieve the original media.

For example, the user instructs the media ID software 858 to retrieve the original article of media for a particular media ID resident in the media ID software. The media ID software 858 processes the request from the user and opens a connection to the Internet 840. The media hosting and management center 838 already has a connection to the Internet 840. The media ID software at 858 contacts the existing media archive 866 on the hosting and management server 838 and requests the original article of media for the media ID in question. In this example, it is assumed that the local user computer 834 already has an account with the media ID intermediary or other entity that manages the media hosting and management server at 838. The media hosting and management server 838 receives the request from the user media ID software 858, processes it, and sends the original article of media via the distributed network 840 to the media ID software at 858. The media ID software 858 receives the original article of media, processes it, and catalogs and stores it. The user of the computer 834 now has the original article of media and its associated media ID.

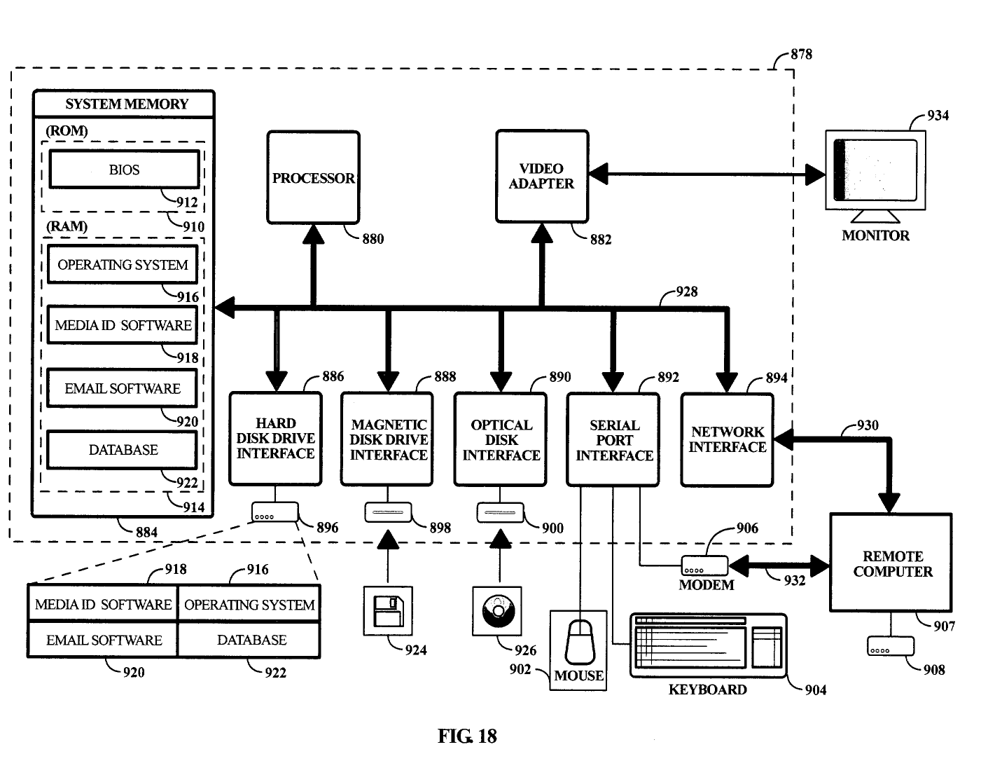

FIG. 18 shows an example computer platform for the media ID software. The media ID software is located at 918 and is stored on the computer hard drive 896. When the media ID software 918 is started, it is loaded into system memory 884. Once started, the media ID software 918 is resident in system memory 884.

A media ID software user can send commands and instructions to the media ID software 918 through the keyboard 904 and through the mouse 902. Media IDs can be received from remote computers such as the one located at 907. A distributed network or other remote connections is represented at 930. A modem connection is represented at 932. Media IDs can also originate or be transferred from removable media sources such as the optical disk 926, and the removable magnetic disk located at 924. In an additional embodiment, media IDs can be preloaded on hard drives at the factory.

The computer system 878 includes a processing unit 880, a system memory 884, and a system bus 928 that couples the system memory 884 to the processing unit 880. The system memory 884 includes read only memory (ROM) 910 and random access memory (RAM) 914. A basic input/output system 912 (BIOS) is stored in ROM 910. The computer system 878 also includes a hard disk drive 896, a magnetic disk drive 898, a removable disk 924, and an optical disk drive 900 for reading a CD-ROM disk 926 or to read from or write to other optical media. The hard disk drive 896, magnetic disk drive 898, and optical disk drive 900 are connected to the system bus 928 by a hard disk drive interface 886, a magnetic disk drive interface 888, and an optical drive interface 890, respectively.

The drives and their associated computer-readable media provide nonvolatile storage for the client on the computer system 878. Although the description of computer-readable media above refers to a hard disk, a removable magnetic disk and a CD-ROM disk, and other types of media which are readable by a computer, such as magnetic cassettes, flash memory cards, digital video disks, and the like, may also be used in the computer operating environment. A number of program modules may be stored in the drives and RAM 914, including an operating system 916, one or more application programs, such as media ID software 918, email management software 920, and a database 922.

A user may enter commands and information into the computer system 878 through a keyboard 904 and pointing device, such as a mouse 902. Other input devices (not shown) may include a pen, touch-operated device, microphone, joystick, game pad, satellite dish, image scanner, fax machine, cellular phone, PDA, or the like.

Additional devices that may interact with the serial interface 892 are printed media ID scanners, PDAs with associated media ID capability in the form of software or hardware as well as other media ID hardware devices that contain media IDs. Such devices can transfer media IDs to the media software on the user system by means of the serial port interface 892 in the form of infrared, Bluetooth, or other wireless data transfer or by means of a direct data transfer by cable. These and other input devices are often connected to the processing unit 880 through a serial port interface 892 that is coupled to the system bus 928, but may be connected by other interfaces, such as a game port, a universal serial bus (USB), Firewire, or similar port.

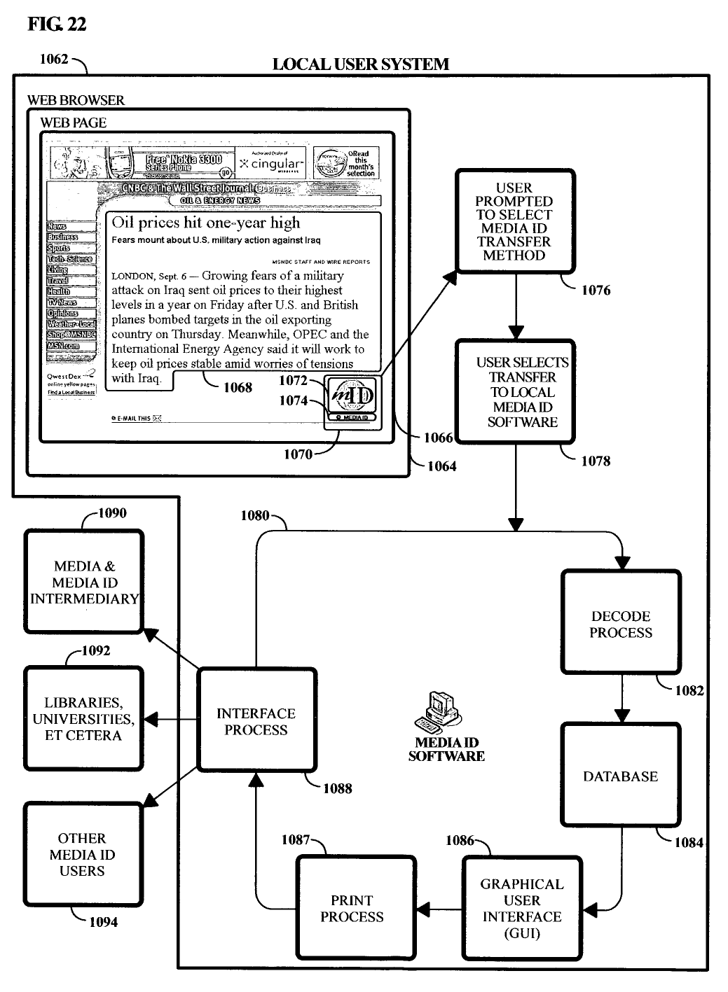

A database 922 in memory 914 includes the possible use of the database as part of the software 918 and/or separate software residing beside the media ID software in system memory 884. Additionally, the e-mail program module 920 provides a mechanism for creating, addressing, sending, receiving, and forwarding media IDs. The use of the database 922 is described in greater detail in connection with FIG. 22. A monitor 934 or other type of display device is also connected to the system bus 928 via an interface, such as a video adapter 882. In addition to the monitor, personal computers typically include other peripheral output devices such as speakers or printers, which are not displayed in this simple figure.

The computer system 878 operates in a distributed or networked environment using logical connections to one or more remote computers, such as a remote computer 907. The remote computer 907 may be a media ID hosting server, a peer user computer workstation, a router or other common network node. The remote computer 907 includes many or all of the elements described relative to the computer system 878, although only a memory storage device 908 has been illustrated in FIG. 18. The logical connections depicted in FIG. 18 include a distributed local area network connection 930 and a distributed wide area network or Internet connection 932. Such networking environments are commonplace in offices, enterprise-wide computer networks, intranets and the Internet, and serve as a medium by which media IDs can be downloaded, processed, acquired, forwarded, or otherwise transferred.

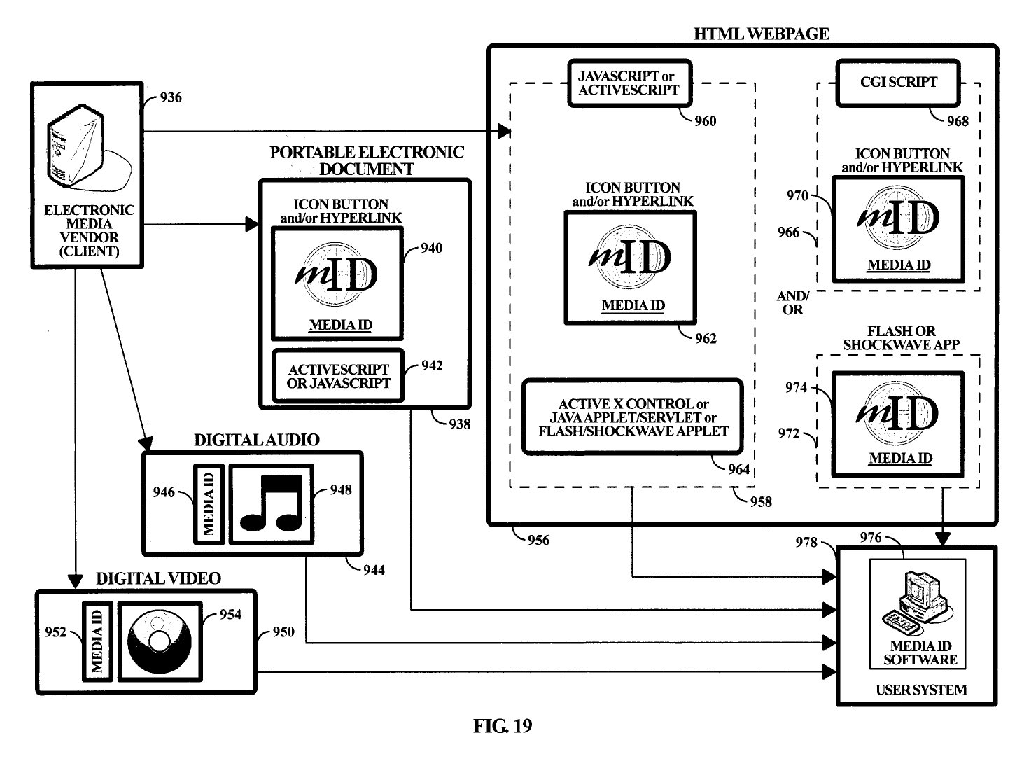

FIG. 19 is a diagram illustrating the basic concepts of an embodiment of the universal electronic media identification system (or media ID system). A vendor or distributor of electronic media is located at 936. For the purposes of this illustration it is assumed that the vendor or distributor of the electronic media has implemented a system to electronically affix or otherwise place an electronic media ID on articles of electronic media (such as electronic documents, web pages articles, etc.). Furthermore, it is understood that the media ID is from the present invention. A web page 956 provides a canvas to illustrate several methods of uniquely identifying electronic media with electronic media IDs. In this example, the electronic media can generally be considered to be electronic news articles published on a web page 956.

FIG. 19 is comprised of a visible media ID 962 in the form of an icon (animated or otherwise) and/or a hyperlink incorporated in a control or script. For example, a script 960 written in ECMAScript (formally referred to as JavaScript), interacts with the media ID icon and/or hyperlink 962. When a user clicks on or otherwise selects the media ID icon 962, the script 960 directs the execution of a client or server based control 964 or Java applet or servlet 964 in response to the users requested action.

This control, applet, or servlet 964 negotiates the transfer of the media ID data it references or contains to the media ID software 976 running on a local user platform 978. The media ID software 976 receives the electronic media ID 958 and decodes it. The media ID software 976 catalogs and organizes the input media IDs. The entire text, graphics, and sound of the electronic media can also be transferred to the media ID software 976 along with the electronic media ID 958. The media ID software 976 can receive and process the entire content of the electronic media ID 958 as well as its associated electronic article of media.

The identification of all articles of electronic media with an electronic media ID (as described herein) provides a powerful tool for users that allows them to easily catalog and store media identification information in a local (or remote) media ID software. As mentioned earlier, the overall productivity of society will increase as time that is currently spent searching for media is released for more productive enterprises as people organize articles of media of interest in the media ID software 976.

Another embodiment of the present invention is illustrated in FIG. 19. Item 966 is comprised of an electronic media ID 970 implemented through the use of a CGI script 968. When the user clicks on the electronic media ID icon and or hyperlink 970, a CGI script 968 is called to transfer all of the electronic media ID information 966 to the media ID software 976.

Yet another embodiment is shown at item 972. An electronic media ID 972 is shown encapsulated in a Flash or Shockwave application 974. Alternatively, an electronic media ID 972 is encapsulated as an ActiveX™ control. When the user clicks on or otherwise selects the electronic media ID icon 974, the associated Flash or Shockwave application or ActiveX™ control 972 executes and negotiates the transfer of the electronic media ID to the media ID software 976.

In another embodiment of the present invention, a vendor of electronic media 936 in FIG. 19 encodes a media ID 940 into a portable electronic document 938 or similar platform independent document. The media ID 940 is represented in the electronic document 938 as an icon, button, hyperlink, or other text or symbol. This electronic media ID 940 has an underlying script 942 in JavaScript or similar control script. When the user clicks on the media ID icon 940 located inside the portable document 938, the script 942 executes and negotiates the transfer of the electronic media ID information from the electronic document 938 to the media ID software 976. The media ID software 976 will automatically decode the electronic document media ID 940 and organize and catalog it in the database. In one embodiment, the media ID software will also add the entire contents of the electronic document 938 to the database along with the associated media ID 940.

In yet another embodiment of the present invention, a vendor of electronic media 936 encodes an electronic media ID 946 into a digital audio file 944. For illustrative purposes, this digital audio file 944 can be considered an MP3 file. Item 944 graphically shows the digital audio file/MP3 file with the attached electronic media ID 946. The electronic media ID 946 associated with the MP3 948 uniquely and definitively identifies the MP3 file and can be transferred to the media ID software 976 in a similar fashion as other electronic media IDs. In one embodiment of the present invention, when the user loads, copies, or downloads the MP3 digital audio file 944 onto the local platform 978, the Media ID software 976 running on the computer platform 978 will prompt the user as to whether the media ID 946 for the MP3 948 should be added to the media ID software 976. If the user can add the electronic media ID 946 that uniquely identifies the MP3 948 to the Media ID software database, the media ID software 976 will automatically decode it, organize it, and catalog it in the media ID software database. The user can also catalog and organize the entire MP3 file 948 in the media ID software 976 as well as its unique electronic media ID 946.

In yet another embodiment of the present invention, a vendor of electronic media 936 in FIG. 19 encodes a digital media ID 952 into a digital video file 950. For illustrative purposes this digital video file 950 is a DIVX file format; however, any other digital video format can also be used. Item 950 graphically shows the digital video file/DIVX file 954 with the attached media ID 952. When the user loads the DIVX file plus media ID 950 on to the local platform 978, the media ID software 976 will prompt the user as to whether the media ID 952 for the DIVX video 954 should be added to the media ID software 976. If the user can add the DIVX video 954 to the media ID software database, the media ID software 976 will automatically decode its media ID 952 and organize and catalog it in the database. In one embodiment, the media ID software 976 will also add the entire contents of the DIVX video 954 to the database along with the associated media ID 952.

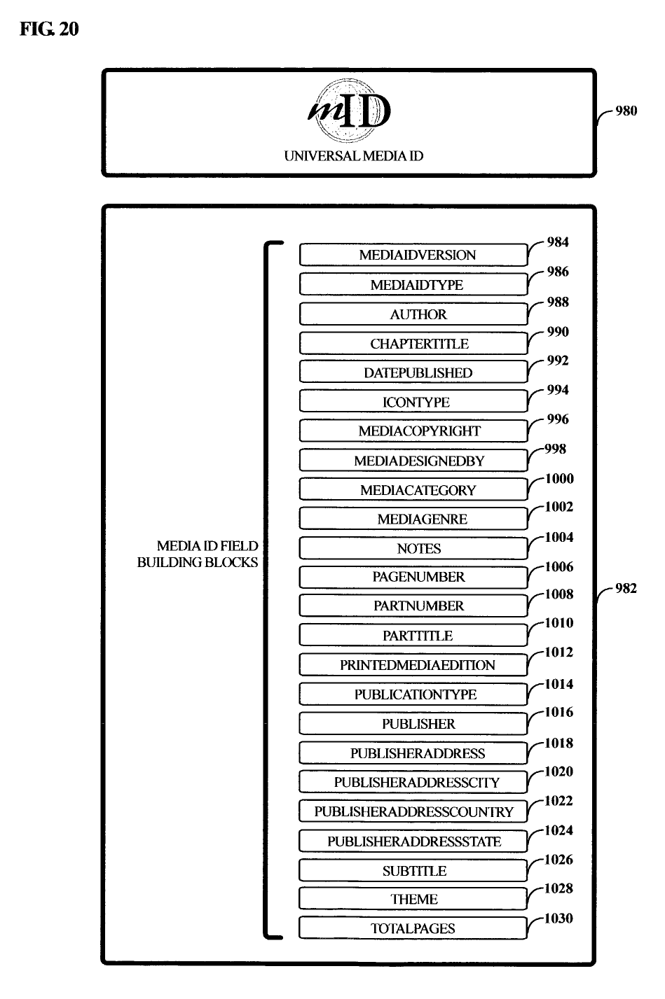

FIG. 20 shows the data field structure for one embodiment of a universal electronic media ID. A media ID as it might appear in association with an article of electronic media is located at 980. In this embodiment, the universal electronic media ID 980 is composed of media ID field building blocks.

Field building blocks 982 are presented for illustrative purposes. These building blocks are typical, interchangeable media ID building blocks, similar to those described in Table 8. The media ID structure is comprised of a system of building block fields. These building block fields can be arranged and rearranged to form different media IDs for different versions of the media ID system and for different articles of media. Different articles of media as described herein can be interpreted to mean online newspaper articles, online magazine articles, videos, music, etc.

For instance, the version of the electronic media ID at 984 alerts the media ID software as to what structure to expect when it processes or decodes the media ID. The field building block that contains information about the publisher of the article of media is located at 1016. When the media ID software decodes the media ID, the user will know who the publisher of the media is based upon how 1016 in FIG. 20 is populated.

The field building blocks provide a sophisticated way to create media IDs that uniquely identify articles of printed and electronic media. These media IDs populate the media ID software database with meaningful and comprehensive information about the origin, history, subject, and other significant information about the article of media, whether it is of the printed or electronic variety.

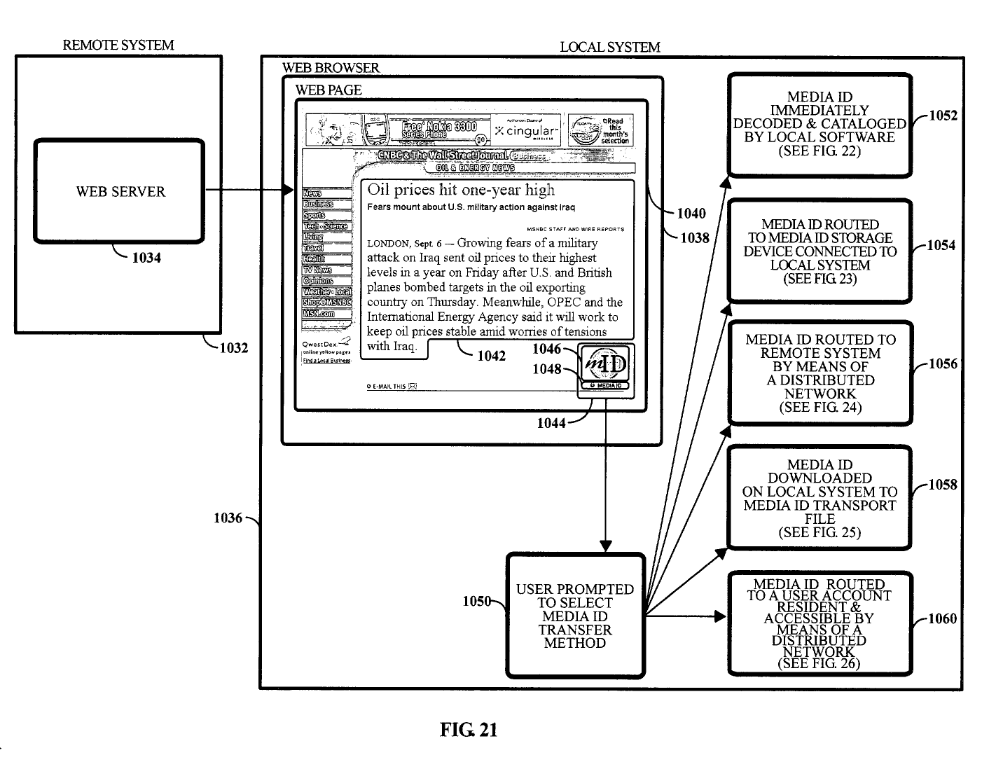

FIG. 21 shows an embodiment of the electronic media ID tag of the present invention in relation to a commercial web site. This web page is being hosted at a remote system 1032 on a web server 1034. The web page 1040 is being viewed with a web page browser 1038 on a media ID user's local system 1036.

An electronic media identification (or media ID) 1044 as described has been associated or placed with the article of media 1042 on the web page 1040 to illustrate how a single article of electronic media presented or published on an web page is uniquely identified. In this example, the media article 1042 is entitled “Oil Prices hit one-year high” and the media ID 1044 has been coupled with the article of electronic media 1042.

This electronic media ID 1044 in FIG. 21 is encoded with fields of data that together constitute a complete and unique identification tag for this electronic media article, and only this electronic media article. When the user clicks on the media ID 1044, comprehensive and unique identification information will be sent to the local media ID software 1052, or will be transferred or copied to a local device 1054, or will be transferred or copied to a computer or other remote system 1056, etc.

In one embodiment, a user can collect or save the media ID 1044 of FIG. 21 that uniquely defines the article of electronic media 1042 located on the web page 1040. The user clicks on the media ID icon 1046 or hyperlink 1048 to collect and store the media ID 1044. This user action activates a software prompt at 1050. This prompt 1050 can originate on the local machine or on a remote machine. The prompt serves to guide and instruct the user who wishes to save a record of, or otherwise collect the media ID 1044. The prompt presents several options that the user can choose in order to download or otherwise save the media ID 1044.

At 1052 the user can download the media ID 1044 to software on the local computer. For example, the user can download the media ID 1044 into the media ID software as described herein located at 1052. The media ID software at 1052 running on the user's system 1036 will decode, catalog, and organize the media ID automatically once the user has decided at 1050 to download it to local software 1052.

At 1054 the user can route, send, and store the media ID 1044 to a storage device attached or otherwise connected to the user's local system 1036. This storage device at 1054 can be removable storage media or non-removable storage media. For example, the user could save the media ID 1044 to a removable memory card, such as a PCMCIA card, or could save the media ID 1044 onto a hardrive. In both cases, the media ID 1044 is stored in such a way as to make it portable. For example, the media ID 1044 is stored on the PCMCIA card at 1054 in such a way that it can be transferred from the PCMCIA storage media to a copy of the media ID software located on a remote machine.

At 1056, the user can route or otherwise send the media ID 1044 to a remote system by means of a distributed network. In one embodiment, the remote system at 1056 would be hosting the media ID software as described herein. In some cases the remote system at 1056 might be the users own personal computer system. For example, a media ID user leaves his office and travels to London on business. The user borrows a computer in London that belongs to a business colleague. The user utilizes this computer for research and finds several articles of media that he wishes to save a record of. The local computer happens to have a copy of the media ID software loaded, but the user would prefer to save the media IDs associated with the articles of media on his own system back in the office. At 1056 a remote connection to his own computer and his own media ID software is established and the media ID 1044 is saved to his own system as opposed to the local system in London.

In another embodiment, the remote computer at 1056 provides a temporary storage place for the media ID 1044. The user would then log onto this remote computer at a later time in order to retrieve his media ID 1044.

At 1058, a user can download the media ID 1044 onto the local system in a media ID transport file. The media ID transport file at 1058 is a portable file format that stores one or more media IDs and can be transported from computer to computer regardless of platform type. A media ID transport file is designed so that the user is able to work on any computer, anywhere, and save media IDs to be transported back to his own computer. The media ID transport file at 1058 can be moved from computer to computer and saves media IDs in a compressed, compact format, or in an uncompressed format, in binary or ASCII. When the user returns to his own computer, he simply imports the transport file(s) to his media ID software. This loads all media IDs that he collected as transport files while on travel into his local media ID software. This embodiment provides another mechanism for the user to use computers other than his own to collect media IDs and then to transport them back to his own computer and to his own copy of the media ID software.

At 1060 a user can send, route, or otherwise transfer the media ID 1044 to a user account via a distributed network. A user can setup a media ID account at a media ID intermediary or other host to deposit and later collect media IDs. For example, a user sets up an account at a media ID intermediary that hosts media and media IDs. This account establishes a mechanism for the user to download original articles of media from the media ID intermediary or other entity, but also creates a user account where the user can deposit media IDs while on travel or otherwise away from his local system.

For example, a user is on business travel to Ankara and in the process of using a colleague's computer for research finds several media IDs that he would like to save. At 1050, the user is prompted to choose a media ID transfer method. The user can transfer the media ID 1044 to a user account located at 1060. Once the media ID 1044 is located at the user account 1060, the user can retrieve it at any time and transfer it to his local media ID system.

FIG. 22 shows an embodiment of the electronic media ID tag of the present invention in relation to a commercial web site. In this example, a web page is hosted by a web server, and is being viewed through a standard web browser at 1064 on a local user computer 1062. An electronic media identification (or media ID) as described has been placed at 1070 to illustrate how a single article of electronic media 1068 presented or published on an web page 1066 is uniquely identified. In this example, the media article 1068 is entitled “Oil Prices hit one-year high” and the media ID tag 1070 has been placed at the lower right of the web page 1066 in conjunction with the article of electronic media 1068.

This electronic media ID 1070 in FIG. 22 is encoded with fields of data that together constitute a complete and unique media identification for this electronic media article 1068, and only this electronic media article 1068. In this example, when the user clicks on the media ID 1070, comprehensive and unique identification information will be sent to the media ID software 1080.

In this embodiment, the media ID software 1080 is running on the same platform as the local web browser 1064. A user can save a record of the article of media 1068 by collecting its media ID 1070 by clicking on the media ID icon 1072. At 1076 the user is prompted to select a media ID transfer process. At 1078 the user transfers the media ID 1070 to the media ID software 1080 running on his local computer 1062. The media ID 1070 is transferred from the web page 1066 to the media ID software 1080.

At 1082 the article media ID 1070 is received from the web server (e.g. from the remote web server) or from the web browser on local system and is decoded. During the decoding process located at 1082, some translation and decompression can occur. Repair of damaged media IDs can also occur at 1082 in FIG. 22.

Once decoded at 1082, the media ID software 1080 will store the media ID 1070 in an integrated and sophisticated database 1084. This database 1084 will catalog and organize the media IDs that the user collects from electronic and printed media (such as the media ID 1070 from the electronic article in this example). In yet another embodiment of the present invention, the user can click on the “MEDIA ID” hyperlink located below the icon at 1074 to transfer the unique electronic media ID 1070 to the media ID software 1080.

The media ID software has a sophisticated graphical-user-interface (or GUI) 1086 that allows the user to navigate through the locally stored media IDs, initiate complicated search queries for local and remote media and media IDs, and retrieve articles of media and media IDs. This graphical-user-interface 1086 provides functionality for the user to accept the default media ID organization structure or to configure a custom media ID organization structure. The graphical-user-interface 1086 represents the media IDs graphically and/or with text. Each media ID has complete information about the media article such as publisher, date published, number of pages, media type, author, title, icon type, etc. In many cases the electronic media ID and the original media are stored together (the entire text, graphics, sound, video, etc) in the media ID software. In other embodiments, the media ID and the media ID software contain the necessary information required to transfer the entire text and graphics of the original article of media between the web server and the media ID software 1080. In one embodiment of the present invention, when the user clicks on a media ID such as the one located at 1070 in FIG. 22, the entire text and graphics of the media article 1068 will be transferred along with the media ID 1070 to the media ID software 1080.

A print process at 1087 allows the user of the media ID software 1080 to “publish” or print the media or media ID to different formats. The print process located at 1082 also allows the user to send the electronic media or the media ID to a plotter or to a printer or to software to create portable electronic documents.

An interface process located at 1088 of FIG. 22 interacts with software, hardware, and other entities located outside of the media ID software 1080. For example, a user can download a media ID 1070 from a source such as a web site and at a later time obtain the full text and graphics of the original electronic media 1068 from a media ID intermediary 1090, the original publisher, or some other entity. In an embodiment, this is accomplished through the process at 1088 interfacing with a media-hosting center located at 1090. In this example, the media-hosting center 1090 contains a repository of printed and electronic media articles with unique media IDs that have been downloaded or otherwise obtained from numerous vendors of printed and electronic media.

The media ID software can access these media and can request a printed or electronic copy of the original media or media ID. In one embodiment of the present invention, the media ID software user would establish an account with the entity that hosts the original articles of media. In another embodiment of the present invention, a user account would not be necessary.

The media ID software interface process 1088 can utilize a distributed network to establish a connection to the media hosting center or other entity located at 1090 and request the original media article 1068 and or media ID 1070 or some combination thereof. This transaction can occur with or without the user having an account established, and can occur with or without the transfer of money. The media ID software 1080, therefore, has several functions as illustrated above. One function is to organize and catalog media IDs, and another is to search for and retrieve new media IDs or supplemental media information at the user's request. This supplemental media information can be retrieved from an intermediary or other entity such as the one located at 1090. In an embodiment, the retrieval function accomplished between the interface process 1088 and the media and media ID hosting center 1090 will be unnecessary. This is because in the original download or acquisition of the media ID 1070, the complete text, graphics, and sound of its associated article of media 1068 will accompany it.

In yet another embodiment of the present invention, the interface process 1088 interacts with libraries, universities, and other institutions at 1092 that contain printed and electronic media with associated unique media IDs. The media ID software 1080 can send and retrieve media information between the interface process at 1088 and the libraries, universities etc. located at 1092. The media ID software 1080 can perform complicated searches between the interface process at 1088 and the libraries, universities etc. at 1092 based upon user input into the media ID software at 1086.

For example, a user clicks on the media ID 1070 in FIG. 22 and transfers it to the media ID software 1080. This media ID 1070 is decoded at 1082 and stored, cataloged, and organized at 1084. At 1086, the user scans through the organized media IDs using a graphical-user-interface 1086 and decides that he wants more information about the article 1068 entitled “Oil Prices hit one-year high”. The user can use the graphical-user-interface 1086 to construct and perform a search on media related to the “Oil Prices hit one-year high” electronic article 1068. This search query starts at the media ID software on the local computer platform 1080 and is then sent to the interface process at 1088 and then is sent to the media and media ID intermediary or other entity 1090, to the libraries, universities, etc. 1092, and to the other media ID users 1094, or any combination thereof. For example, in response to the search query, the media and media ID hosting center 1090 replies with 27 articles of electronic and printed media related to the “Oil Prices hit one-year high” article 1068. The user of the media ID software 1080 can then decide if he wishes to download any of these related articles of media.

In yet another embodiment of the present invention as illustrated by FIG. 22, users of the media ID software 1080 can interface and interact with other users of the media ID software located at 1094. Media ID software users can swap media IDs and associated graphics, text, video, sound, etc. between the local media ID software user 1080 and the other media ID users 1094.

For example, a user logs on a web site and can download the unique electronic media ID 1070 that is associated with the article entitled “Oil Prices hit one-year high” 1068. The user talks with a colleague later in the day that expresses interest in the article about oil prices 1068. At 1086 and then at block 1088, the user whom originally downloaded the media ID 1070 sends it to his colleague who is located at 1094. The user at 1094 receives the media ID 1070 through his local media ID software running on his own local personal computer. This example illustrates how media IDs can be transferred from one user to another through the vehicle of the media ID software and the associated media ID language as presented herein.

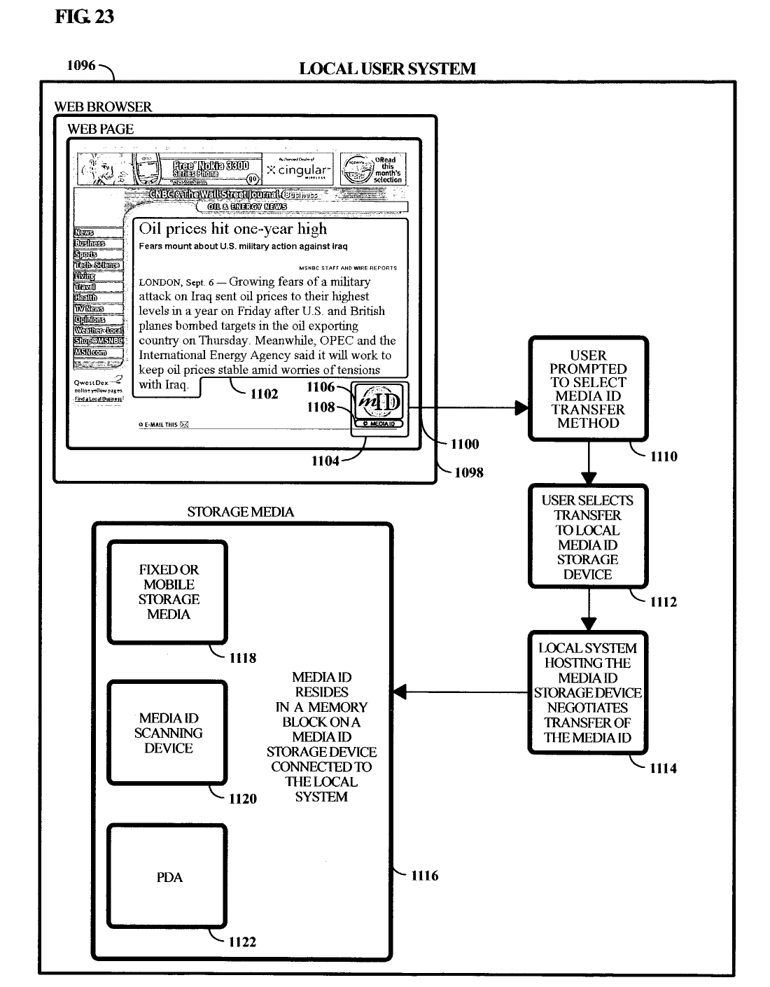

FIG. 23 shows a media ID transfer process from a web page 1100 to a storage device located or connected to a local computer system according to an embodiment of the invention. The web page 1100 is being viewed by a local user with a standard web browser 1098. A media ID 1104 uniquely identifies the article of media 1102 that is presented in the web page 1100. A user can save a record of the article of media 1102 by collecting its media ID 1104. The user does this by clicking on the media ID icon at 1106. At 1110 a user is prompted to select a media ID transfer process. At 1112 the user decides to transfer the media ID 1104 to a local media ID storage device. At 1114, the local system 1096 where the storage device is located or accessed negotiates the transfer of the media ID 1104 from the web page 1100 to the selected local storage device. The media ID resides in a memory block at 1116 on the local storage device or media.

The local storage device can be a fixed or removable storage media 1118 such as a hard drive or a PCMCIA card. The local storage device could also be a handheld electronic media ID scanner 1120 that is connected to the local user system 1096. The local storage device could also be a personal data assistant or PDA 1122 that is connected to the local user system 1096. The media ID 1104 can be saved on the local storage media in compressed or uncompressed format and in a binary or ASCII format.

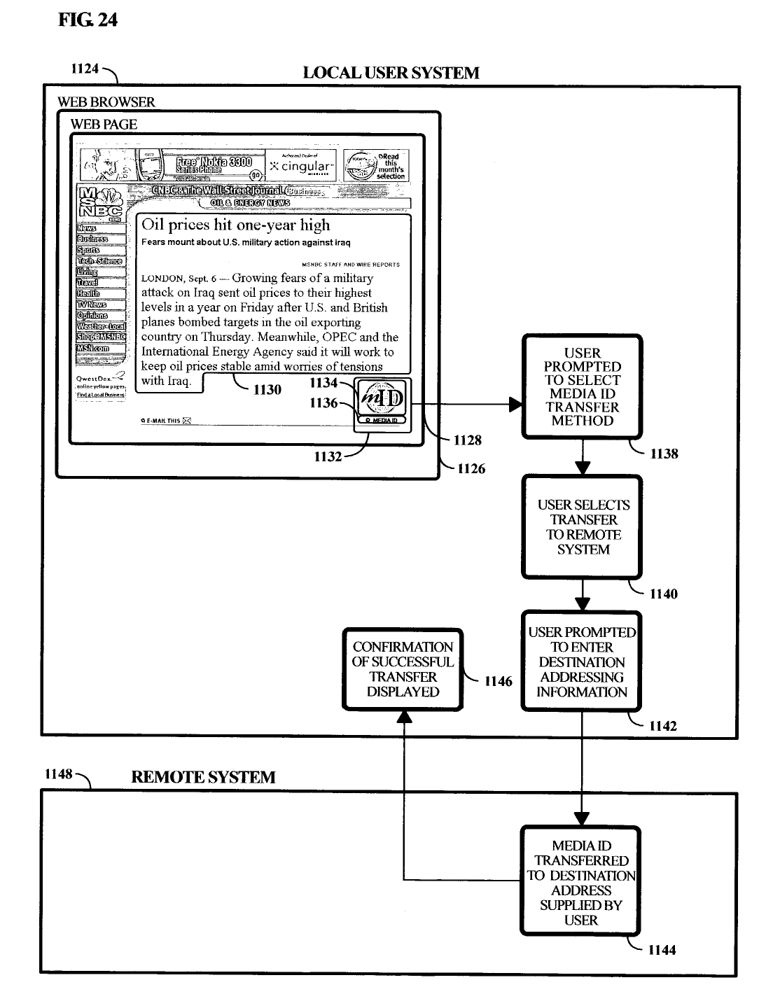

FIG. 24 shows a media ID transfer process from a web page to a remote system or remote hardware. A web page 1128 is being hosted on a web browser 1126. The user has the web browser 1126 loaded on a local user system 1124. The media ID 1132 that uniquely identifies the article of media 1130 is shown associated with it on the web page 1128.

A user can save a record of the article of media by collecting its media ID 1132. This is accomplished by clicking on the media ID hyperlink at 1136. At 1138 the user is prompted to select a media ID transfer process. At 1140 the user can transfer the media ID 1132 to a remote system 1148. At 1142 the user is prompted to enter information on what remote system to store the media ID 1132 on, and is prompted to provide information about the location and access protocols associated with the remote system 1148. At 1144 the media ID 1132 is transferred from the web page 1128 to the remote computer 1148 that was specified by the user. At 1146, a confirmation is sent that the media ID 1132 was successfully received by the remote system 1148.

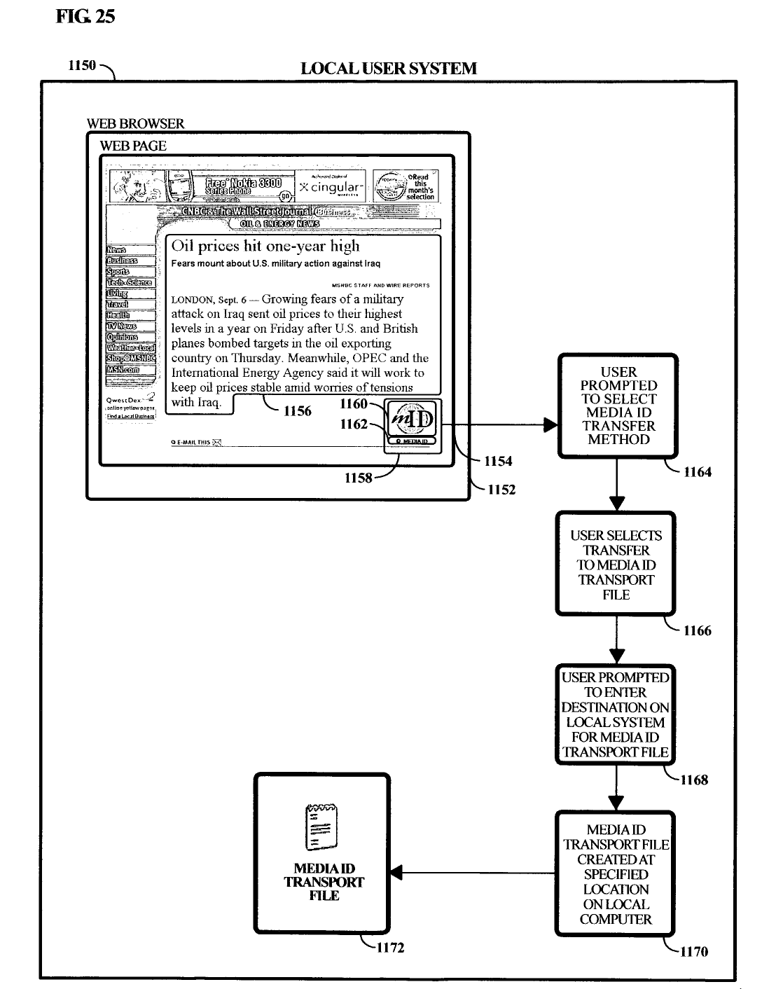

FIG. 25 shows a media ID transfer process from a web page to a media ID transport file. A web page 1154 is being viewed with a web browser 1152. The user has the web browser 1152 loaded on a local user system 1150. The media ID 1158 that uniquely identifies the article of media 1156 is presented in the web page 1154.

A user can save a record of the article of media 1156 by collecting its media ID 1158. This is done by clicking on the media ID icon at 1160. At 1164 the user is prompted to select a media ID transfer process. At 1166 the user decides to transfer and store the media ID 1158 to a media ID transport file 1172. At 1168 the user is prompted to enter information as to where to store the media ID transport file 1172 on the local system 1150, or on a remote system. At 1170 the media ID 1158 is converted to a media ID transport file 1172 and stored on the local system 1150 or on a remote system. The media ID transport file 1172 can be compressed or uncompressed, and can be in binary or ASCII format.

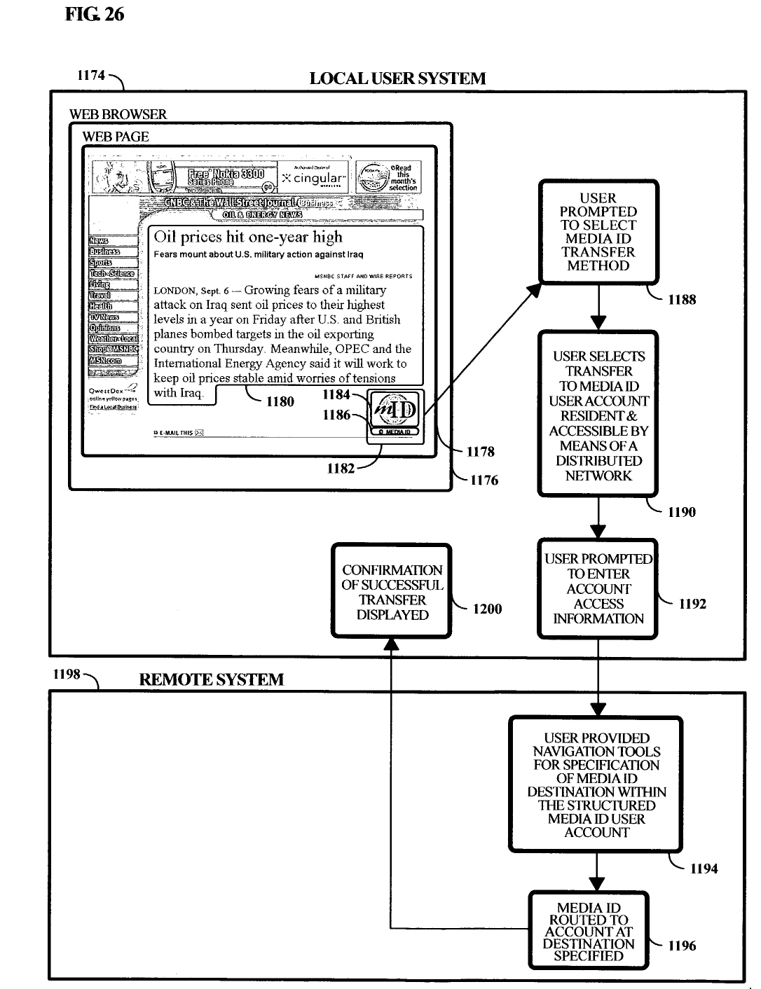

FIG. 26 shows a media ID transfer process from a web page to a user account accommodated through a distributed network or other connection. A web page 1178 is being viewed with a web browser 1176. The user has the web browser 1176 loaded on a local user system 1174. The media ID 1182 is presented on the web page 1178 in conjunction with the article of media 1180 that it uniquely identifies.

A user can save a record of the article of media 1180 by collecting its media ID 1182. This is done by clicking on the media If hyperlink 1186. At 1188 the user is prompted to select a media ID transfer process. At 1190 the user decides to transfer and store the media ID 1182 to a user account located on a remote computer or other device 1198. At 1192 the user is prompted to enter information as to where the user account is located and is asked to provide access information to the user account. Additionally, tools are provided sophisticated navigation to the user account.

At 1194 the user is provided dynamic software tools to facilitate navigation within the structured user account. At 1196 the media ID 1182 is routed and delivered to the account on the remote system 1198 that the user specified. At 1200 a confirmation message is sent to the users local system 1174. The user can access his user account at a later time and download the media ID 1182 to his local software or view the media ID directly thorough the user account.

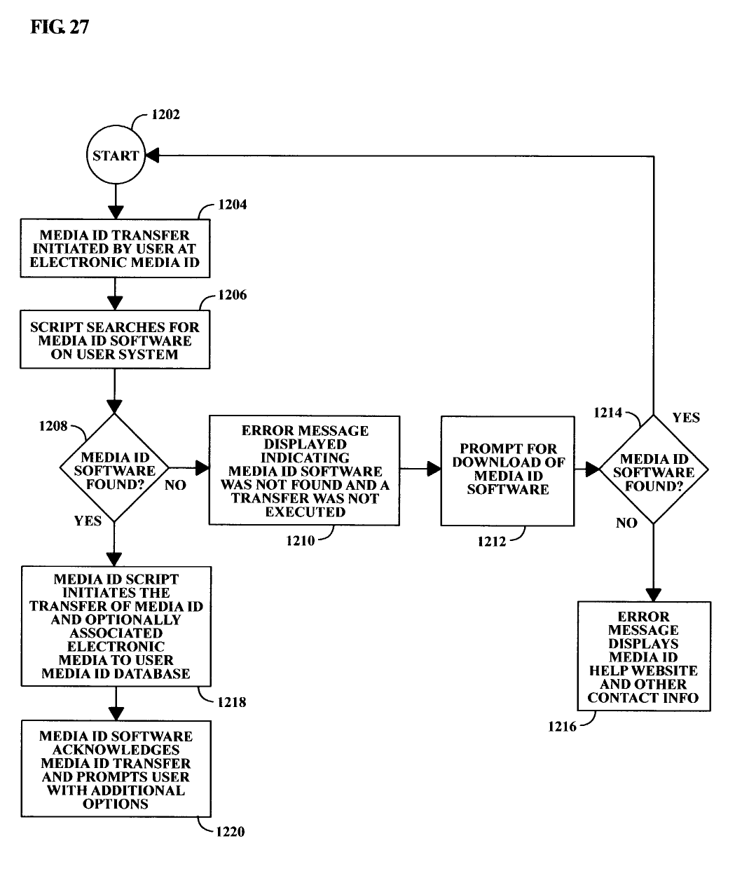

FIG. 27 shows several aspects of the transfer of an electronic media ID. The transfer of an electronic media ID starts at 1202. At 1204, an electronic media ID transfer is initiated by a user at the electronic media and its associated media ID (e.g. Internet web page). For example, the user clicks on an electronic media ID associated with an article of electronic media that is hosted on a web page. At 1206 a script, control, or other process is launched as a result of the user interacting with the media ID. This script, control, or other process searches for media ID software located on the local user system. At 1208, the media ID software is either found or is not found on the local system.

If the media ID software is not found at 1208, an error message is displayed at 1210 indicating that the media ID software was not found and that the transfer was not executed. At 1212 the user is prompted to download the media ID software, or open a user account, or save a media ID transport file to disk. If the media ID software is not found at 1214 after the download prompt, an error message is displayed at 1216. This error message contains information about how to get help installing the media ID software. For example, the error message might display a URL that leads to a web page providing information about the media ID software and how to obtain it.

If the media ID software is found at 1214, then the process starts again at 1202. If the media ID software was originally found at 1208, then the process proceeds to 1218 as opposed to 1210. At 1218 the media ID is transferred from the media source to the media ID software and its associated database located on the users computer. At 1220 the media ID software acknowledges the successful receipt of the media ID and prompts the user with additional options. These options can include transferring the original article of media in addition to the media ID. These options can also include joining an online discussion group or bulletin board or performing searches for related media.

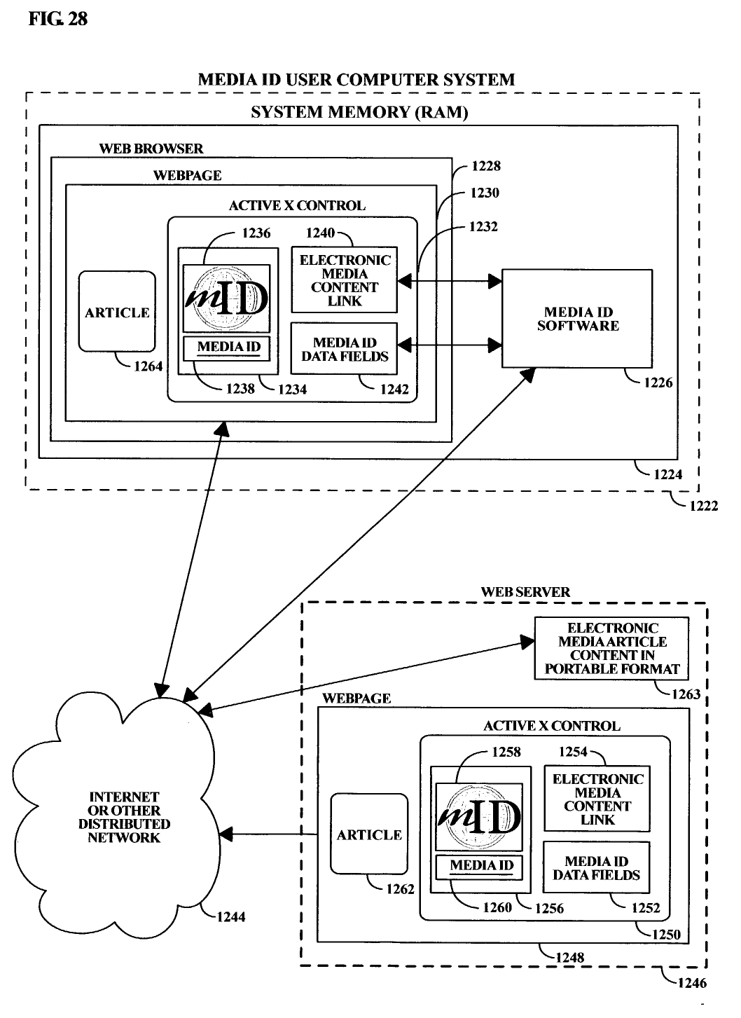

FIG. 28 displays a media ID transfer process from an Internet web server to the media ID software. FIG. 28 displays a web server 1246 that is hosting a web page 1248 that contains an article of electronic media 1262 with an associated media ID that is incorporated in an ActiveX™ control 1250.

The media ID located on the web server 1246 has been published in an ActiveX™ control 1250, or other control that contains, is encoded with, or references data fields 1252 that uniquely define and identify the article of electronic media 1262 on the web server 1246. The control also contains electronic media content links 1254 enabling the ActiveX™ control to manage a download of the original article of electronic media in portable format 1263, or hand-off the necessary information for a transfer to be executed by the media ID software 1226 or other process. Additionally, the ActiveX™ control 1250 is graphically represented 1256 by a media ID graphic 1258 and/or character hyperlink 1260. The original article of media that the media ID uniquely identifies is located at 1262.

A user computer system 1222 has the media ID software 1226 and the web browser software 1228 loaded in system memory at 1224. A web browser 1228 is shown with a web page 1230 that contains a media ID that is incorporated in an ActiveX™ control 1232 and an associated article of electronic media 1264. In this embodiment, the web page 1230 loaded in the web browser 1228 has been obtained using the Internet 1244 from the host web server 1246. The user of the local computer 1222 can save the media ID and the associated article of media 1264 presented on his web page 1230 and hosted from the web server 1246. To do this, the user clicks on the media ID graphic 1236 to initiate a transfer. The ActiveX™ control or other control or mechanism 1232 initiates communication with the local media ID software 1226 and negotiates transfer of the media ID data fields 1242. If the user specifies that they wish to obtain the associated original electronic media content 1263, then the ActiveX™ control 1232 or media ID software 1226 can utilize the link information located within the ActiveX™ control at 1240 to download the original electronic media hosted on the web server at 1246. This download can be accomplished using a distributed network connection 1244.

These transfers are initiated by the user and facilitated by the media ID software 1226 or ActiveX™ control 1232 and a distributed network browser 1228. The user can activate the transfer of a media ID simply by clicking on the graphic representation of the ActiveX™ control 1234 associated with the article of electronic media 1264 that is presented through the web browser 1228 on the user computer system 1222. The media ID software 1226 then receives the incoming media ID data fields 1242 or electronic media article content in portable format 1263 that is being transferred.

Alternatively, the article of electronic media 1264 displayed on the web page 1230 of the users computer system 1222 can be converted to a portable document format through a process executed by the ActiveX™ control 1232 or media ID software 1226. This method eliminates the need for the ActiveX™ control to contain electronic media content links 1240 and the web server 1246 to host electronic media article content in portable format 1263.

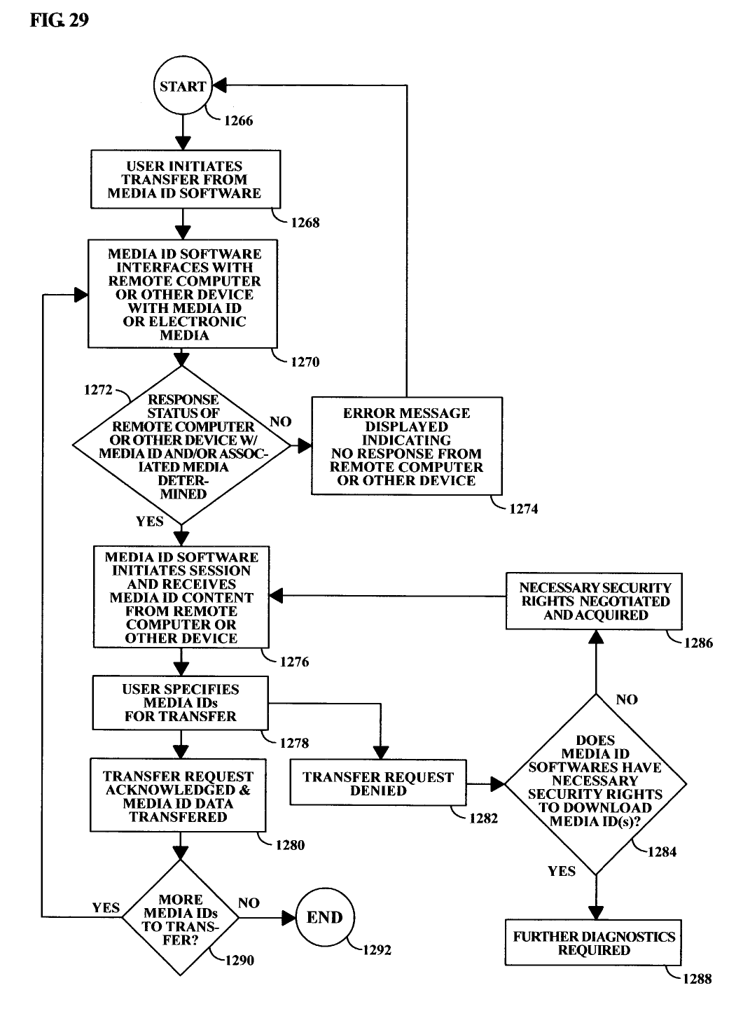

FIG. 29 shows the transfer of a media ID from media ID software to a remote computer or other device. The process of transferring an electronic media ID starts at 1266. At 1268, a media ID transfer is initiated by the user from his media ID software. For example, the user opens his media ID software and decides to transfer a media ID from a remote source to his local media ID software on his local computer platform.

At 1270 the media ID software processes the transfer request from the user and opens a connection to a remote computer or other device selected by the user that is hosting the target media ID. At 1272, the response status of the remote computer, or other device, or software is determined. If the remote computer or other device does not respond, a “no” state is reached and an error message is displayed at 1274. The process returns to start at 1266.

If the remote computer or other device does respond at 1272, the media ID software initiates a session with the remote computer, software, or other device and receives media ID content information and media content information from the remote computer or other source at 1276.

At 1278 the user specifies what media ID content he wishes to transfer. If at 1282 the media ID transfer request is denied, then at 1284 the media ID software making the transfer request determines if sufficient security rights and access protocols are in place to download the media ID. If it is determined that sufficient rights and access protocols are in fact in place to download the media ID from the remote media ID software, the process proceeds to 1288 for further diagnostics.

Alternately, at 1284 it is determined that the necessary transfer rights are not in place. At 1286 the necessary transfer rights and access protocols are negotiated and acquired. Following the successful negotiation of transfer rights and access protocols, the process returns to 1276 and the process starts again.

If the original transfer request at 1276 is acknowledged, or if access rights were negotiated at block 1286, the user specifies which media IDs to transfer at 1278, and the media IDs are transferred from the remote media ID software to the local user media ID software at 1280. After the media ID has been successfully transferred, the local media ID software prompts the user at 1290 to determine if the user wishes to transfer more media IDs. If the user wishes to transfer more media IDs, the process returns to 1270. If the user does not wish to transfer more media IDs, the process ends at 1292.

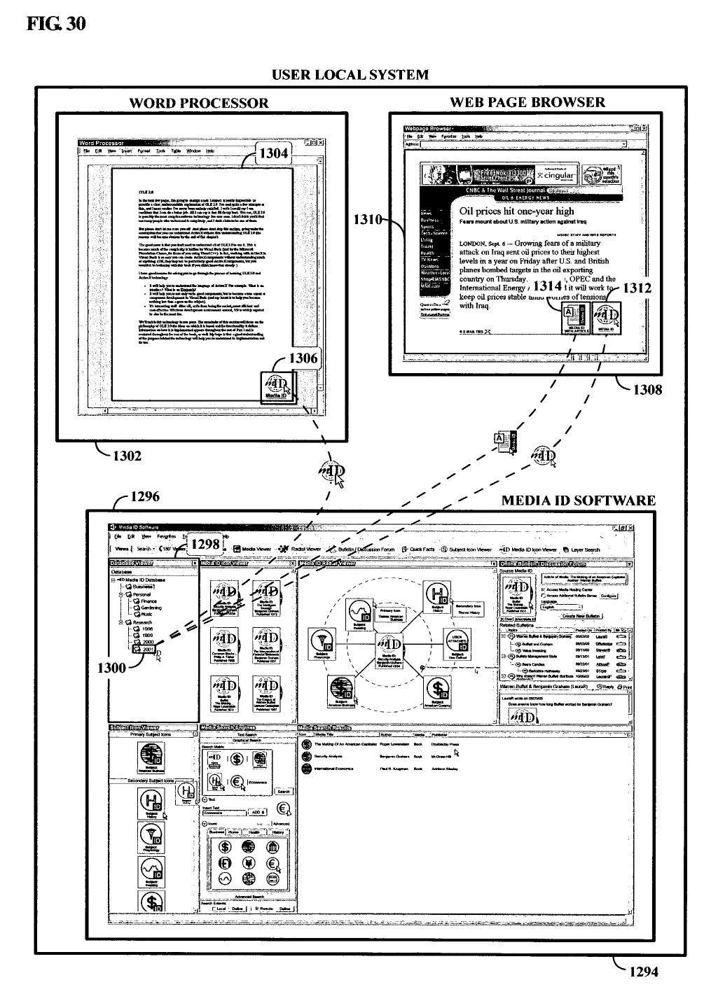

FIG. 30 is a screen illustration showing media IDs being dragged from articles of media and being dropped into the media ID software 1296 that is located on a local user computer system 1294. For example, a word processor 1302 contains an article of media 1304 that has an associated media ID 1306. FIG. 30 shows the media ID 1306 being dragged from the word processor 1302 to the media ID software 1296. Media IDs can be dragged from articles of media directly into the media ID software 1296. The media ID software 1296 receives the media ID 1306 from the word processor 1302, decodes it and then catalogs and organizes it into its database.

A media ID 1312 located on a web page browser 1308 uniquely defines and identifies an article of media 1310 that is being displayed on the web page browser 1308. FIG. 30 shows the media ID 1312 being dragged from the web page browser 1308 to the media ID software 1296. The user is dragging the media ID 1312 into the database viewer 1298 of the media ID software 1296. Media IDs can be dropped into many different windows within the media ID software 1296. Once dropped in the media ID software 1296, the software automatically decodes the media ID 1312 and stores it in the media ID database. In an embodiment, the media ID 1312 is a media ID only and does not contain the associated article of media 1310. Alternatively, media IDs can be encoded with the identifying text of the article of media and the original article of media itself.

A media ID 1314 is shown being dragged from the web page browser 1308 and dropped in the media ID software 1296. The media ID 1314 contains the original article of media 1310 and is dropped into the database viewer window 1298 where the media ID software 1296 receives the media ID 1314 decodes it, organizes it, and manages it. The media ID software now contains the media ID 1314 that uniquely represents the article of media 1310 plus the article of media 1310. The media ID software 1296 provides sophisticated tools to interact with both the media ID 1314 and the article of media 1310. In this embodiment, the only difference between media ID 1312 and media ID 1314 is the inclusion of media item 1310 within media ID 1314.

In yet another embodiment, the graphical representation and manipulation of media and media IDs and the related ability in the media ID software 1296 provides the user with the ability to quickly transfer media IDs to the media ID software.

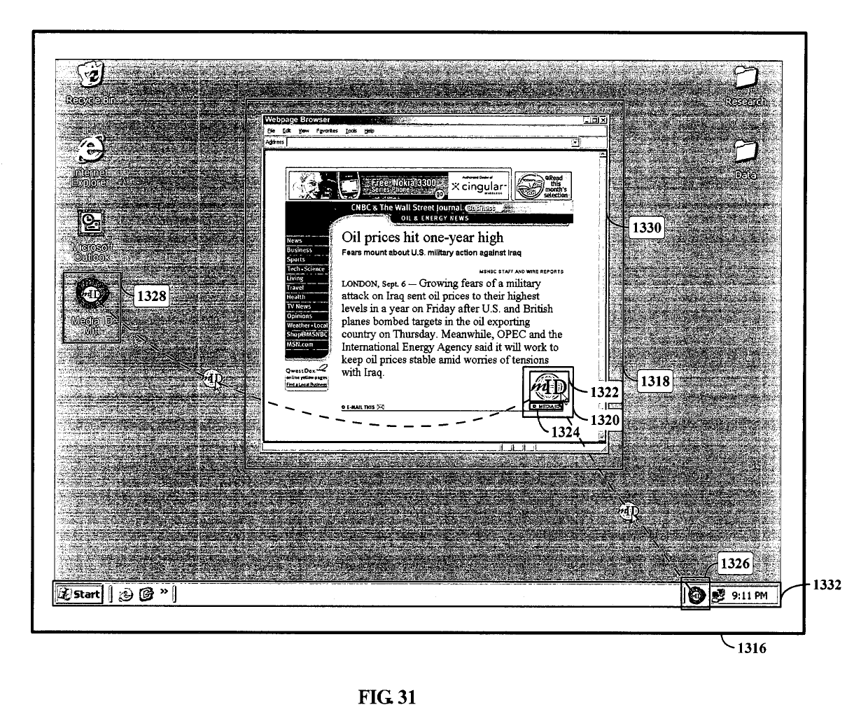

FIG. 31 shows a media ID 1320 being dragged from a web page browser 1318 to the media ID mitt 1328. The media ID mitt 1328 is placed on the desktop 1316 so that the user does not have to open the media ID software to drag and drop media IDs from articles of media to the media ID software. The media ID mitt 1328 is available on the desktop 1316 to “catch” any media IDs that the user wants to save to the media ID software. The media ID mitt 1328 is capable of storing media IDs and then automatically transferring them to the media ID software once it has been opened. The media ID mitt 1328 can also be configured to automatically send the media IDs to the media ID software database even when the media ID software is closed.

For example, a media ID 1320 is shown being dragged from a web page browser 1318 to the media ID mitt 1328. This media ID 1320 uniquely identifies the article of media 1330 that is being displayed on the web page browser 1318. The media ID mitt 1328 catches the media ID 1320 and stores it until the media ID software is opened. Alternately, the media ID mitt 1328 catches the media ID 1320 and automatically stores it in the media ID software database. The media ID mitt can be used whether the media ID software is active or not, providing users the option of dragging media IDs to the mitt 1328 as opposed to the minimized, or even closed media ID software.

FIG. 31 also shows a media ID mitt 1326 that is located in the task bar 1332. The media ID mitt can be located in the task bar 1332 or on the desktop 1316. A media ID 1320 is shown being dragged from the web page browser 1318 to the media ID mitt 1326 located in the task bar 1332. The media ID mitt 1326 catches the media ID 1320 and automatically stores it in the media ID software database. Like media ID mitt 1328, the media ID mitt 1326 in the task bar 1332 can be used whether the media ID software is active or not.

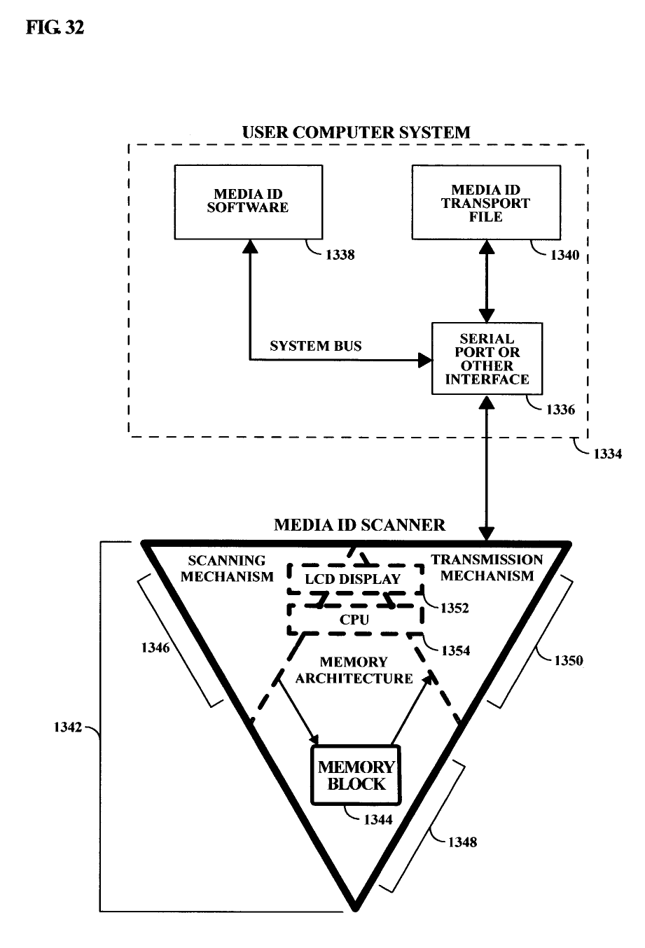

FIG. 32 displays a media ID transfer process from a handheld media ID scanner to a user computer system. The media ID scanner 1342 is a portable hand-held electronic device like a cellular phone that stores media IDs that have been scanned. The media ID scanner 1342 is used to scan and collect printed and electronic media IDs and store them in memory 1348. Once stored in memory 1348, the user has a record of articles of media and can download them to the media ID software 1338, to a media ID transport file 1340, etc. that are located on a user computer system 1334.

In response to a user's request, an embodiment of the media ID scanner transmission mechanism 1350 sends the media ID(s) stored in the electronic scanner 1342 to a user computer system 1334. The transfer from the media ID scanner 1342 is received at the user computer system 1334 via a serial port, or other interface (e.g. infrared, Firewire, USB) 1336. After being received at the serial port or other interface 1336, the media IDs from the electronic scanner 1342 are sent to the media ID software 1338. The media IDs could alternately be sent to a media ID transport file 1340 on the user computer system 1334. The media ID transport file 1340 is a platform independent file that contains media ID(s) that can be moved between different user platforms and loaded into the associated media ID software. In yet another embodiment, a media ID transport file 1340 that contains media ID(s) can be sent from the user computer system 1334 to the media ID scanner 1342. Additionally, a media ID can be sent directly from the media ID software 1338 on the user computer system 1334 to the media ID scanner 1342. This two-way communication allows the user to move media ID(s) back and forth between the media ID scanner 1342 and the user computer system 1334.

The media ID software 1338 catalogs and organizes the media IDs sent from the electronic media ID scanner 1342. The interaction between the electronic media ID scanner 1342 and the user computer system 1334 provides a mechanism for a user to collect media IDs in the absence of the media ID software 1338. The handheld scanner 1342 provides a storage place 1348 for the media IDs until such time that they are loaded into the media ID software 1338 on a user computer system 1334. The handheld scanner can also send the media IDs to other hardware and electronic transport files.

In another embodiment, a system and software for managing media IDs and associated media using a database for the storage, management, and communication of media IDs and media associated with media IDs. This embodiment efficiently manages media IDs using software with an integrated database located at a client or other computer that organizes and catalogs an archive of media IDs and associated media. Additionally, the software negotiates the communication and transfer of media IDs from various sources. For example, the media ID software receives the media ID when a user activates a transfer from a web page electronic news article that has an associated media ID. Alternately, the media ID software can send a media ID from a local user platform to a remote user platform.

An embodiment of the present invention operates in a distributed computer environment, which includes, but is not limited to servers, client computers, PDAs, media ID scanners, LANs, WANs, the Internet, and wireless device connections. This embodiment provides software for managing media IDs. The media ID software can interface with a multitude of media that have, contain, or are linked to associated media IDs. Some examples include printed newspaper articles, music videos, MP3 songs, electronic news, videos, etc. Additionally, the media ID software can interface with media ID scanning devices, PDAs, electronic media documents, electronic mail, media ID database archives, media hosting servers, and a multitude of other devices.

The media ID software program manages media IDs and their content, provides advanced query tools for searching and sorting of media ID content, manages the download and transfer of media IDs and associated electronic documents, and includes screens, windows or other facilities for quick and easy previewing of electronic documents. The media ID software includes advanced tools for export of media IDs and/or their associated electronic media via numerous transfer mechanisms. For example, these can include SMTP, instant messaging software, and computer I/O ports.

The media ID application program also includes the proper software tools to allow a user to publish or otherwise create and implement their own electronic and printed media IDs. This embodiment may be practiced in distributed computing environments where tasks are performed by remote processing devices that are linked through a communications link or network. In a distributed computing environment, program modules may be located in both local and remote memory storage devices. Execution of the program modules may occur locally in a stand-alone manner or remotely in a client/client or client/server manner. Examples of such distributed computing environments include device/computer connections, local area networks of an office, enterprise-wide computer networks, and the Internet.

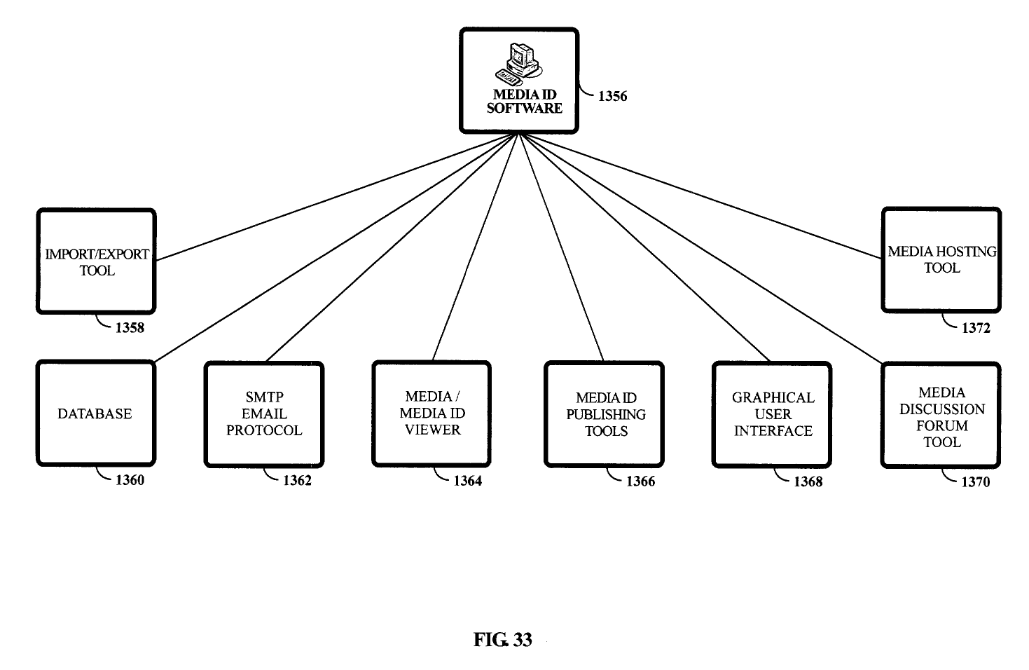

FIG. 33 shows components of an embodiment of the media ID software. The media ID software 1356 is comprised of components or elements 1358 through 1372. An import/export component or process is located at 1358. This import/export process allows media IDs to be imported and exported from the media ID software. For example, a user could export his media IDs to a media ID export file. This user could then give this media ID export file to a colleague who could subsequently import it into his media ID software. The colleague (or importer) would now have his own collection of media IDs in addition to his friends. The import/export process at 1358 can be utilized for a variety of other import/export processes such as file exchange, file conversion, and to perform work on a collection of media IDs.

A media ID database component is located at 1360. This database is capable of cataloging and organizing the media IDs and associated media that the user or other entity inputs, downloads into, or otherwise transfers into the media ID software. The database is an active component of the software that is accessed for simple and advanced media ID searches, to organize groups of media IDs, to archive media IDs, and to perform searches and filtering of media IDs. The database 1360 has a sophisticated default organization structure. Additionally, the database structure can be customized based upon user input. The database can be configured to suit the personal tastes of each user. An aspect of the media ID database located at 1360 is its ability to store, catalog, and organize articles of media as well as media IDs. For example, a user can download a media ID from an article of electronic media and store it in the database located at 1360. The user can then download the original article of media that the media ID identifies and represents and can store that in the media ID database located at 1360.

An e-mail component is located at 1362. The e-mail component provides the media ID software with a connection to the world of electronic mail. Users of the media ID software described herein can e-mail media IDs to friends directly from the media ID software. The e-mail component can also be used as a tool that the media ID software can use to perform work associated with local media IDs and remote media IDs.

A media and media ID viewer is located at 1364 in FIG. 33. This media ID viewer provides a quick and simple mechanism for the user to view text, graphics, sound, and video associated with media IDs and to view the media IDs themselves. This capability allows the user to click on or otherwise select a media ID and quickly see relevant text, graphics, and play sound and video associated with the media ID. In some cases the media ID viewer at 1364 will allow the user to view not only a subset of the media ID, but the entire contents of the media ID. For example, the viewer at 1364 allows the user to play movies such as MPEG and DIVX files.

A media ID publishing tools component is located at 1366. The publishing tools allow the user to “publish” their own media IDs. For example, an author might finish a mystery book and wish to publish it with a unique media ID. The publishing tools at 1366 can be used to publish a unique media ID on the mystery book that is in all respects in conformity with media ID standards. The user's local media ID publishing tool is capable of operating in concert with a media ID intermediary or other media ID entity that has been established to maintain and provide oversight for media ID creation.

A media ID graphical user interface component is located at 1368. This graphical-user-interface is the front-end through which the media ID user accesses most other aspects of the media ID software. For example, if a media ID software user wants to look for a particular media ID, the graphical user interface provides simple yet powerful tools to interface with the database component that is located at 1360. The graphical-user-interface provides the user with a graphical representation and text representation of media IDs and has tools like drop-down menus and pop-up boxes etc. that facilitate the users needs. The graphical-user-interface is the local users primary interface with the media ID software.

A media ID discussion forum tool is located at 1370. The media ID discussion forum provides support for users to log on to discussion forums, and to support discussion forums on their local platform. For example, a user downloads an electronic media ID about the slide of the dollar against the euro. In addition to downloading the media ID, the user downloads the entire article of electronic media. The media ID software will catalog and organize the media ID and the associated article of media. At 1370 the media ID software also provides the interface for the user to join any online discussion forums that exist and are related to the article of media (in this case the slide of the dollar against the euro). Additionally, the media hosting forum at 1370 allows the user to host an online or bulletin board discussion related to media IDs and associated media. The media ID software has built in capability that allows the user to host his own small forum that other media ID users can join.

A media hosting tool is located at 1372. The media ID software provides support for the user to host media IDs and related articles of media. A user can share a media ID with a friend through the tools and functionality associated with 1372. For example, a user can configure the media ID software to allow a set of users to access one or more media IDs or associated article of media using the tools located at 1372. The user can also provide anonymous access to media and media IDs as well.

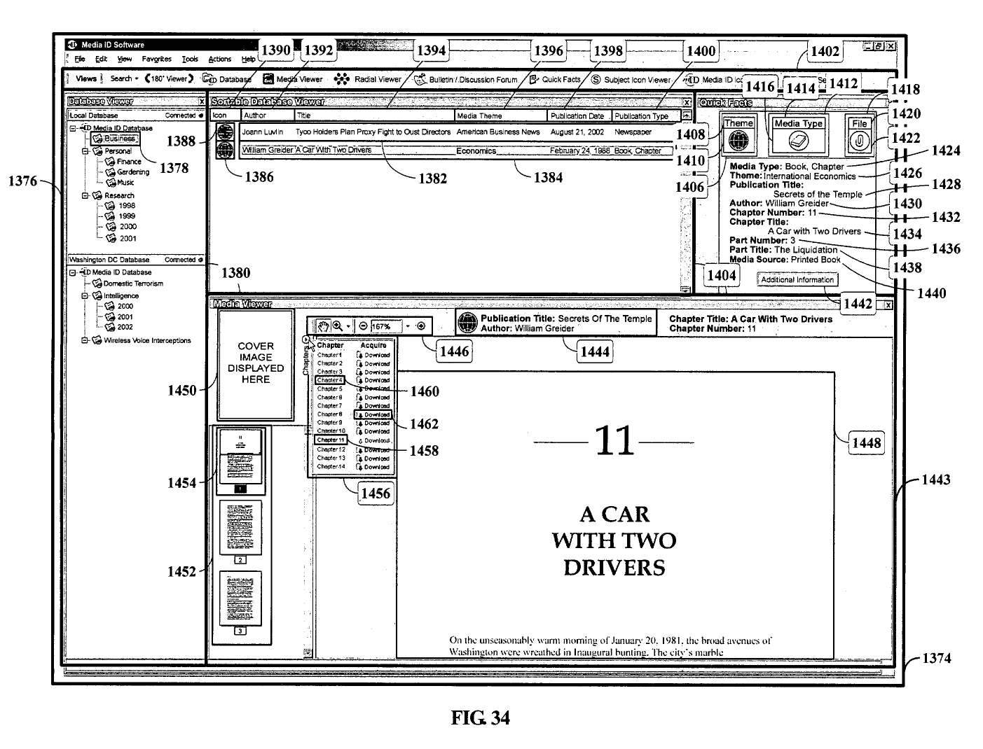

FIG. 34 shows a screen display that illustrates several aspects of an embodiment of media ID software. The media ID software contains many features and is designed to be user-configurable. Because the user can easily configure the software to his liking, many alternate variations of the screen display are possible. In this example, a media ID database navigation tool 1376 is used for accessing the information in the media ID software database. The user can create directories and folders as required, or the media ID software can automatically create directories and folders as media IDs are loaded into the software. The media ID software as presented in the current invention has a default media ID organization structure. This default media ID structure will automatically organize the media IDs into logical groupings without input from a user.

A user can either accept the default media ID database organization structure, or establish their own organization structure. The media ID database navigation tool 1376 shows several folders and sub-folders to illustrate a simple media ID database structure. In this example, the business folder 1378 is currently highlighted. When a database folder that contains media IDs is highlighted, the media IDs are displayed in the sortable database viewer 1380.

The sortable database viewer 1380 displays a list of the media IDs contained in the business folder 1378 that is located in the database navigation tool 1376. The first media ID 1382 is a newspaper article and the second media ID 1384 is a chapter from a book. In this example, the media ID 1384 is shown with text and an associated graphic icon 1386. Although the media IDs are primarily represented by text in screen display 1374 of the media ID software, numerous other representations of the media IDs within the media ID software are possible. For example, the media IDs can be represented primarily by graphics with supporting text.

Each media ID contains unique information about the article of printed or electronic media that they are associated with. Each media ID also contains at least one subject classification that identifies it with a theme or subject matter. An alternate embodiment establishes a suite of subject classifications for each media ID that represent the different subject classifications and groupings that a single article of media can “belong” to, or be associated with.

The sortable database viewer 1380 shows two media IDs that are being represented graphically and with text. In this example, the sortable database viewer 1380 displays the contents of the business database folder 1378. The first media ID 1382 has an American flag/dollar sign graphic 1388 associated with it. This American flag/dollar sign graphic 1388 is a graphical representation of a primary subject classification. Subject classifications can also be represented with text and by other means. This American flag/dollar sign graphic 1388 visually alerts the media ID user that the primary subject content of this article of media is American business. A user of the software can place their mouse or other pointer over the graphic to activate a hint box that displays text information that is equivalent to the graphic.

The second media ID 1384 has an International economics graphic 1386 associated with it. This International economics graphic 1386 is a graphical representation of a primary subject classification and indicates that this article of media is principally related to international economics. In this example, media ID 1384 from the sortable database viewer 1380 is currently highlighted. When a media ID is highlighted in the sortable database viewer 1380, detailed information about it will be displayed in other areas of the media ID software. Media IDs can be quickly sorted and arranged by the sortable database viewer 1380. For example, the media IDs can be sorted by author 1392, by subject icons 1390, by media theme 1396, by publication date 1398, etc. As an example, the publication date column header 1398 in the sortable database viewer 1380 can be clicked on by the user to quickly sort media IDs displayed in the sortable database viewer by publication date.

The quick facts window 1404 of FIG. 34 shows relevant information associated with the currently highlighted media ID 1384 from the sortable database viewer 1380. The quick facts window 1404 provides the user with a collection of useful information about the currently selected media ID. The following information is provided in the quick facts window 1404: the media ID theme 1406, the media ID media type 1412, the presence of an attached file 1418, the media type 1424, the theme 1426, the publication title 1428, the author 1430, the chapter number 1432, the chapter title 1434, the part number 1436, the part title 1438, and the media source 1440.

The quick facts window provides the media ID software user with a set of convenient facts about the article of media associated with the media ID currently selected. This information can come directly from the information encoded within or otherwise associated with the media ID that is uniquely identifying the article of media. The information that is encoded in a media ID that renders each article of media unique is used to populate most or all of the quick fact section.

Information can be represented graphically or with text in the quick facts window 1404. For example, the primary subject classification of the article of media uniquely represented by the media ID 1384 that is currently selected in the sortable database viewer 1380 is international economics. This primary subject classification information from the currently selected media ID 1384 is represented at 1406. Block 1406 is composed of text 1408 and an international economics subject classification graphic 1410. The text 1408 consists of the word “Theme” and the graphic 1410 is a graphical representation of the primary subject classification international economics. A user of the software can place their mouse or other pointer over the graphic 1410 to activate a hint box that displays text information that is equivalent to the graphic. In this example the equivalent text would be international economics. The information at block 1406 in the quick facts window provides a fast and simple method for the user to visually determine the primary subject classification of the currently selected media ID 1384.

This graphical and text representation of aspects of a media ID provides a mechanism where the user can simply glance at the quick facts window 1404 and immediately see information about the article of media associated with the media ID. For example, Block 1418 is composed of text 1420 and a file graphic 1422 that indicates whether or not an article of media is attached to the currently selected media ID 1384. The presence of the graphical representation of a file (paper clip) 1422 in the quick facts window 1404 indicates that a file is currently attached to the media ID 1384. In this example, the attached file is an electronic version of the original article of media associated with the media ID 1384 currently selected in the sortable database viewer 1380.

Information about the currently selected media ID 1384 is also presented with text only in the quick facts window 1404. For example, The chapter title 1434 of the article of media associated with the currently selected media ID 1384 is displayed in the quick facts window 1404. The chapter title 1434 is “A Car with Two Drivers”.

Another aspect of the quick facts window 1404 is the additional information button 1442 located near the bottom of the window. This additional information button 1442 will open another window when the user clicks on or otherwise selects the button that contains comprehensive information about the currently selected media ID 1384. For example, the additional information window can contain all of the information fields from a media ID 1384. In other cases, the additional information window could contain all of the information from the media ID fields plus additional information provided by the media ID software. Configuration controls are also made available that allow for user defined customization of the quick facts window.

In a further embodiment, an embedded media player/viewer enables users of the media ID software to open the media ID and/or article of media and interact with it. Screen display 1374 shows a media ID viewer/player 1443 that a user of the media ID software can utilize to view attached media or media IDs. In this case, the media associated with the currently selected media ID 1384 from the sortable database viewer 1380 is being shown. In this example, the media ID 1384 and the original article of media that the media ID identifies are two separate entities.

The original article of media in this case is a chapter from a book and is an attachment to the media ID 1384. The top section of the media viewer window 1443 is divided into information display areas and shows information about the article of media currently being played or viewed. For example, the publication title area 1444 is “Secrets of the Temple.” In addition, the top section of the media viewer 1443 contains media navigation and display tools 1446 that allow the user to pan or precisely move through the media, enlarge or reduce the media view, and to set the view scale etc.

The media viewing tools and methods of interacting with the media automatically change depending on the type of media ID selected and the different types of media that media IDs can represent. For instance, if a chapter from a book is selected, a book or text viewer is appropriate. If the user selects a media ID from an MP3 song, a sound player would be activated. If the user had selected a media ID from a video, a video player would be activated instead of a viewer. If the user had selected a media ID from a photo, a photo viewer would be activated etc.

Screen display 1374 of FIG. 34 shows additional aspects of the media ID software. A graphical representation 1450 of the media that the media ID identifies is displayed in the media viewer 1443. In this case a graphic 1450 represents the front cover of the original article of media (book) that the media ID 1384 uniquely identifies. In this case, the media ID 1384 that is currently selected in the sortable database viewer 1380 and is being viewed in the media viewer window 1443 is from a chapter from the book whose front cover is shown as a graphic 1450.

Immediately below the graphic 1450 are thumbnail preview pages 1452 from the article of media associated with the media ID 1384 that is currently selected. The user can click on any of these preview pages 1452 and the page clicked on will be displayed in the media viewer window 1448 to the right. In this example, the first preview page 1454 is currently selected and is being displayed in the viewer window 1448. The chapter title is “A Car With Two Drivers” and it is chapter eleven. This information is currently being viewed in the media ID viewer 1448 to the right.

Screen display 1374 of FIG. 34 shows additional aspects of an embodiment of the media ID software. A media ID software acquisition tool 1456 is shown that the user can utilize to acquire additional media or media IDs related to the currently selected media ID 1384. In this example, the media ID software contains only chapter eleven from the book entitled “Secrets of the Temple”, as indicated by it being solid black text 1458 in the acquire tool 1456. The other chapters in the acquisition tool 1456 are grayed out, indicating that they are not currently present in the media ID software database. For example, chapter four 1460 is grayed out indicating that is not currently present in the media ID software.

In this embodiment, the right side of the media ID acquire tool 1456 provides a mechanism for the user to acquire the chapters of the book that are not present. These chapters are shown in active black, which indicates that the user can click on them for acquisition. For example, the user can acquire chapter 6 by clicking on the black active download text 1462. Once the user clicks on a chapter to acquire it, the media ID software will process the request and retrieve the media and associated media ID. This is accomplished through a distributed network connection or other connection as discussed above.

The acquisition tool will change form depending upon the type of media ID that is currently selected in the media ID software. For example, if a media ID for a single song from an album is selected, then the acquisition tool might show the balance of the songs on the album and allow the user to download them if the proper authorization is in place. Hot buttons for the media ID software are displayed at 1402. Hot buttons allow the user to open a particular window or configuration screen with one click. Hot buttons also allow the user to starts processes, access the database, and perform other tasks related to the management of media IDs.

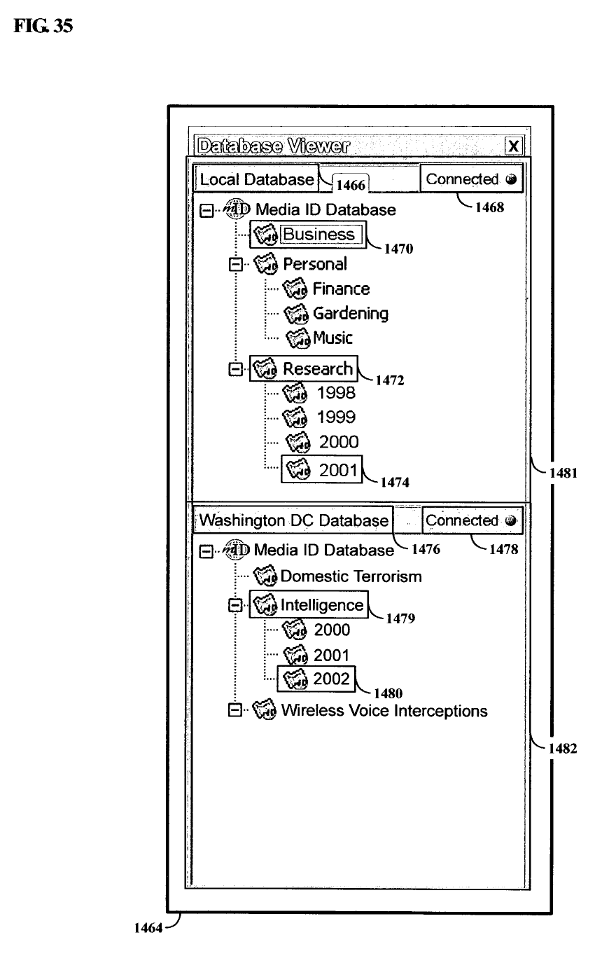

FIG. 35 shows a screen display of the database viewer 1464 from FIG. 34 that contains additional information. The database viewer 1464 allows the user of the media ID software to view, access, and manage the media IDs stored in the local media ID database(s) or remote media ID database(s) associated with the media ID software. A top-level local media ID database folder 1466 defines and encompasses a discrete media ID database. The local media ID database 1466 is the local database for the local user's media ID software.

The top-level local media ID database 1466 shown in FIG. 35 is composed of sub-folders that contain media IDs and provide a sophisticated organization structure. For example, a business folder 1470 is located immediately beneath the top-level local media ID database folder 1466. A research folder 1472 is also located beneath the top-level local media ID database folder 1466 and contains a 2001 sub-folder 1474. A status indicator 1468 provides an immediate visual indication (green light) that the database folder is currently on-line and accessible. Media IDs and associated articles of media can be accessed through the database viewer when the database is on-line.

A remote media ID database 1476 is shown in FIG. 35 that the user can also view through the local media ID software and database viewer 1464. The remote media ID database 1476 is located on a remote system that the local media ID software is currently connected to. A status indicator 1478 provides an immediate visual indication (green light) that the remote database is currently on-line and accessible. The remote media ID database 1476 is composed of folders and sub-folders that contain media IDs and associated media. For example, an intelligence folder 1479 contains a 2002 sub-folder 1480.

The business folder 1470 is currently highlighted or selected in the database viewer 1464. Highlighting or selecting a database folder in the database viewer 1464 will result in information about the media IDs contained in that folder being displayed elsewhere in the media ID software.

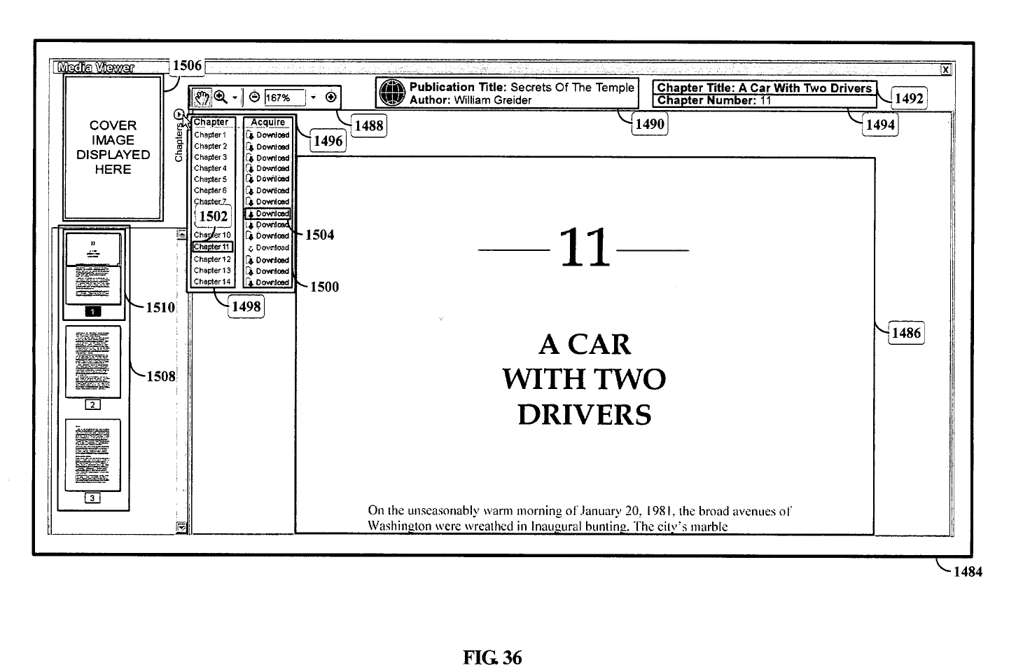

FIG. 36 shows a screen display of the media viewer window 1484 from FIG. 34 that contains additional information. A media/player display area 1486 displays media associated with media IDs that the user has currently selected. The media display area 1486 will change in appearance and functionality depending upon what type of media ID is currently selected. For example, the media display area 1486 is currently displaying information from a chapter of a book. If a media ID associated with a digital video file was selected, a player capable of playing the digital video file would be presented in area 1486 instead of a viewer for a chapter of a book.

Media viewer navigation and management tools 1488 are also displayed in the media viewer window 1484. These tools provide media management capabilities to the user and change based upon the type of media ID and associated media currently selected. Information about the currently selected media ID and associated media is displayed at 1490, 1492, and 1494. In this example, the information is the publication title 1490, the chapter title 1492, and the chapter number 1494.

A media and media ID acquisition tool 1496 provides a mechanism for users to download media or media IDs associated with the currently selected media ID. A graphic 1506 of the media associated with the media ID provides a visual representation for the user to see. A preview pane or viewer 1508 allows the user to see additional media content that is not currently displayed in the view area 1486. In this example, the media viewer 1484 is flexible and changes appearance and form based upon the media type selected.

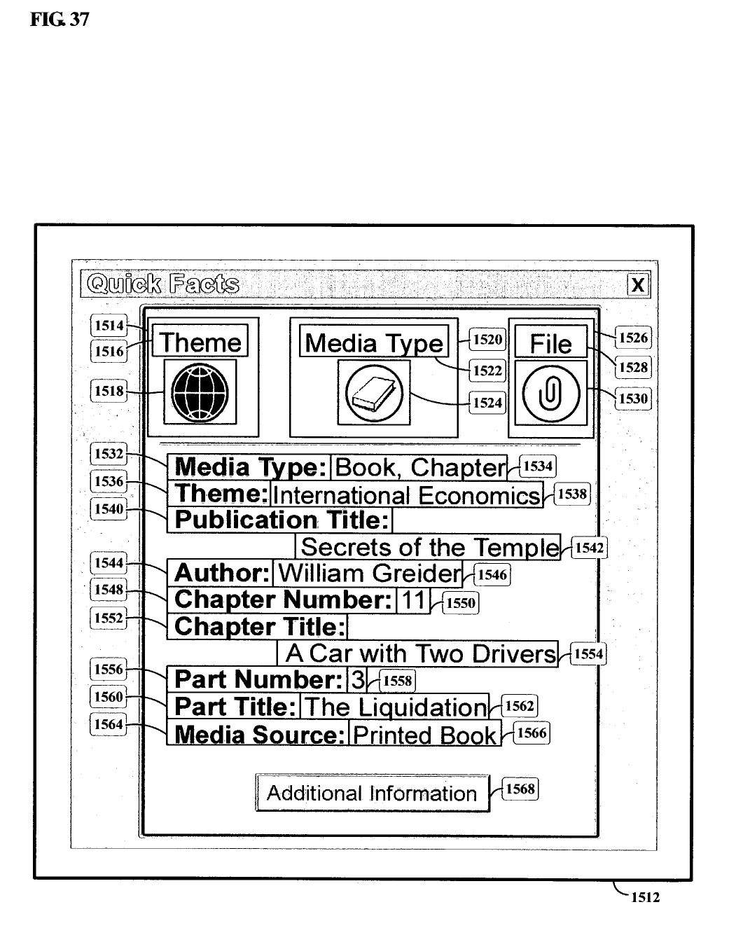

FIG. 37 shows a screen display of the quick facts window 1512 from FIG. 34. The quick facts window 1512 provides a quick information summary of the currently selected media ID. For example, three graphics are presented at the top of the quick facts window 1512 that each have text immediately above the graphic. These graphic/text combinations provide useful visual information about the currently selected media ID. For example, the theme of the currently selected media ID is presented at block 1514 which contains text 1516 and a graphic 1518. The text 1516 reads “Theme” and the graphic 1518 is an international economics icon. The user can quickly process this information and understand that the theme of the currently selected media ID and associated media is international economics.

Text fields below the graphic/text combinations provide the user with additional information about the currently selected media ID and associated media. For example, a media part title 1560 has an associated field 1562 that is currently populated with the text “The Liquidation.” These text fields in the media ID software quick facts window 1512 provide the user with a quick summary of relevant information about the article of media associated with the currently selected media ID.

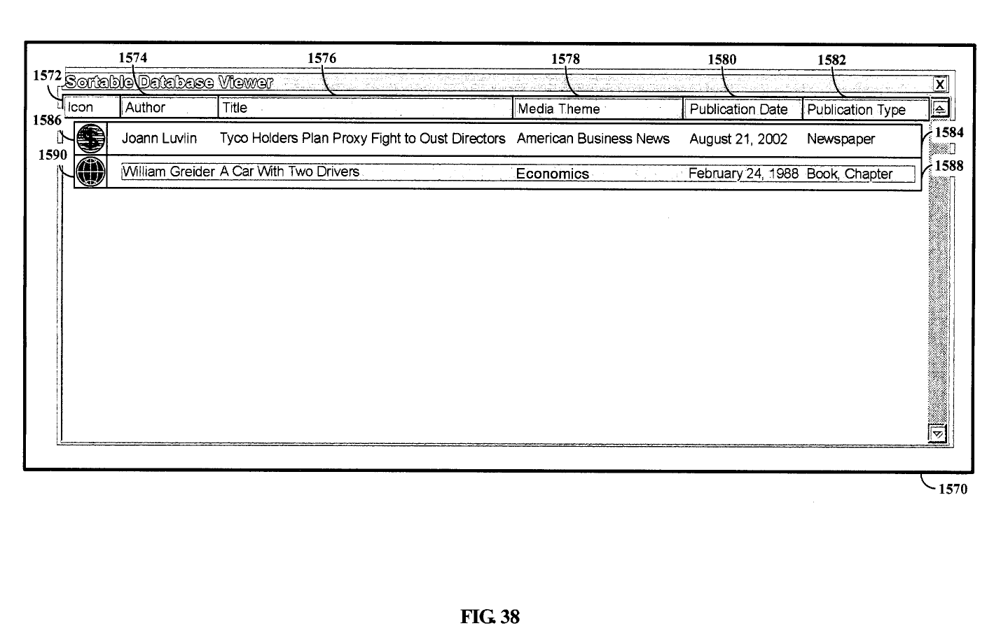

FIG. 38 shows a screen display of the sortable database viewer window 1570 from FIG. 34. The sortable database viewer 1570 provides the user with a display of media IDs and associated media from the currently selected folder in the database viewer. The sortable database viewer 1570 in FIG. 38 shows two media IDs. The first media ID 1584 represents a newspaper article and has a primary subject classification graphic 1586. Items 1572 through 1582 are dockable information fields that control what information is displayed for each media ID. The information fields also can be used to quickly sort the list of media IDs that are currently shown in the media ID sortable database viewer 1570.

For example, if the user clicks on publication type 1582, the media IDs will automatically be sorted in a logical order based upon their associated publication type. The second media ID 1588 is shown highlighted in FIG. 38. When a user highlights a media ID in the sortable database viewer, additional information about the media ID becomes available in other media ID software windows.

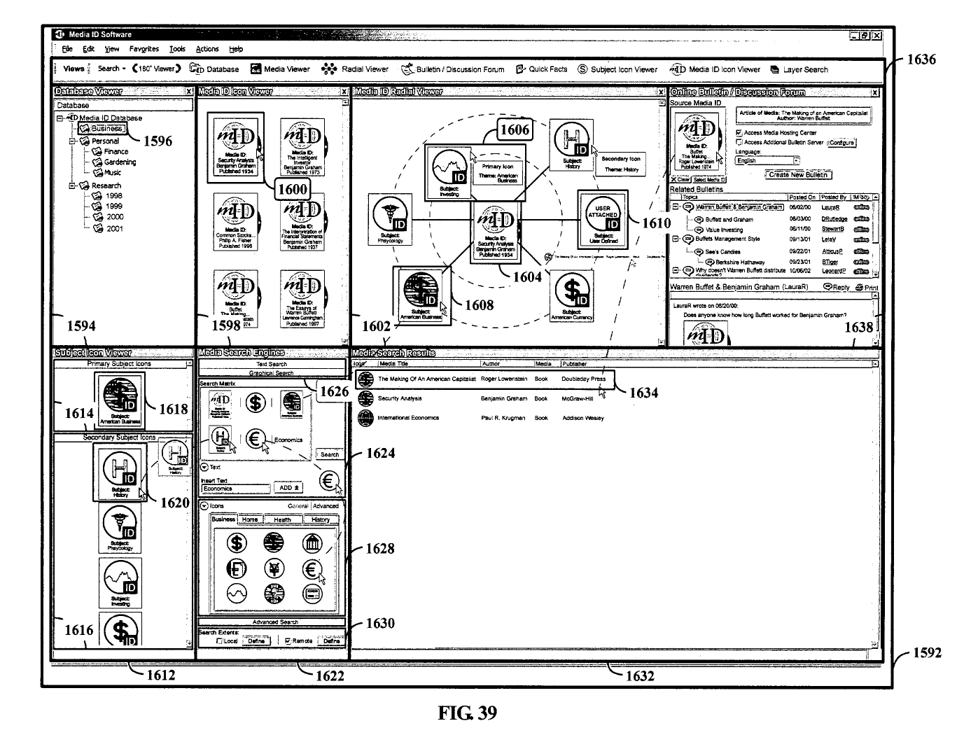

FIG. 39 shows a screen display 1592 that illustrates several aspects of the media ID software. The media ID software contains many features and is designed to be user-configurable. Because the user can easily configure the software to his liking, many software screen variations are possible. In this example, the screen display generally follows standard windows formatting.

A database navigation tool 1594 (or database viewer) allows the user to access the information in the media ID software database or other media ID databases. The user can create directories and folders as required, or the media ID software can automatically create directories and folders based upon imported media and media ID content. The media ID software as presented in the current invention has a default media ID organization structure. This default media ID structure will automatically organize the media IDs into logical groupings.

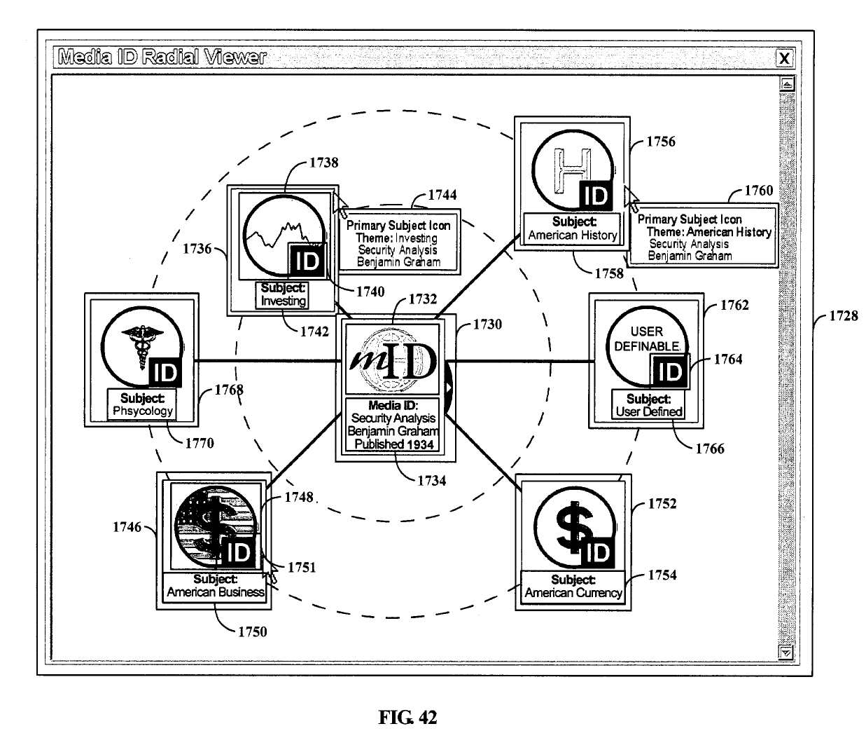

An embodiment of the media ID subject classification viewer 1602 provides a radial view of the selected media ID and its associated subject classifications. The media ID subject classification viewer 1602 (or radial viewer) is covered in detail in FIG. 42. Several aspects of the radial viewer 1602 as it relates to the media ID software will be discussed here. The media ID radial viewer 1602 provides users of the media ID software with a graphical and text representation of the subject content or subject classification(s) of the currently selected article of media that is represented by a media ID 1604. The radial viewer 1602 can be turned on and off at the users discretion. The radial viewer 1602 shows 1 primary subject classification 1606 being represented by graphics and text, and 5 secondary subject classifications (for example, 1608) being represented by graphics and text. The system of attaching multiple subject classifications to a media ID 1604 accurately captures the many subject hues of the article of media, as opposed to the current system of attaching a single subject classification. In this embodiment, the primary and secondary subject classifications are being represented with graphics and with text.

A secondary subject classification graphic 1608 associated with the media ID 1604 is shown being dragged from the radial viewer 1602 and dropped in the media search matrix 1624. The currently selected media ID 1604 uniquely defines and represents “Security Analysis” by Benjamin Graham and the primary and secondary media ID subject classifications in the radial viewer 1602 help to comprehensively define the subject content of the media ID 1604 and the article of media it represents. The secondary subject classification graphic 1608 that is being dragged from the radial viewer 1602 to the media search matrix 1624 indicates that the article of media associated with the media ID 1604 contains subject content related to American business.

In this example a user can visually see by the arrangements of primary and secondary subject classifications that a secondary theme of Benjamin Graham's book is American business. The media ID software allows the user to drag and drop any aspect of the media ID subject classification structure into the search matrix 1624. When this secondary subject classification is dragged into the search matrix 1624, it will influence the media search with the subject it represents, American business, and it will influence the search by its attachment to the media ID 1604.

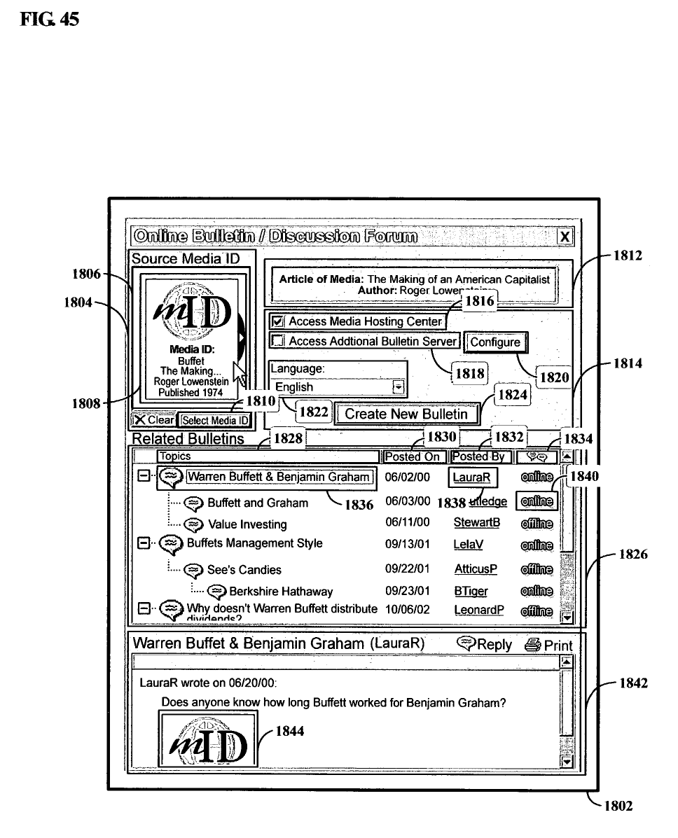

An online bulletin/discussion forum window 1638 provides users of the media ID software with tools to support online bulletins and discussion groups. A media ID 1634 can be dragged from the media search results window 1632 into the online bulletin/discussion forum window 1638. This allows the user to easily populate the online bulletin/discussion forum window 1638 with a topic media ID. The online bulletin discussion forum window 1638 is discussed at length in FIG. 45.

A media ID subject icon viewer 1612 contains primary 1618 and secondary 1620 media ID subject classifications. The media ID subject icon viewer 1612 contains subject classification information that is similar in nature to the information presented in the radial viewer 1602. The media ID subject icon viewer 1612 organizes the subject icon information in a horizontal or vertical orientation and separates the media ID subject content into primary 1614 and secondary 1616 subject classification categories.

Like the media ID radial viewer 1602, the subject viewer 1612 contains graphic and text descriptions of each media ID. In this window display 1612, the subject classifications are placed in a vertical fashion and the subject icon viewer that contains them is placed immediately adjacent to the media search engine 1624. This facilitates the dragging and dropping of the primary 1614 and secondary 1616 subject classifications associated with a media ID from the media ID subject icon viewer 1612 to the to the media search matrix 1624.

A secondary media ID subject classification 1620 is shown being dragged from the subject icon viewer 1612 to the media ID search matrix 1624. The secondary media ID subject classification 1620 that is being dragged from the subject icon viewer 1612 and dropped in the search matrix 1624 is the history subject classification. When this secondary subject classification 1620 is dragged into the search matrix 1624, it will influence the media search with the subject it represents, history, and it will influence the search by its attachment to the media ID 1604 that is associated with. Alternatively, the history subject classification could have been dragged from the media ID radial viewer 1602 as well.

The media ID software contains sophisticated media and media ID search tools as well as sophisticated media and media ID filtering tools. A media ID search engine window 1622 in FIG. 39 provides powerful and flexible search capabilities. The media ID search engines window 1622 contains a search matrix 1624 that the user can utilize to design and execute searches for media IDs and associated media. The radial subject classification window 1602 and the media subject icon viewer window 1612 visually establish the subject content and subject relationships of a media ID 1604 and the article of media that it represents. Once the subject content is established the user can then drag all of the subject identifiers or some sub-set of them to the media ID search matrix 1624 to develop sophisticated searches with little effort.

A media search results window 1632 shows the results from a media ID search executed from the media search engine 1622. In this example, three search results were returned in the media search results window 1632. The user of the media ID software can click on one or more of these search results to access the media ID associated with it and or the original article of media.

A media ID icon viewer 1598 displays the contents of the currently selected database folder 1596 from the database viewer window 1594. In this example, the media ID 1600 in the upper left is currently selected. When a media ID 1600 is selected in the media ID icon viewer 1598, it will appear in detail in the media ID view windows such as the media ID radial viewer 1602 and the subject icon viewer 1612.

Hot buttons 1636 allow the media ID software user to open a particular window or configuration screen with one click. Hot buttons 1636 also allow the user to start processes, access the database, and perform other tasks related to the management of media IDs.

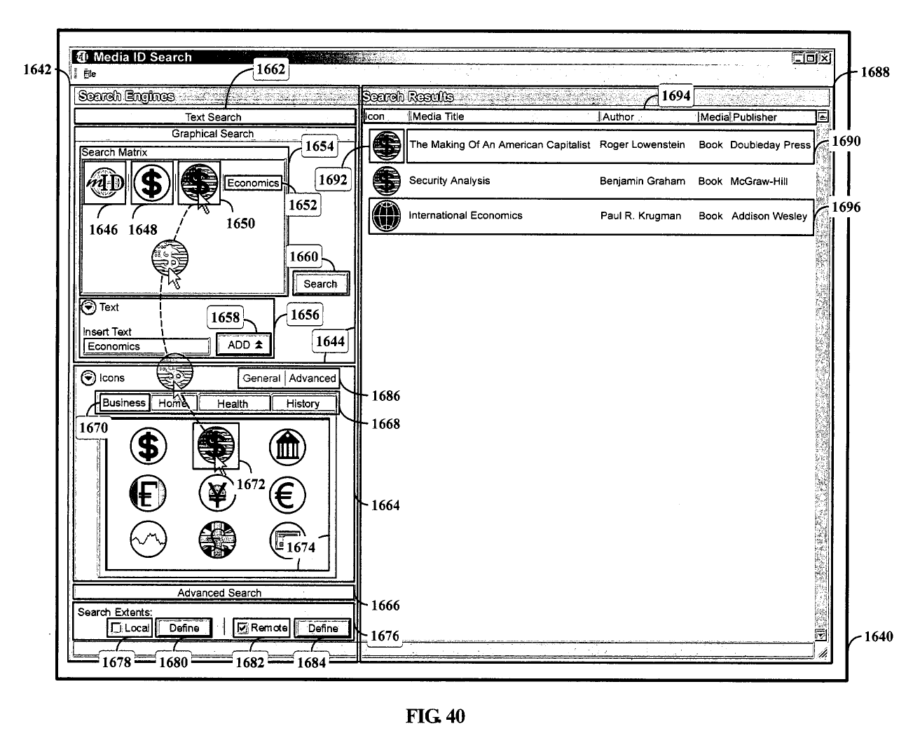

FIG. 40 shows a screen display of the media ID search tool 1640 from FIG. 39. An embodiment of the present invention introduces the concept of graphical searches for locating articles of printed and electronic media. A graphical search is made possible in part because each media ID has a primary subject classification graphic associated with it as well as a suite of secondary subject classification graphics.

In an embodiment, more than one subject classification graphic is associated with each article of media because articles of media are complicated and rarely one-dimensional. Because of this, any given article of media tends to fall into several subject categories rather than Just one subject category. This embodiment addresses this complexity by assigning each article of media a suite of subject classification graphics rather than just one subject classification graphic (or icon). This graphical subject classification suite also enables the user to visually see the subject categories that an article of media belongs to or is associated with, as opposed to having to read text to identify the subject classification categories.

Because the user can see the subject categories or themes associated with each article of media graphically, it is logical to allow the user to design searches based upon graphics in addition to text. FIG. 40 shows a graphical search engine 1644 that performs this task. This graphical search engine 1644 allows the user to drag media IDs and different sets of primary and secondary subject classification graphics into a search area or matrix 1654. The user can drag and drop multiple subject classification graphics and text into the search matrix 1654 and then perform a search.

Media ID software graphical/text searches are defined and guided by the media IDs, subject classification graphics, and text placed in the search matrix 1654. For example, a media ID 1646 from an article of media is located in the search matrix 1654, an American currency graphic 1648 is located in the search matrix 1654, an American business graphic 1650 is located in the search matrix 1654, and the text “economics” 1652 is located in the search matrix 1654. This combination of graphics and text constitutes a unique search that the media ID software user can execute. The user can click on the search button 1660 and the media ID software will begin a search based upon the four items in the search matrix 1654. The search can occur on the local platform as well as remote platforms.

The introduction of a graphical search engine 1644 empowers the media ID software user in several ways. First, the introduction of the association of subject classification and other graphics with articles of media and media IDs provides a more meaningful identification of media than text alone. People process visual information through text as well as graphics, and attaching both to media and media IDs allows a more sophisticated identification system. It is reasonable to assume that more advanced search processes can be designed with the combination of graphic information and text information that help define an article of media.

Second, the association of graphics with media and media IDs facilitates media searches because the associated icons are easily dragged and dropped into the search matrix 1654. Dragging and dropping graphics such as icons is far less cumbersome than typing strings of text into a box. Instead of having to type in text for searches, a user can simply drag and drop media IDs, associated icons, and generic subject icons into the search matrix 1654 and then click on search. Because this process is visual, and easy, users are more apt to search for related media and even more apt to perform sophisticated searches that are easy for them to imagine visually, but difficult to imagine with text only.

FIG. 40 shows a window display of a media and media ID search window 1640. This search engine window is activated inside of the media ID software and is user-configurable. Window display 1640 of FIG. 40 contains a graphical plus text search engine, a text search engine, advanced search parameters, and other tools for the media ID software user. These different search engines and options are activated by clicking on the tabs located at the top and bottom of the search engines window 1642. In FIG. 40, the graphical plus text engine 1644 has been activated by clicking on the graphical search tab at the top of 1644, and is currently shown. The search matrix area 1654 is where media IDs, primary and secondary subject classification graphics associated with media IDs, and text are dragged or otherwise placed in order to define a search. Four items have been placed in the search matrix 1654 of the media ID software search engines window 1642 in this example. Three of the search items are graphical subject classifications and one is text. The search matrix 1654 contains a media ID 1646, an American currency graphic 1648, an American business graphic 1650, and the text economics 1652.

Generic subject classification graphics 1674 provide a library that the user can access to drag media subject classifications into the graphical plus text search engine 1644. The different categories of subject classification graphics are accessed by a series of subject tabs 1668. In this case the business tab 1670 has been activated. The user can drag any of these business subject classification graphics 1674 into the search matrix 1654 to further define the search. There is a difference between the generic subject classification graphics 1674 and the primary and secondary subject classification graphics associated with a media ID. The primary and secondary media ID subject classification graphics will always remain associated to the media ID they identify and will influence any search with their relationship to the media ID that they are associated with. These media ID subject classification graphics have an ID located at the lower right of the graphic. The generic subject classification graphics 1674 of FIG. 40 have no associations with a particular media ID, and will influence any media ID or media search only with the generic subject matter that they represent.

In this embodiment, an American business subject classification graphic 1672 is shown being dragged from the generic subject classification library 1674 to the search matrix 1654. The insert text feature 1656 allows the user to type search terms in the search window 1654. The user adds this text by clicking on the add button 1658.

In this embodiment, the search matrix 1654 is currently configured for a simple graphical and text search. A user can execute the search by clicking on the search button 1660. In this example the user has populated the search matrix 1654 with a media ID, generic subject classification graphics, and text. This embodiment of the media ID search engine 1642 illustrates the ease with which a user can conduct a sophisticated search and the visual dimensions of graphical searches.

Search extents parameters 1676 for the media ID and media search engines provide a mechanism for the user to define the range and dimensions of the media and media ID search. For example, the search can be conducted on the local machine only, on remote platforms only, or on the local machine and remote machine(s). The define buttons 1680/1684 allow the user to comprehensively define the local and remote search parameters for media and media ID searches.

A search results window 1688 provides a mechanism for the user to view the search results from searches originating at the search engines 1642, or other media ID software search engines. In this example, three search results have been returned based upon a search that originated from the search engines 1642. The search results window 1688 can display the search results from searches conducted on the local system, or can display the search results from searches conducted on media and media IDs located on remote platforms. The search results can represent searches designed to locate media, to locate media IDs, or to locate combinations thereof. The media ID software user can download the media and associated media IDs that are returned in the search window. This is accomplished by clicking on an item located in the search window and following the media retrieval instructions.

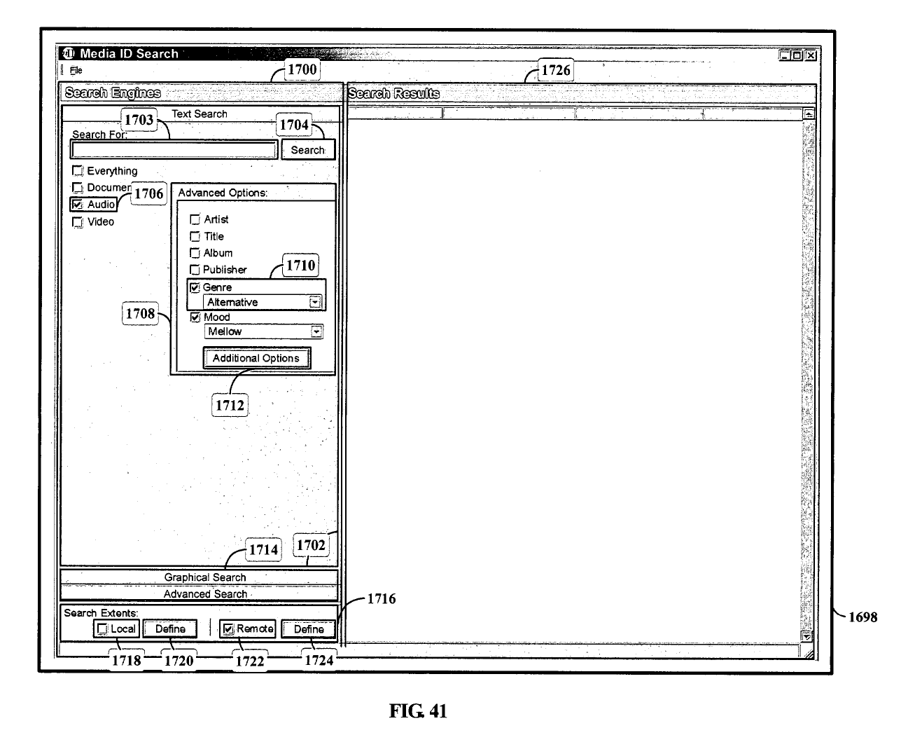

FIG. 41 shows a window display of the media ID software media ID search engine 1698 from FIG. 39. The user can click on the tabs at 1714 to move back and forth between the different search engines and the advanced search options. The text search engine 1702 is straightforward and includes a data entry box 1703 that the user can populate with text to define a search. More than one word can be entered into the text box 1703 in the text search engine 1702 to form searches. The user can define whether the search is for all types of media or for select types of media, such as audio only 1706, or video only. The search extents 1716 provides a mechanism for the user to define the local and remote search range and the dimensions of the search for the media ID and media search. For example, the search can be conducted on the local machine only, on remote platforms only, or on the local machine and remote machine(s).

An advanced options window 1708 is available for each type of media that are selected for search. In this illustration the advanced options 1708 are for fine tuning an audio 1706 media search. An additional options button 1712 provides more options for the user to design searches. The search results window 1726 displays the results of searches generated by the text search engine 1702. In this example, no search results are displayed in the search results window 1726 based upon a search originating from the test search engine 1702. The search results window 1726 can display the search results from searches conducted on the local system, or can display the search results from searches conducted on media and media IDs located on remote platforms.

The media ID software user can download media and associated media ID(s) that are displayed in the search window. This is accomplished by clicking on an item located in the search window and following the media retrieval instructions.

A shortcoming of current media identification systems is the tendency to identify articles of media by placing them in a single subject category. For example, the book “Security Analysis” by Benjamin Graham is typically classified as an investment book, where investment is the subject classification of the book. Furthermore, the classification is usually represented by text only. For instance, the identification of “Security Analysis” by Benjamin Graham as an investing book is usually accomplished with text only, and not text and graphics.

An embodiment of the present invention identifies and classifies articles of media with reference to more than one subject classification or theme. Furthermore, in addition to classifying articles of media into more than one subject field, this embodiment uses text and graphics to identify and classify articles of media. This comprehensive classification system better represents articles of media that almost always fall into more than one subject category or subject classification.

For example, “Security Analysis” by Benjamin Graham is better represented by not one subject classification but at least four subject classifications: investing, philosophy, business, and history. This embodiment recognizes that media content is rarely one-dimensional and utilizes multiple graphics and regular text to identify the various subject classifications and categories that media belong to. For instance, “Security Analysis” by Benjamin Graham is represented by a unique media ID, in addition to one or more subject classification icons that symbolize the different subjects or categories that the work pertains to. In our example “Security Analysis” has a primary subject classification that identifies it as an investing book and three secondary subject classifications representing philosophy, business, and history.

A further embodiment of the invention utilizes text and graphics in presenting subject classifications which identify, classify, and catalog articles of media. The association of multiple graphical icons with individual articles of media offers several unique and non-obvious benefits. The visual and graphical representation of the multiple subject categories that an article of media belongs to enables the user to literally see the subject categories rather than reading the subject categories. This helps enable the user to form complicated thoughts about the content and subject matter of the book or other media and better relate it to other articles of media. This is a direct result of the article of media being represented by subject classification icons symbolizing the many facets of the subject content of the article of media and the presentation in a graphical manner. The association of multiple subject categories with an article of media also provides a convenient system for the user of the media ID software to design and execute powerful searches based upon graphical information associated with an article of media as well as text information associated with an article of media.

FIG. 42 shows a window display of the media ID radial viewer 1728 from FIG. 39. FIG. 42 displays primary and secondary media ID subject classifications that are represented through the use of graphics and text. These subject classifications are used to illustrate the underlying subject content associated with an article of media and encoded within each media ID. A media ID subject radial viewer 1728, as it would appear in the media ID software, comprehensively displays the subject classifications associated with a media ID. FIG. 42 is an embodiment of the radial and graphical presentation of the subject classifications of media IDs.

A media ID 1730 as outlined in an embodiment of the present invention uniquely identifies an individual article of media with a set of comprehensive data about the associated article of media. The media ID 1730 of FIG. 42 can represent printed or electronic media. For the purposes of this illustration it is assumed that a user is viewing this media ID radial 1728 inside of the media ID software as described herein. In this example, the media ID icon 1730 is composed of a graphic 1732 and text 1734. This text 1734 describes the unique media ID 1730 with alphanumeric characters.

A primary subject classification icon 1736 can be immediately recognized due to its close proximity to the media ID icon 1730 that it represents and further classifies. Primary media ID subject classification icon 1736 occupies the innermost radial or orbit around the media ID icon 1730. The primary subject classification icon 1736 is immediately identifiable as a media ID subject classification icon by the ID graphic 1740 at the lower right. This ID 1740 draws a distinction between subject classification icons related to and attached to media IDs and generic subject classification icons.

Media ID subject classifications always retain a reference to the media ID that they are attached to. When the user drags a primary media ID subject classification icon into the media ID software search matrix, the primary media ID subject classification icon will influence the search process through the content and identity of the original article of media that the media ID identifies, plus the subject matter represented by the subject matter classification graphic. When the user drags a generic subject matter icon into the search matrix, only the subject matter of the generic subject classification icon will influence the search. Media ID subject matter icons are represented here with an ID graphic 1740 in the lower right to distinguish them from generic subject matter icons that do not have an ID graphic in the lower right corner.

In this example, the subject matter or classification of the primary media ID icon 1736 is investing. The close proximity of this icon 1736 to the media ID icon 1730 establishes that this is a primary media ID subject classification icon and identifies the subject content of the article of media that the media ID represents as being principally concerned with investing. The primary subject classification icon 1736 is composed of a graphic 1738, text 1742, and an ID graphic 1740. This text 1742 describes the primary subject classification with alphanumeric characters. In this case the text reads “Subject: Investing.” A hint box 1744 is activated when the user positions the mouse over the Investing subject classification icon 1736. The hint box 1744 can contain additional information about the subject classification icon 1736 and the media ID 1730. In this example, the hint box 1744 identifies the investing primary subject classification icon 1736 as being a primary subject classification icon, identifies it as an investing subject icon, and identifies the author and title of the work.

Secondary media ID subject classification icons provides additional information about the subject content of the media ID 1730 and its associated article of media. Multiple secondary subject classification icons can be associated with an article of media and its associated media ID 1730. These secondary media ID subject classifications transform the classification of the media ID 1730 and its associated media from a one-dimensional subject classification to a multi-dimensional subject classification. Secondary subject classification media icons are used to reflect the subject spectra that articles of media occupy.

For example, an American business secondary subject classification icon 1746 also has an ID graphic or mark 1751 located at the lower right. This distinguishes the media ID subject classification icon 1746 from a generic subject classification icon. In fact, there is a generic investing subject icon in FIG. 39 that looks identical to subject classification icon 1746 except that it does not have the ID graphic in the lower right.

In addition to the graphical representation of the subject matter, text 1750 is located just below the American business graphic 1748. This text 1750 describes the media ID subject icon with alphanumeric characters. In this case the text 1750 reads “Subject: American Business.” In this example, the primary subject icon occupies the innermost radial and the secondary subject icons occupy the next radial out.

A secondary media ID subject classification icon 1752 is the American currency subject classification icon and indicates that the media ID 1730 is related to American currency as well as investing and American business. An embodiment is the comprehensive identification of the subject matter of an article of media. The media ID subject radial 1728 from FIG. 42 provides comprehensive information about the subject matter of the media ID 1730 at the center of the radial 1728 and provides it in a graphical format as well as a text format. Text 1754 describes the media ID subject classification 1752 with alphanumeric characters. In this case the text reads “Subject: American Currency.”

A secondary media ID subject classification icon 1756 indicates that the media ID 1730 is related to American history as well as investing, American business, and American currency. Text 1758 describes the media ID subject classification 1756 with alphanumeric characters. In this case the text 1758 reads “Subject: American History.” A hint box 1760 is activated when the user positions the mouse over the History subject classification icon 1756. The hint box 1760 can contain additional information about the media ID subject classification icon 1756 and the media ID 1730. In this example, the hint box 1760 identifies the American history icon as being a secondary subject icon, identifies it as a American history Subject icon, and identifies the author and title of the work.

A user definable secondary subject classification icon 1762 provides a mechanism for the user to attach a subject matter graphic or icon to a media ID 1730 and further define and personalize the media ID subject classification. Because classification is subjective at some level, an embodiment of the present invention provides a mechanism for a user to attach media ID subject matter icons to individual media IDs.

A user would attach a media ID subject icon 1762 by going to a library of generic subject icons, finding the appropriate one, and then instructing the media ID software to attach it to the target media ID. Once attached to a media ID, the icon's status would change from a generic subject icon to a media ID subject icon. This user attached icon is recognizable as not being an original attached subject media ID subject icon, but will influence a user designed search in a similar way as an original media ID subject icon. A user attached subject icon 1762 will have an ID 1764 in the lower right that is similar to the ID of an original media ID subject icon.

A psychology secondary subject classification icon 1768 indicates that the media ID 1730 is related to psychology as well as investing, American business, American currency, and American history. Text 1770 describes the media ID subject with alphanumeric characters. In this case the text 1770 reads “Subject: Psychology.”

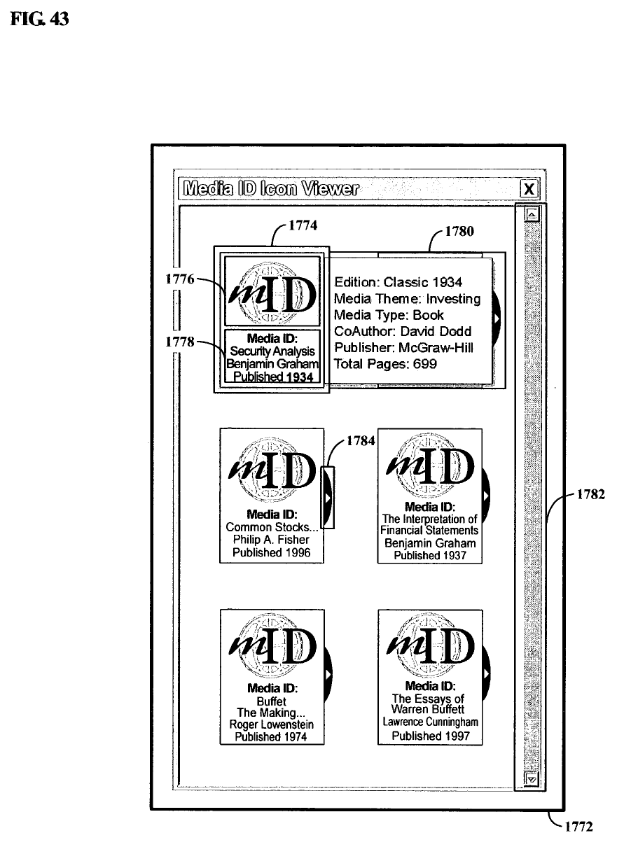

FIG. 43 shows a window display of the media ID icon viewer 1772 from FIG. 39. The media ID icon viewer 1772 is located in the media ID software and displays the media IDs in a graphic plus text format. The icon viewer 1772 displays the contents of media ID folders that are located in local or remote media ID database(s). A media ID 1774 is composed of graphics 1776 and with text 1778. When the user clicks on the fly-out box tab 1784 on a media ID, a fly-out box 1780 appears that displays summary information about the media ID selected. The fly-out box 1780 stays out until the user clicks on the fly-out box tab 1784. The fly-out box contains numerous information fields and expands and contracts based upon user input.

Because many media IDs can be contained in a single folder, a sliding bar 1782 allows the user to scroll up and down through the media IDs located in a media ID software database folder. When a database folder (see FIG. 39) is selected in the media ID software, the media ID icon viewer located at block 1772 in FIG. 43 displays the contents of that folder.

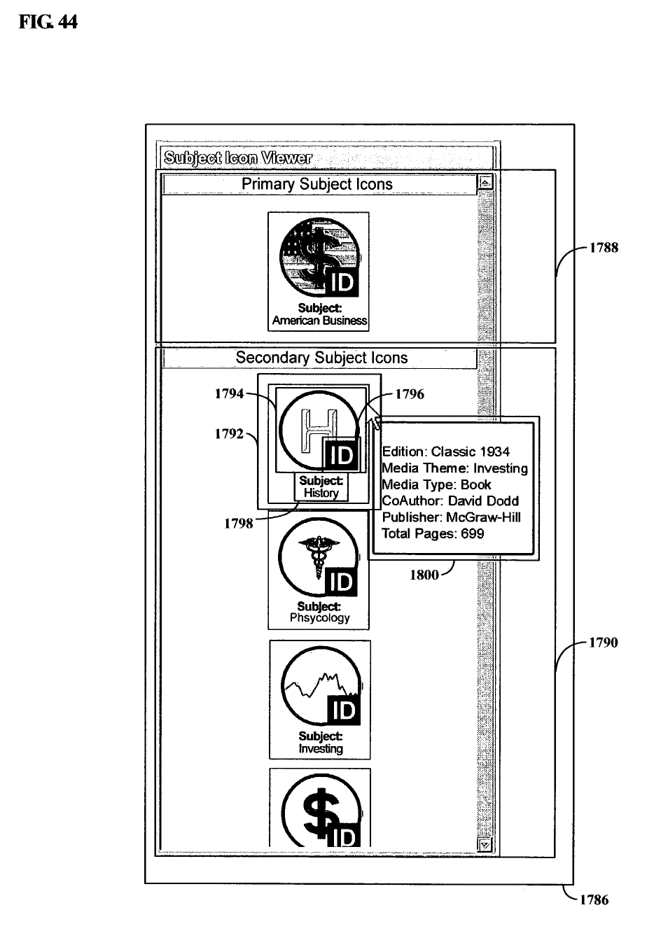

FIG. 44 shows a window display of the media ID subject icon viewer 1786. The media ID subject icon viewer 1786 displays the primary and secondary subject classification graphics or icons associated with individual media IDs and the underlying articles of media that they represent. The media ID subject icon viewer 1786 is divided into a primary subject icon section 1788 and a secondary subject icon section 1790.

A secondary subject graphic or icon 1792 located in the secondary subject icon section 1790 indicates that the selected media ID has subject content that relates to history. The history subject classification 1792 is represented with a graphic 1794 and with text 1798. If the user positions the mouse over the secondary subject icon 1792, a hint box 1800 will appear that displays summary information about that particular subject icon 1792.

FIG. 45 shows a window display of the media ID software online bulletin/discussion forum 1802 from FIG. 39. The online bulletin/discussion forum 1802 provides a mechanism for the user to log onto a local or remote bulletin or other discussion format and to discuss articles of media that are identified by media IDs. For example, a media ID 1808 has been selected by the user with the select media ID button 1810. Media IDs can also be dragged into the media ID source box 1806 from other windows within the media ID software.

Once the user selects a media ID 1808, the online bulletin/discussion forum 1802 provides many tools that the user can take advantage of to access bulletins that contain related media content to the selected media ID 1808 and associated article of media. In this example, the article of media that the media ID 1808 identifies is “The Making of an American Capitalist” by Roger Lowenstein. This information is displayed in a text box 1812.

The online bulletin/discussion forum 1802 provides many tools that the media ID software user can utilize when accessing additional information about a particular media ID 1808. The user can access a centralized media hosting center 1816 or access additional bulletin servers 1818. The user can configure the connection parameters 1820, and can select the desired language at 1822.. The user can also create a new bulletin at 1824. New bulletins can be created on the local machine or on remote servers or data centers.

A bulletin area 1826 shows bulletin topics and user responses. The bulletin area 1826 contains a topics field 1828, a posted on field 1830, a posted by field 1832, an instant communication field 1834, and a variety of other control and management mechanisms. The user can click on any of these fields and post responses, create new topics, etc.

A text entry area 1842 allows the local media ID software user to type in text associated with the online forums and discussions. For example, user LauraR 1838 wrote on Jun. 20, 2000 “Does Anyone know how long Buffett worked for Benjamin Graham?” in the text entry area 1842. The name of a user 1838 who posts a response or creates a new topic is displayed in the bulletin area 1826. In this example, user LauraR 1838 posted on Jun. 2, 2000. By clicking on the hyperlink text LauraR 1838, the media ID software user accesses a window that opens a communication path between the local user and user LauraR 1838.

A status indicator 1840 beneath the instant communication field 1834 displays if a user is currently available through an instant communication mechanism. In this example, the colored online text or graphic 1840 indicates that the user LauraR 1838 is currently online. By clicking or otherwise selecting the graphic at 1840, the user of the media ID software initializes an instant communication with user LauraR 1838. Media ID 1844 is attached to a bulletin message. Media IDs can be dragged and dropped or otherwise placed in bulletin messages. Readers of the bulletins have the option of retrieving the media ID 1844 from the bulletin message 1842 if they wish.

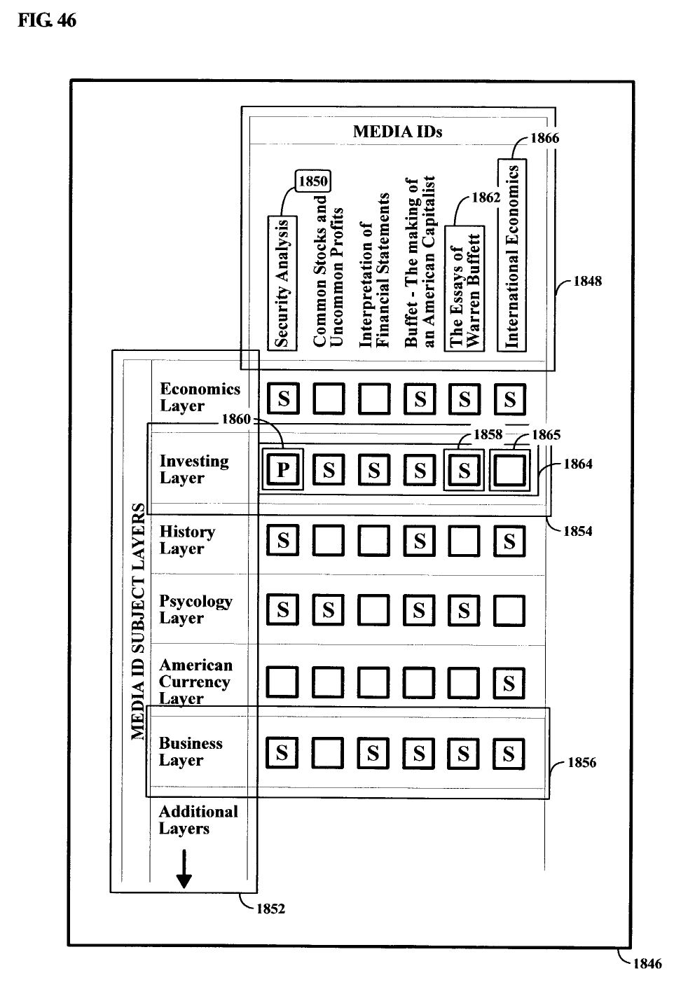

FIG. 46 shows several aspects of an embodiment of the media ID subject layer database system 1846 for the universal identification system for printed and electronic media and associated media ID software. Each media identification or ID can have primary and secondary subject classifications that can be represented by alphanumeric text or graphical icons and that help define the subject matter of the media attached to the media ID. These subject classifications define the subject matter for a given article of media that is represented by a media ID. For example, a media ID might have a primary classification that establishes the media as being primarily related to investing. The same media ID might then be represented by 4 secondary subject classifications (e.g. business, history, psychology, and statistics) that further define the subject content of the article of media. These primary and secondary subject classifications are represented in the media ID software with text and/or graphics (e.g. icons) in association with media IDs.

FIG. 46 shows a simple diagram of an example media ID database structure that contains media ID subject layers and is populated with media IDs and their associated suite of subject classifications. Media IDs 1848 define columns in the media ID layer database. These media IDs 1848 can be represented by alphanumeric text or by graphical means such as icons. In this embodiment they are shown represented as text.

Media ID subject classification layers 1852 can account for a nearly infinite number of subject classification slots within the database. Subject classification layers 1852 are automatically created when media IDs with associated primary and secondary subject classifications are imported into the media ID software. For example, if a media ID with a primary subject classification of investing is imported into the media ID software, then the media ID software will automatically create an investing subject layer 1854 (assuming it has not already been created). Individual subject layer blocks (for example 1858) are either populated or not depending on whether or not a media ID (for example 1862) has that subject classification associated with it.

For example, the investing subject classification layer 1854 contains six subject classification layer slots or blocks 1864. Five of these subject classification slots are populated or activated, indicating that the media IDs and associated articles of media belong to these subject classifications. The slot to the far right 1865 is not populated because the international economics media ID 1866 directly above it does not have investing as a primary or secondary subject classification. Investing block 1860 contains a “P” to indicate that this is a primary subject classification for the “Security Analysis” media ID 1850.

In other words, the primary subject classification of the media ID “Security Analysis” 1850 is investing as evidenced by the subject classification slot being populated with the text “P” 1860. Primary subject classifications determine the primary or principal subject category to which an article of media belongs. Investing block 1858 contains an “S” to indicate that this is a secondary subject classification for the “The Essays of Warren Buffett” media ID 1862. In other words, a secondary subject classification of “The Essays of Warren Buffett” media ID 1862 is investing because the investing slot 1858 is populated with an “S” for secondary. Secondary subject classifications determine secondary subject categories to which an article of media belongs.

By putting the subject classifications of media IDs on layers, an orderly subject classification system is created. Furthermore, the organization of media ID subject classifications on layers provides the user with the ability to construct powerful media and media ID searches. The subject classification layer database also allows the user to visually see the relationships amongst the subject content of the different media and associated media IDs located in the database.

For example, a user could tell the media ID software to display all media IDs that are on the investing and psychology subject classification layers. The results of this search would be to show all of the media IDs and associated articles of media that are common to both layers. This is the same as displaying all articles of media with primary/secondary subject classifications of investing and psychology. In another example, the user of the media ID software could instruct the media ID software to display all media IDs whose primary subject classification is economics and whose secondary subject classifications are history and philosophy.

The layer database, the concept of a layer database, and the visual presentation of a layer database provide an easy mechanism for a user to understand the complex relationships between different articles of media. An embodiment of the present invention provides a graphical-user-interface through which the layer database concept can be utilized by users to analyze media IDs and the associated media.

The attachment of primary and secondary subject icons to media IDs provides sophisticated subject classification tools. This, combined with the creation of subject classification database layers, allows the user to form complicated searches based upon media subject content and to visually see the various relationships between different media.

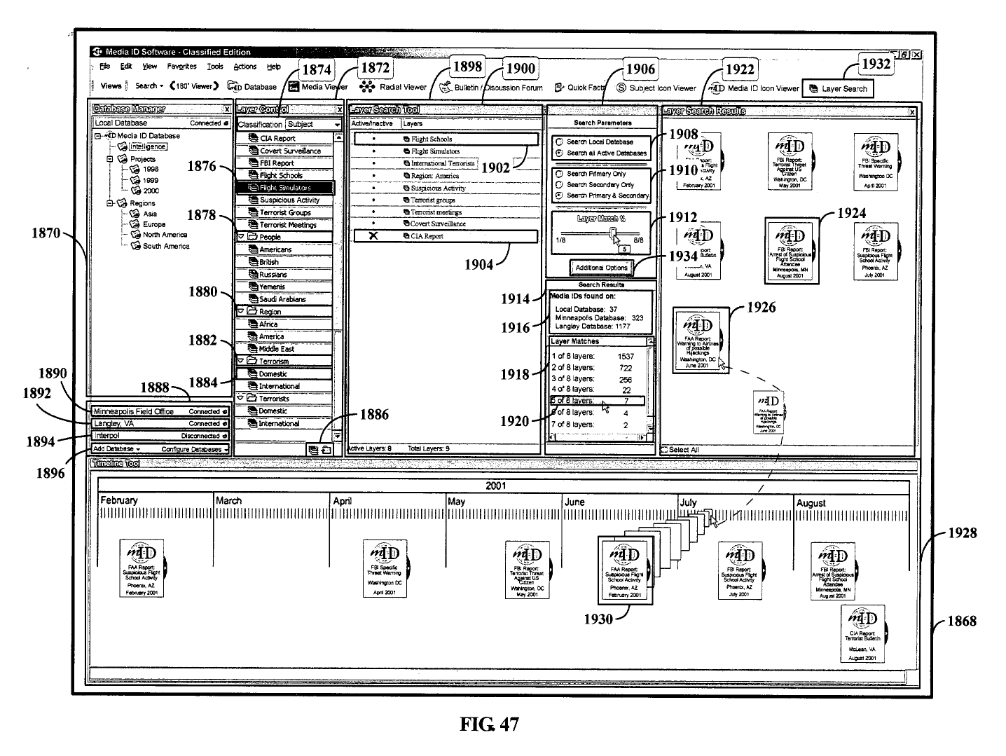

FIG. 47 shows screen display 1868 that illustrates several aspects of an embodiment of the media ID software. Screen display 1868 presents several aspects of the media ID software search capability related to media ID subject classifications and the layer database system. As previously discussed, each media ID has a suite of associated subject classifications that comprehensively define the subject content of the article of media and can be represented with text and or with graphics. These subject classifications exist and are presented on subject classification layers in the media ID software in order to facilitate searches designed to identify media IDs that have similar subject content. Each subject classification layer contains all media IDs that have that particular subject classification.

Screen display 1868 in FIG. 47 illustrates the media ID software configured to do layer searches that are centered around the subject classifications of media IDs. Layer searches can be performed on other aspects of a media ID besides the media ID subject classifications. FIG. 47 only illustrates layer searches associated with subject classifications. A layer search hot button 1932 allows the user to quickly open layer search windows by clicking on the hot button.

The layer control window 1872 is for subject classification and other searches and displays the subject classification layers for the media IDs located in the local media ID software database(s). The layer control window 1872 also displays the subject classification layers for any remote media ID databases that the local media ID software is currently interfaced to.

Media ID databases 1888 are displayed along with an indication of connection status. When a database is connected, subject classification layers from that database will be displayed in the layer control window 1872. In this example, the local media ID software database 1890 for a Minneapolis field office is being displayed as well as a remote database 1892 in Langley, Va. that is being accessed through a remote connection. A remote media ID database 1894 associated with Interpol is also displayed, but the media ID software is not currently connected to it.

FIG. 47 shows eight subject classification layers that have been dragged from the layer control window 1872 into the layer search tool 1898. These eight subject classification layers are from the currently connected databases 1888. The media ID software provides an easy mechanism for the user to view the subject classification layers associated with all of the media ID databases 1888 currently open and then to drag a set of them into the layer search tool 1898. Once they are in the layer search tool 1898, the user can begin performing searches, look for subject relationships, and perform a variety of other searches based upon the comprehensive subject content of the media IDs from the actively connected databases.

The layer search tool 1898 currently contains nine subject classification layers that have been dragged from the layer control window 1872 and dropped in the layer search tool 1898. The subject classifications layers are: flight schools, flight simulators, international terrorists, region: America, suspicious activity, terrorists groups, terrorist meetings, covert surveillance, and CIA report. The media ID user in this example is looking for media IDs that possess subject content similar to these nine layers 1900. Once the user has defined the subject classification layers 1900 for the search, the search process begins. In this example, the CIA report subject classification layer 1904 has been clicked to inactive which temporarily removes it from the search.

A search parameters window 1906 provides a mechanism for the user to define the search parameters. For example, the user can search the local database only or search all active databases 1908. The search parameters 1906 also allow the user to search for primary subject classifications only, for secondary subject classifications only, or for primary and secondary subject classifications 1910. In this example, the search parameters window 1906 allows the user to use primary and secondary subject classifications when defining a search.

A sliding layer match bar 1912 slides from 1/n to n/n where 1/n instructs the software to show all media IDs that have a subject classification on at least one of the n layers, to n/n which instructs the software to show all media IDs that are present on all n of the n layers. For example, eight subject classification layers are active in the layer search tool 1898. The layer match bar 1912 slides from ⅛ to 8/8 where ⅛ instructs the software to show all media IDs from the connected databases that have a subject classification on at least one of the eight layers, to 8/8 which instructs the software to show all media IDs that are present on all eight of the eight layers. When the user moves the sliding layer match bar 1912, the search results are immediately displayed in the layer search results window 1914.

The search results window 1914 displays detailed results from the subject classification layers 1900 that were dragged into the layer search tool 1898. For example, the layer matches window 1918 indicates that there are 1,537 media IDs that are associated with at least one of the eight subject classification layers that have been placed in the layer search tool 1898. An association here means that at least one of the media ID subject classifications (primary or secondary) from the actively connected databases 1888 is on one of the active subject classification layers 1900 in the layer search tool 1898.

The layer matches window 1918 displays the total number of media IDs that match one of eight through eight of the eight subject classification categories from the current search as defined in the layers search tool 1898. For example, two media IDs match seven of the eight subject classification layers.

The fifth field down in the layer matches window 1918 displays the total number of media IDs that match five out of eight subject classification categories, in this case seven media IDs. In this example, the fifth field in the layer matches window 1918 is highlighted. A media ID software user can highlight layer match fields 1918 and they will immediately be displayed in the layer search results viewer 1922. The user can then click on any of the media IDs displayed in the layer search results viewer 1922 to see the full contents of the media ID and in some cases the original article of media that the media ID represents.

A media ID timeline tool 1928 provides a tool for the media ID software user to determine the chronological order of media IDs. For example, the layer search tool 1898 is used to design a search that returns seven media IDs that match five of eight subject classification layers. These seven media IDs that comprise the search results can be dragged and dropped into the timeline tool 1928 that automatically organizes them into a chronological order.

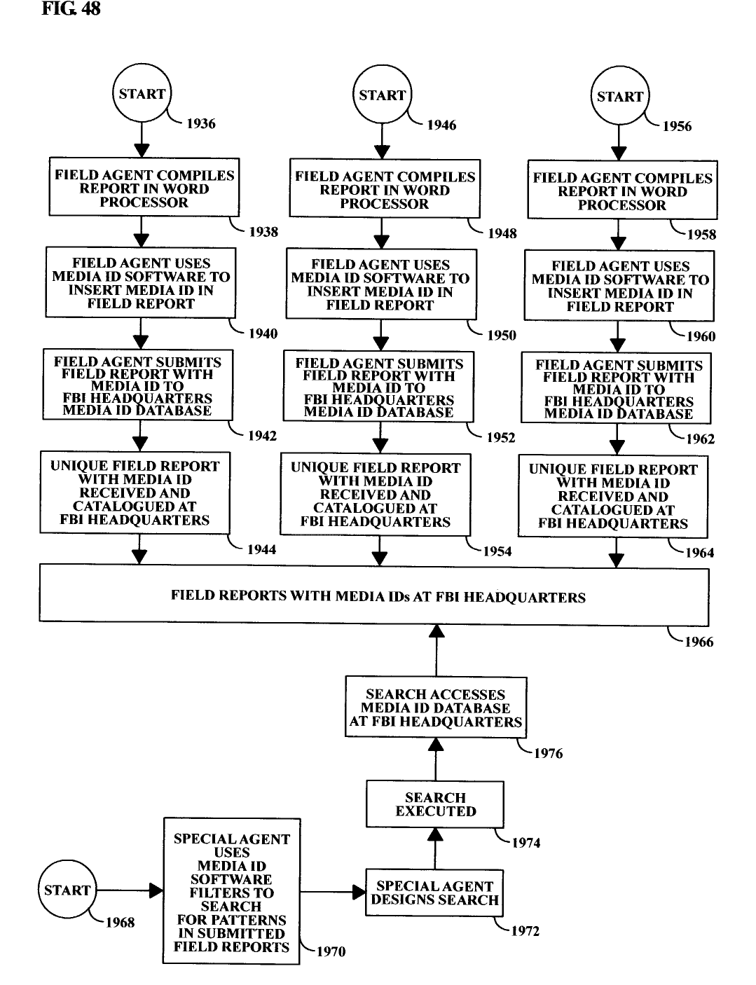

FIG. 48 shows a diagram illustrating the application of a universal media identification system as described herein to intelligence gathering. This example is an embodiment using the media ID system to tag and uniquely identify field reports created by field intelligence agents or others. The creation of an intelligence field report with a media ID with multiple subject classifications and comprehensive identification information begins at 1936. At 1938, a field agent compiles a field report on a word processor. The intelligence agent uses a version, module, or component of the media ID software at 1940 in conjunction with his local word processor to embed or otherwise associate a media ID with the field report. At this point the field report is now uniquely defined and can be distinguished from all other field reports, all other articles of media. The field agent submits the field report with the media ID to FBI intelligence headquarters at 1942. The field report with the media ID is received and cataloged at the FBI headquarters at 1944. The field report that originated with the field agent at 1938 is now located at FBI headquarters at 1944 and has been uniquely identified with a media ID.

Other intelligence field agents at 1948 and 1958 also compile intelligence field reports and submit them to FBI headquarters at 1952 and 1962, respectively. These intelligence field reports are received and cataloged at FBI headquarters at 1954 and 1964. Incoming field reports are collected together and hosted by the FBI headquarters for other agents to access and download at 1966.

A field report search by a special agent begins at 1968. At 1970 the special agent uses the media ID software of this embodiment to search for subject classification patterns, or other patterns in field agent reports and other reports located and hosted at 1966. In one embodiment, the layer search tool from FIG. 47 is used for this purpose. The special agent designs the media ID search at 1972 and the search is executed at 1974. At 1976 the special agent contacts the media ID database at FBI headquarters located at 1966 via her media ID software. The field agent will be able to rapidly filter and search the information in the database at 1966 because the various field reports and other articles of media hosted at 1966 contain unique media IDs that have sophisticated information about their subject classification and content. This is because the field agents at 1940, 1950, and 1960 encode each media ID with multiple subject classifications and other information. These subject classifications comprehensively identify the subject content of the field reports and allow the special agent to quickly filter and search media IDs and their underlying articles of media.

Those skilled in the art will appreciate that the present invention establishes a universal identification system for printed and electronic media. The present invention has been described in relation to particular embodiments that are intended in all respects to be illustrative rather than restrictive. Therefore, it should be understood that the method and apparatus of the present invention could be practiced with modification and alteration within the spirit and scope of the claims herein. Furthermore, the invention may be implemented in any combination of hardware and/or software. Alternative embodiments will become apparent to those skilled in the art to which the present invention pertains without departing from its spirit and scope.

What is claimed is:

1. A method for providing a universal identification system for an article, the method comprising
creating an identification tag uniquely associated with the article; and
associating an identification tag with the article, such that the identification tag maintains the association when the article is transferred from a first location to a second location.

2. The method of claim 1, wherein the article includes a physical document.

3. The method of claim 2, wherein the article includes a portion of a newspaper.

4. The method of claim 2, wherein the article includes a portion of a magazine.

5. The method of claim 2, wherein the article includes a portion of a book.

6. The method of claim 2, wherein the article includes a portion of printed subject matter.

7. The method of claim 1, wherein the article includes an electronic representation of information.

8. The method of claim 7, wherein the article includes an electronic file.

9. The method of claim 7, wherein the article includes image information.

10. The method of claim 7, wherein the article includes text information.

11. The method of claim 1, wherein the identification tag includes image information.

12. The method of claim 11, wherein the identification tag appears as an icon in association with a visual representation of the article.

13. The method of claim 1, wherein the identification tag comprises a plurality of information fields describing attributes of the article.

14. The method of claim 1, wherein the identification tag includes a machine-readable code affixed to an article of printed media.

15. The method of claim 14, wherein the machine-readable code includes a linear bar code.

16. The method of claim 14, wherein the machine-readable code includes a two-dimensional bar code.

17. The method of claim 14, wherein the machine-readable code includes a composite bar code.

18. The method of claim 1, wherein the identification tag includes an electronic code embedded within an article of electronic media.

19. The method of claim 13, wherein an information field includes a primary subject classification.

20. The method of claim 13, wherein an information field includes a secondary subject classification.

21. The method of claim 13, wherein an information field includes a date.

22. The method of claim 13, wherein an information field includes a page number.

23. The method of claim 13, wherein an information field includes an author.

24. The method of claim 13, wherein an information field includes publication information.

25. The method of claim 13, wherein the plurality of information fields is extracted by a scanning device configured to read a machine-readable code.

26. The method of claim 25, further comprising the step of storing the plurality of information fields in a user database associated with the user.

27. The method of claim 26, further comprising the step of storing an electronic version of the article in the user database when the media identification tag is associated with an article of printed or electronic media.

28. The method of claim 26, further comprising the steps of:
receiving a search request from a user;
identifying an article having a media identification tag when the user database contains an information field matching the search request; and
sending the user the article.

29. A media identification tag and media manager, comprising:
a database configured to store a plurality of media identification tags and associated media, each media identification tag associated with an article of printed or electronic media;
a graphical user interface (GUI) configured to provide a user interface;
a media ID and media viewer configured to display or play any of the plurality of media ID tags and associated articles of media; and
a media search tool configured to select a media identification tag(s) and or media having an attribute(s) specified by a user.

30. The media ID and media manager of claim 29, wherein the database further includes an electronic version of an article of printed media.

31. The media ID and media manager of claim 29, wherein the database further includes an electronic version of an article of electronic media.

32. The media ID and media manager of claim 29, further comprising:
a search library having a plurality of attributes, each attribute having an icon; and
wherein the media search tool is configured to receive a selection of attribute icons representing a selection of attributes and to select a media identification tag matching the selection of attributes from the media database.

33. The media ID and media manager of claim 29, wherein the database is configured to store an additional media identification tag when an icon and or hyperlink representing a media identification tag is clicked on or otherwise selected and transferred to the media ID and media manager.

34. The media ID and media manager of claim 33, wherein the icon and or hyperlink is clicked on or otherwise selected from a web browser.

35. The media ID and media manager of claim 33, wherein the icon is clicked on or otherwise selected from a word processor.

36. The media ID and media manager of claim 33, wherein the icon is clicked on or otherwise selected from an electronic mail program.

37. The media ID and media manager of claim 29, wherein the database is configured to store an additional media identification when an icon representing a media identification is selected and moved to a predefined icon associated with the media ID and media manager.

38. The media ID and media manager of claim 29, further comprising:
a radial attribute viewer configured to display an icon representing a first attribute of a media identification tag at a central position, and to radially arrange a plurality of additional icons representing additional attributes around the central position.

39. The media ID and media manager of claim 37, wherein the attributes are subject classifications of a media identification scheme.

40. A method for organizing information about articles of media, the method comprising
associating an identification tag with an article hosted on a web page, wherein the tag uniquely identifies the article, wherein the tag includes a plurality of fields, wherein a field includes information about the article to which the tag is associated; and
transferring a portion of the fields from a first electronic device to a second electronic device.

41. A method for organizing information about articles of media, the method comprising
associating an identification tag with an article hosted on a web page, wherein the tag uniquely identifies the article, wherein the tag includes a plurality of fields, wherein a field includes information about the article to which the tag is associated; and
using the tag to obtain information about user preferences based on download activity of the associated article.

42. A method for organizing information about articles of media, the method comprising
associating an identification tag with an article hosted on a web page, wherein the tag uniquely identifies the article, wherein the tag includes a plurality of fields, wherein a field includes information about the article to which the tag is associated; and
using the tag to obtain information about publishing and distribution activity of the associated article.

43. A method for organizing information about articles of media, the method comprising
using an application program to associate an identification tag with an article of media, wherein the tag uniquely identifies the article.

44. The method of claim 43, wherein the application includes a word processor application.

45. An apparatus for scanning an identification tag, wherein the tag is associated with a printed or electronic media article, wherein the tag includes information to identify the article, the apparatus comprising
a processor;
a scanner for obtaining information from the tag;
a memory component;
an interface component including direct and wireless connectivity;
user interface controls coupled to the processor to allow a human user to operate the apparatus; and
a display coupled to the processor for providing the user with a display of at least a portion of the contents of a selected tag.

46. An apparatus for processing identification tags, wherein a tag is associated with a media article, wherein the tag includes information to identify the article, the tag further including a plurality of fields of information about the article, the apparatus comprising
means for processing the plurality of fields.

47. A method for displaying information about articles of media, wherein an identification tag associated with an article of media includes a plurality of fields of information about the associated article of media, the method comprising
displaying primary and secondary subject classifications on a display device for presentation to a human user.

48. The method of claim 47, wherein the step of displaying primary and secondary subject classifications includes a sub step of
displaying image information to represent a subject classification.

49. The method of claim 47, wherein the step of displaying primary and secondary subject classifications includes a substep of
displaying text information to represent a subject classification.

50. The method of claim 47, wherein the step of displaying primary and secondary subject classifications includes a sub step of
displaying the primary and secondary subject classifications in concentric circles.

51. The method of claim 50, wherein the distance of a displayed subject classification from the center of the concentric circles indicates a degree of relevance of the subject classification to an article of media.

52. A method for performing information searches associated with articles of media that have associated identification tags, wherein a tag associated with an article of media includes a plurality of fields of information about the associated article of media, the method comprising
defining an information layer for a unique subject classification in a database; and
displaying a relationship of two or more layers on a display device.

53. The method of claim 52, further comprising
accepting signals from a user input device to allow a human user to modify the displayed relationship.

54. The method of claim 52, further comprising
using a processor to analyze the relationship of the two or more layers; and displaying the results of the analysis to a human user.
